(19) United States
(12) Patent Application Publication
(10) Pub. No.: US 2026/0056097 A1
(43) Pub. Date: Feb. 26, 2026

(54) METHODS, SYSTEMS, AND DEVICES FOR ANTIGEN PROFILING AND ISOLATION OF TARGET CELLS FROM BIOLOGICAL SAMPLES

(71) Applicant: University of Georgia Research Foundation, Inc., Athens, GA (US)

(72) Inventors: Leidong Mao, Watkinsville, GA (US); Yang Liu, Bogart, GA (US)

(21) Appl. No.: 19/102,515

(22) PCT Filed: Aug. 11, 2023
(86) PCT No.: PCT/US2023/072053

§ 371 Date: Feb. 10, 2025

Related U.S. Application Data
(60) Provisional application No. 63/397,645, filed on Aug. 12, 2022.

(51) Int. Cl. G01N 1/34; B01L 3/00

(52) U.S. Cl. CPC G01N 1/34; B01L 3/502761; B01L 2200/0668; B01L 2300/087

(57) ABSTRACT

In various aspects, microfluidic devices, systems, kits, and methods of using quantitative ferrohydrodynamic cell separation devices are provided for quantifying antigen-binding capacity and isolating target cells. The method includes providing a magnetically labeled biological sample cell-bead complexes comprising a target cell bound to antibody-conjugated magnetic beads and combining the magnetically labeled biological sample with a colloidally stable. Flowing the mixed ferrofluid biological sample through a microfluidic device comprising a plurality of collection stages arranged in series and fluidly connected. Collecting a first portion of cell-bead complexes having the cellular magnetic content greater than the ferrofluid concentration of the mixed ferrofluid biological sample. Diluting the ferrofluid concentration of the mixed ferrofluid biological sample with a buffer solution for a subsequent collection stage. Collecting, in a subsequent collection chamber, another portion of cell-bead complexes having the cellular magnetic content greater than the ferrofluid concentration in the subsequent collection stage.

### CROSS-REFERENCE TO RELATED APPLICATIONS

This application claims priority to U.S. Provisional Patent Application No. 63/297,645, filed on Aug. 12, 2022, the entire contents of which are incorporated herein by reference.

### STATEMENT REGARDING FEDERALLY SPONSORED RESEARCH OR DEVELOPMENT

This invention was made with government support under EB028191 and UL1 TR002378 awarded by the NIH and grants 1150042, 1648035, 1659525 awarded by the NSF. The government has certain rights in the invention. (37 CFR 401.14 f (4))

### TECHNICAL FIELD

The present disclosure generally relates to microfluidics and uses thereof for biological cell separation, isolation, and quantification.

### BACKGROUND

The need for multimodal sorting of target cells according to the levels of a specific surface antigen while at the same time profiling antigen-binding capacity distribution among cells is increasing as it becomes important in understanding and treating diseases.

### SUMMARY

According to various aspects, the present disclosure provides microfluidic devices, systems, kits, and methods of using quantitative ferrohydrodynamic cell separation devices for quantifying antigen-binding capacity and isolating target cells.

Methods for profiling and isolating target cells in a biological sample are provided in the present disclosure. In embodiments, the methods for profiling and isolating target cells in a biological sample include providing a magnetically labeled biological sample comprising a plurality of cell-bead complexes, individual ones of the cell-bead complexes comprising a target cell bound to one or more antibody-conjugated magnetic beads, and wherein the cellular magnetic content of the individual cell-bead complex is proportional to an antigen-binding capacity of the individual target cell. The method includes combining the magnetically labeled biological sample with a colloidally stable ferrofluid to produce a mixed ferrofluid biological sample. The method includes flowing the mixed ferrofluid biological sample through a microfluidic device comprising a plurality of collection stages arranged in series and fluidly connected. A first portion of cell-bead complexes having the cellular magnetic content greater than the ferrofluid concentration of the mixed ferrofluid biological sample can be collected in a first collection chamber of a first collection stage of the plurality of collection stages. The method also includes diluting the ferrofluid concentration of the mixed ferrofluid biological sample with a buffer solution for a subsequent collection stage. The method includes collecting, in a subsequent collection chamber of the subsequent collection stage, another portion of cell-bead complexes having the cellular magnetic content greater than the ferrofluid concentration of the mixed ferrofluid biological sample in the subsequent collection stage.

Embodiments of microfluidic devices provided in the present disclosure for profiling and isolating target cells in a biological sample includes a sample inlet configured to receive a mixed ferrofluid biological sample comprising a ferrofluid combined with a magnetically-labeled biological sample comprising a plurality of cell-bead complexes comprising individual target cells conjugated to one or more magnetic beads. Individual cell-bead complexes having a cellular magnetic content proportional to an antigen-binding capacity of the individual target cell. In embodiments, the device includes a buffer fluid delivery section comprising a solution inlet and one or more flow resistance microchannels fluidly connected to the solution inlet. The solution inlet is configured to receive a buffer fluid and the one or more flow resistance microchannels configured to deliver the buffer fluid at a specified flow rate with a specific flow direction. The microfluidic device can also include a plurality of collection stages arranged in series. Each of the plurality of collection stages comprising a collection chamber collectively arranged in a cell collection section of the device. The plurality of collection stages are fluidly connected such that a first collection stage is fluidly connected to the sample inlet and one or more subsequent collection stages are individually fluidly connected to a previous collection stage and the buffer fluid delivery section via a mixer configured to combine the buffer fluid with the mixed ferrofluid biological sample from the previous collection stage at a flow rate sufficient to dilute the ferrofluid concentration of the mixed ferrofluid biological sample for the individual collection stage. In embodiments, one or more magnetic sources are adjacent to the cell collection section and configured to produce a substantially non-uniform magnetic field such that, for each individual collection stage, one or more cell-bead complexes having cellular magnetic content (which is proportional to a volumetric antigen-binding capacity of the individual cell) greater than the ferrofluid concentration within the individual collection stage are captured within the individual collection chamber of the individual collection stage.

The present disclosure also provides for systems for profiling and isolating target cells in a biological sample. In embodiments, the system includes a plurality of magnetic microbeads adapted for adapted to specifically bind to the primary antibodies to form cell-bead complexes, thereby producing a magnetically labeled biological sample comprising a plurality of cell-bead complexes, wherein the cellular magnetic content of the individual cell-bead complex is proportional to an antigen-binding capacity of the individual target cell. The system can also include a biocompatible ferrofluid comprising a plurality of magnetic nanoparticles and a biocompatible surfactant, the biocompatible ferrofluid adapted to be combined with the magnetically labeled biological sample to make a mixed ferrofluid biological sample. Additionally, the system includes the microfluidic device disclosed herein.

Other systems, methods, features, and advantages of the present disclosure will be or will become apparent to one with skill in the art upon examination of the following drawings and detailed description. It is intended that all such additional systems, methods, features, and advantages be included within this description, and be within the scope of the present disclosure.

### BRIEF DESCRIPTION OF THE DRAWINGS

Further aspects of the present disclosure will be readily appreciated upon review of the detailed description of its various embodiments, described below, when taken in conjunction with the accompanying drawings.

FIG. 1A illustrates an example quantitative ferrohydrodynamic cell separation (qFCS) device according to various embodiments disclosed herein.

FIG. 1B illustrates the flow resistances of the example qFCS device of FIG. 1A according to various embodiments disclosed herein.

FIG. 1C illustrates the mixers of the example qFCS device of FIG. 1A according to various embodiments disclosed herein.

FIG. 1D illustrates the collection chambers of the example qFCS device of FIG. 1A according to various embodiments disclosed herein.

FIG. 1E illustrates the incubation chambers of the example qFCS device of FIG. 1A according to various embodiments disclosed herein.

FIGS. 2A-2F illustrate an overview of the quantitative ferrohydrodynamic cell separation (qFCS) method and its prototype device according to various embodiments disclosed herein.

FIGS. 3A-3H illustrate an example design of the quantitative ferrohydrodynamic cell separation (qFCS) method for cell isolation according to various embodiments disclosed herein.

FIGS. 4A-4F illustrate an example calibration of the quantitative ferrohydrodynamic cell separation (qFCS) method for cell isolation according to various embodiments disclosed herein.

FIGS. 5A-5L illustrate an experimental validation of the qFCS device for its capabilities of quantifying antigen-binding capacity according to various embodiments disclosed herein.

FIGS. 6A-6E illustrate an example experimental validation of the qFCS device for its capabilities of isolating rare cells according to various embodiments disclosed herein.

FIGS. 7A-7D illustrate an example of quantifying and isolating T lymphocytes based on the antigen binding of a low-expression CD154 according to various embodiments disclosed herein.

FIG. 8 illustrates an example of maximum number of closely packed magnetic beads on a spherical cell's surface according to various embodiments disclosed herein.

FIG. 9 illustrates an example of a linear relationship approximated between the cellular magnetic content and the number of magnetic beads on the cell's surface according to various embodiments disclosed herein.

FIG. 10A illustrates an example schematic of an optically thin layer of ferrofluids with magnetic nanoparticles as light absorbers according to various embodiments disclosed herein.

FIG. 10B illustrates an example schematic of an optically thick layer of ferrofluids that can be divided into many optically thin layers according to various embodiments disclosed herein.

FIG. 11 illustrates an example linear relationship between ferrofluid absorbance and its concentration according to various embodiments disclosed herein.

FIG. 12 illustrates an example simulation and experimental results of the ferrofluid concentration in the chambers at variable inlet according to various embodiments disclosed herein.

FIG. 13 illustrates an example magnetic flux density and gradient of flux density in the cell-collection chamber of the qFCS device according to various embodiments disclosed herein.

FIG. 14 illustrates an example of Ferrofluid concentration profiles in the qFCS device at different starting ferrofluid concentrations according to various embodiments disclosed herein.

FIGS. 15A and 15B illustrate an example of final positions of cells in cell-collection chamber in qFCS with variable flow rates and cell diameters according to various embodiments disclosed herein.

FIGS. 16A-16C illustrate an example of simulation data of cell-beads complexes according to various embodiments disclosed herein.

FIGS. 17A and 17B illustrate an example of diameter distribution of cells collected in qFCS chambers according to various embodiments disclosed herein.

FIG. 18 illustrates an example of number of magnetic beads on CD45+ WBCs with respect to cell diameter according to various embodiments disclosed herein.

FIGS. 19A and 19B illustrate an example of cell viability and cell proliferation assay for evaluating qFCS biocompatibility according to various embodiments disclosed herein.

### DETAILED DESCRIPTION

In various aspects, microfluidic devices, systems, kits, and methods of using quantitative ferrohydrodynamic cell separation devices are provided for quantifying antigen-binding capacity and isolating target cells in a biological sample. In some embodiments, the target cells are rare cells, such as cultured cancer cells and peripheral blood mononuclear cells (PBMCs) in a biological sample. The methods include labeling of the target cells by indirect or direct magnetic labeling in which the target cells are specifically labeled with magnetic beads to form a cell-bead complex in which the number of magnetic beads coupled to an individual target cell is proportional to the antigen binding capacity of the target cell. In embodiments, the methods, systems, and devices also provide for quantifying antigen-binding capacity of the rare cells according to the cellular magnetic content of the cell-beads complex which is proportional to the cell's antigen-binding capacity under specific conditions.

Before the present disclosure is described in greater detail, it is to be understood that this disclosure is not limited to particular embodiments described, and as such may, of course, vary. It is also to be understood that the terminology used herein is for the purpose of describing particular embodiments only, and is not intended to be limiting. The skilled artisan will recognize many variants and adaptations of the embodiments described herein. These variants and adaptations are intended to be included in the teachings of this disclosure and to be encompassed by the claims herein.

All publications and patents cited in this specification are cited to disclose and describe the methods and/or materials in connection with which the publications are cited. Where such publications and patents describe methods or materials needed for description of the devices, systems, kits and methods of the present disclosure, the references are herein incorporated by references as if each individual publication or patent were specifically and individually indicated to be incorporated by reference. Such incorporation by reference is expressly limited to the methods and/or materials described in the cited publications and patents and does not extend to any lexicographical definitions from the cited publications and patents. Any lexicographical definition in the publications and patents cited that is not also expressly repeated in the instant specification should not be treated as such and should not be read as defining any terms appearing in the accompanying claims. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

Embodiments of the present disclosure will employ, unless otherwise indicated, techniques of biochemistry, molecular biology, microfluidics, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

Although any methods and materials similar or equivalent to those described herein can also be used in the practice or testing of the present disclosure, the preferred methods and materials are now described. Functions or constructions well-known in the art may not be described in detail for brevity and/or clarity.

It should be noted that ratios, concentrations, amounts, and other numerical data can be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to about 5%” should be interpreted to include not only the explicitly recited values of about 0.1% to about 5%, but also include individual values (e.g., 1%, 2%, 3%, and 4%) and the sub-ranges (e.g., 0.5%, 1.1%, 2.2%, 3.3%, and 4.4%) within the indicated range. Where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y’, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In some embodiments, the term “about” can include traditional rounding according to significant figures of the numerical value. In addition, the phrase “about ‘x’ to ‘y’”, where ‘x’ and ‘y’ are numerical values, includes “about ‘x’ to about ‘y’”.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

### Definitions

Unless defined otherwise, all technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

The articles “a” and “an,” as used herein, mean one or more when applied to any feature in embodiments of the present invention described in the specification and claims. The use of “a” and “an” does not limit the meaning to a single feature unless such a limit is specifically stated. The article “the” preceding singular or plural nouns or noun phrases denotes a particular specified feature or particular specified features and may have a singular or plural connotation depending upon the context in which it is used.

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

In this disclosure, “consisting essentially of” or “consists essentially” or the like, when applied to methods and compositions encompassed by the present disclosure refers to compositions like those disclosed herein, but which may contain additional structural groups, composition components or method steps (or analogs or derivatives thereof as discussed above). Such additional structural groups, composition components or method steps, etc., however, do not materially affect the basic and novel characteristic(s) of the compositions or methods, compared to those of the corresponding compositions or methods disclosed herein. “Consisting essentially of” or “consists essentially” or the like, when applied to methods and compositions encompassed by the present disclosure have the meaning ascribed in U.S. patent law and the term is open-ended, allowing for the presence of more than that which is recited so long as basic or novel characteristics of that which is recited is not changed by the presence of more than that which is recited, but excludes prior art embodiments.

As used herein, “about,” “approximately,” “substantially,” and the like, when used in connection with a numerical variable, can generally refers to the value of the variable and to all values of the variable that are within the experimental error (e.g., within the 95% confidence interval for the mean) or within +/−10% of the indicated value, whichever is greater. As used herein, the terms “about,” “approximate,” “at or about,” and “substantially” can mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” indicates that the subsequently described event or circumstance can or cannot occur, and that the description includes instances where said event or circumstance occurs and instances where it does not.

As used herein, “kit” refers to a collection of at least two components constituting the kit. Together, the components constitute a functional unit for a given purpose. Individual member components may be physically packaged together or separately. For example, a kit comprising an instruction for using the kit may or may not physically include the instruction with other individual member components. Instead, the instruction can be supplied as a separate member component, either in a paper form or an electronic form which may be supplied on computer readable memory device or downloaded from an internet website, or as recorded presentation.

As used herein, “instruction(s)” refers to documents describing relevant materials or methodologies pertaining to a kit. These materials may include any combination of the following: background information, list of components and their availability information (purchase information, etc.), brief or detailed protocols for using the kit, trouble-shooting, references, technical support, and any other related documents. Instructions can be supplied with the kit or as a separate member component, either as a paper form or an electronic form which may be supplied on computer readable memory device or downloaded from an internet website, or as recorded presentation. Instructions can comprise one or multiple documents, and are meant to include future updates.

As used herein, “attached” can refer to covalent or non-covalent interaction between two or more molecules. Non-covalent interactions can include ionic bonds, electrostatic interactions, van der Walls forces, dipole-dipole interactions, dipole-induced-dipole interactions, London dispersion forces, hydrogen bonding, halogen bonding, electromagnetic interactions, π-π interactions, cation-π interactions, anion-π interactions, polar π-interactions, and hydrophobic effects.

A “biocompatible” substance or fluid, as described herein, indicates that the substance or fluid does not adversely affect the short-term viability or long-term proliferation of a target cell within a particular time range.

“Curved” or “curve,” as described herein, indicates a non-linear shape, where curved can include a single curve, multiple curves, and multi-directional curves, including crescent-shaped, U-shaped, serpentine, sigmoidal, and the like.

As used herein, the term “cells/particles” refers to particles, cells, or a combination of both, in a sample or mixture.

As used herein, channels that are “substantially parallel” refers to channels of a device of the present disclosure that, with respect to a reference channel, while not absolutely parallel throughout the entire device, are parallel for a majority of the length of the channel, particularly in a portion of the channel in which cell migration is being observed.

### Quantitative Ferrohydrodynamic Cell Separation Devices, Systems and Methods of Use Thereof

Broadly described, the present disclosure provides devices, systems, and methods for profiling and isolating target cells in a biological sample. The quantitative ferrohydrodynamic cell separation (qFCS) devices and systems are configured for separating and quantifying target cells from a sample using magnetic labeling of the target cell in the sample prior to separation. The methods include labeling of the target cells by direct or indirect magnetic labeling to forming a cell-bead complex having a cellular magnetic content which is proportional to the cell's antigen-binding capacity. A biological sample is formed by combining the magnetically labeled target cells with biocompatible ferrofluids. The magnetically labeled target cells are separated and sorted to quantify expression of certain cell-surface antigens by passing the sample through a microfluidic device having a series of separation stages, in which the ferrofluid is serially diluted, and one or more magnets to separate the magnetically labeled target cells having a greater cellular magnetic content than the ferrofluid concentration of the fluid for the individual stage.

The method for profiling and isolating target cells in a biological sample can include providing a magnetically labeled biological sample comprising a plurality of cell-bead complexes. The individual ones of the cell-bead complexes can include a target cell bound to one or more antibody-conjugated magnetic beads. The antibody is specific for a cell surface antigen of the target cell. Since target cells with a greater number of surface antigen will have the capacity to bind a greater number of antibodies and hence a greater number of magnetic beads, the cellular magnetic content of the individual cell-bead complex is proportional to an antigen-binding capacity of the individual target cell.

The magnetically labeled biological sample can be directly or indirectly labeled. In one example, the magnetically labeled biological sample can be provided by combining the biological sample with a plurality of antibodies where the antibodies are specific for cell surface antigens of the target cells and specifically bind the target cells. The antibodies are conjugated to a plurality of magnetic beads, to form cell-bead complexes. In an embodiment of direct labeling, the antibodies can be conjugated to magnetic beads prior to combining with the biological sample. In other embodiments, the antibodies can be combined with the sample first to form an antibody-cell complex, and then the magnetic beads can be added after the antibodies have bound the target cells in the sample such that the magnetic beads bind the antibody-cell complexes in the sample. In such embodiments the antibodies and the magnetic beads are each functionalized with one half of a binding pair (e.g., biotin/streptavidin) such that the magnetic beads will specifically bind the cell-bound antibodies in the sample. For instance, the antibodies can be functionalized with biotin and the magnetic beads functionalized with streptavidin. In an embodiment of indirect labeling, the magnetically labeled biological sample can be provided by combining the biological sample with a plurality of primary antibodies adapted to specifically bind a plurality of specific cell surface antigens of the target cells to form antibody-functionalized target cells and combining the biological sample comprising the antibody-functionalized target cells with a plurality of secondary antibodies conjugated to a plurality of magnetic beads and adapted to specifically bind to the primary antibodies to form cell-bead complexes, thereby producing the magnetically labeled biological sample comprising the plurality of cell-bead complexes.

The method can also include combining the magnetically labeled biological sample with a colloidally stable ferrofluid to produce a mixed ferrofluid biological sample. The mixed ferrofluid biological sample can be flowed through a microfluidic device of the present disclosure. In embodiments, the microfluidic device of the present disclosure includes a plurality of collection stages arranged in series and fluidly connected. A first portion of cell-bead complexes having the cellular magnetic content greater than the ferrofluid concentration of the mixed ferrofluid biological sample can be collected in a first collection chamber of a first collection stage of the plurality of collection stages. The ferrofluid concentration of the mixed ferrofluid biological sample can be diluted with a buffer solution for a subsequent collection stage. Another portion of cell-bead complexes having the cellular magnetic content greater than the ferrofluid concentration of the mixed ferrofluid biological sample in the subsequent collection stage can be collected in a subsequent collection chamber of the subsequent collection stage. The method can include adding subsequent diluting and collecting steps to collect cell-bead complexes having lower cellular magnetic content than the cell-bead complexes collected in a previous collection chamber.

A microfluidic device for profiling and isolating target cells in a biological sample can include a sample inlet, a buffer fluid delivery section, a plurality of collection stages arranged in series, each of the collection stages comprising a collection chamber, and one or more magnetic sources. The sample inlet can be configured to receive a mixed ferrofluid biological sample. The mixed ferrofluid biological sample can include a ferrofluid combined with a magnetically-labeled biological sample comprising a plurality of cell-bead complexes comprising individual target cells conjugated to one or more magnetic beads with the individual cell-bead complexes having a cellular magnetic content proportional to an antigen-binding capacity of the individual target cell. The buffer fluid delivery section can include a solution inlet and one or more flow resistance microchannels fluidly connected to the solution inlet. The solution inlet can be configured to receive a buffer fluid and the one or more flow resistance microchannels can be configured to control the flow of the buffer fluid. In embodiments the flow resistance microchannels can be configured to deliver the buffer fluid at a specified flow rate with a specific flow direction. The buffer fluid can be a biologically compatible fluid such as a buffered saline solution, a cell culture media, and the like.

The plurality of collection stages can be arranged in series. Each of the plurality of collection stages can include a collection chamber with the collection chambers collectively arranged in a cell collection section of the device. The plurality of collection stages can be fluidly connected such that a first collection stage is fluidly connected to the sample inlet and one or more subsequent collection stages are individually fluidly connected to a previous collection stage and the buffer fluid delivery section via a mixer. In embodiments, the mixer(s) are configured to combine the buffer fluid with the mixed ferrofluid biological sample from the previous collection stage at a flow rate sufficient to dilute the ferrofluid concentration of the mixed ferrofluid biological sample for the individual collection stage. The device includes one or more magnetic sources adjacent to the cell collection section and configured to produce a substantially non-uniform magnetic field such that, for each individual collection stage, one or more cell-bead complexes having cellular magnetic content greater than the ferrofluid concentration within the individual collection stage are captured within the individual collection chamber of the individual collection stage. Additionally, in some embodiments each of the collection stages can also include an incubation chamber in fluid connection with the collection chamber of the individual stage of the plurality of collection stages.

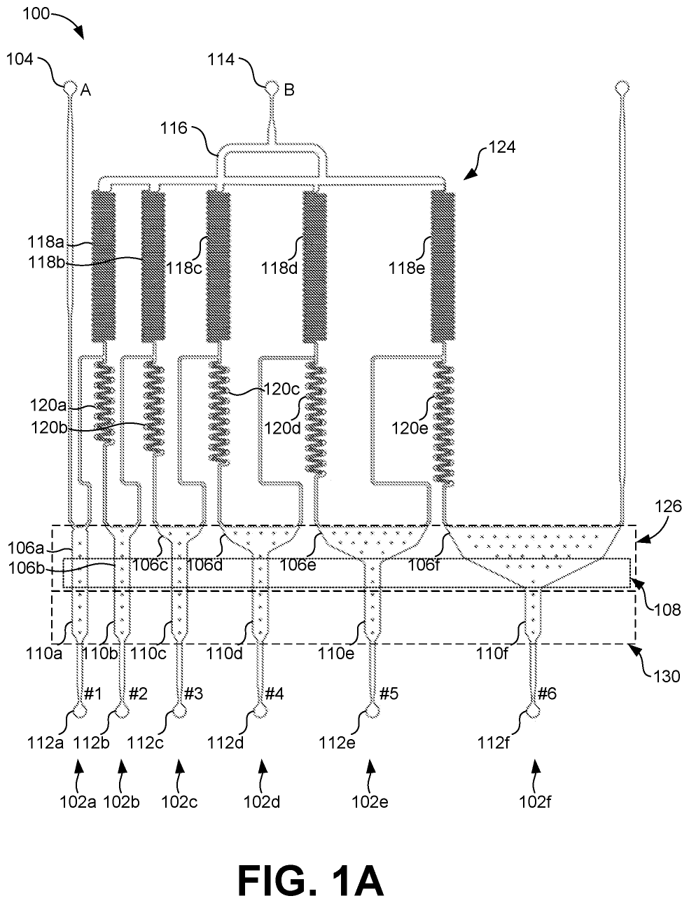

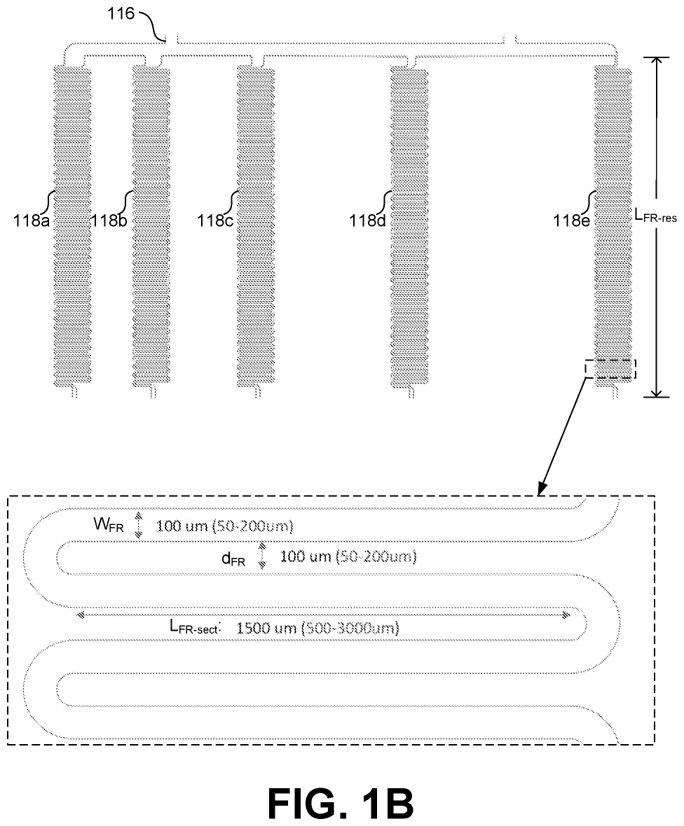

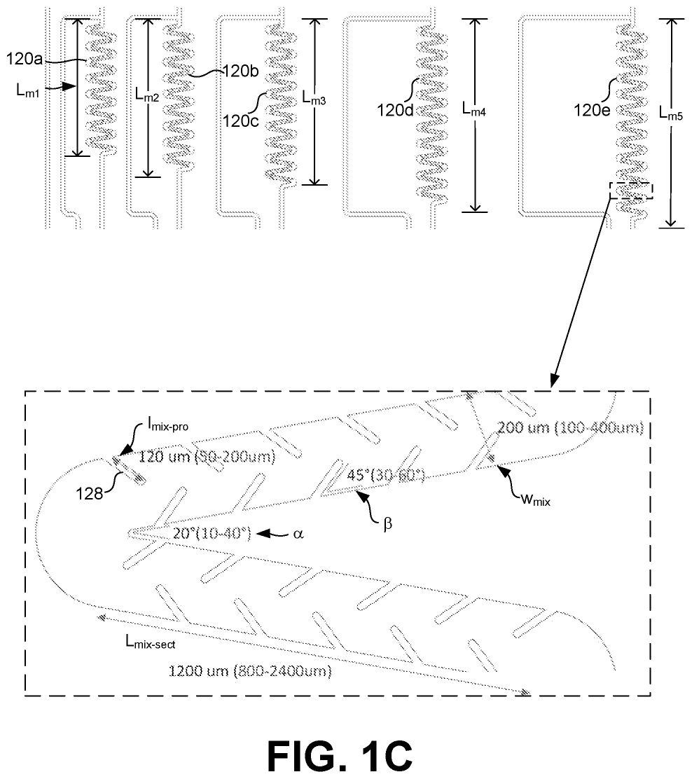

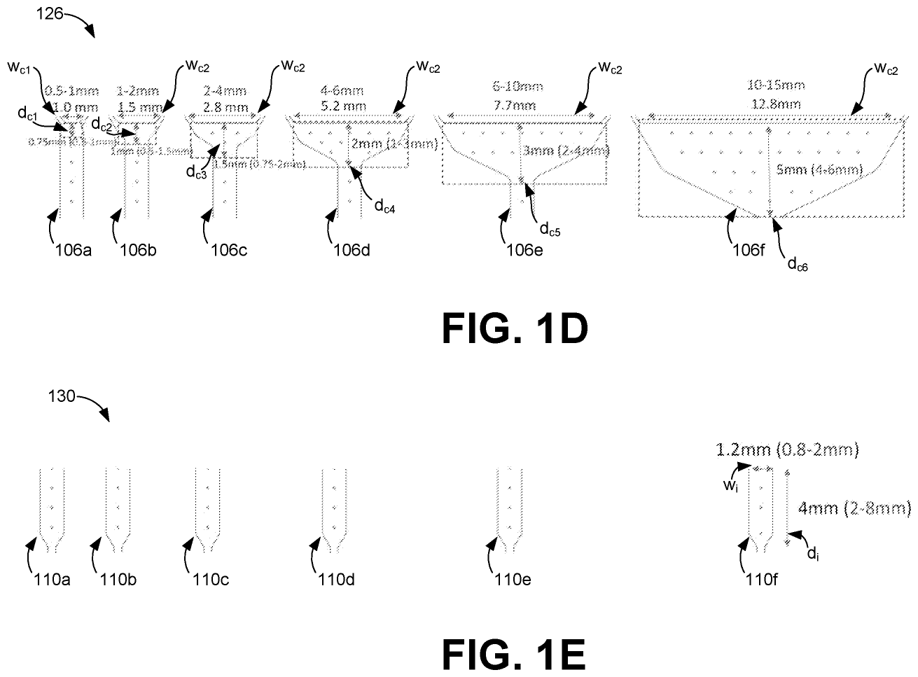

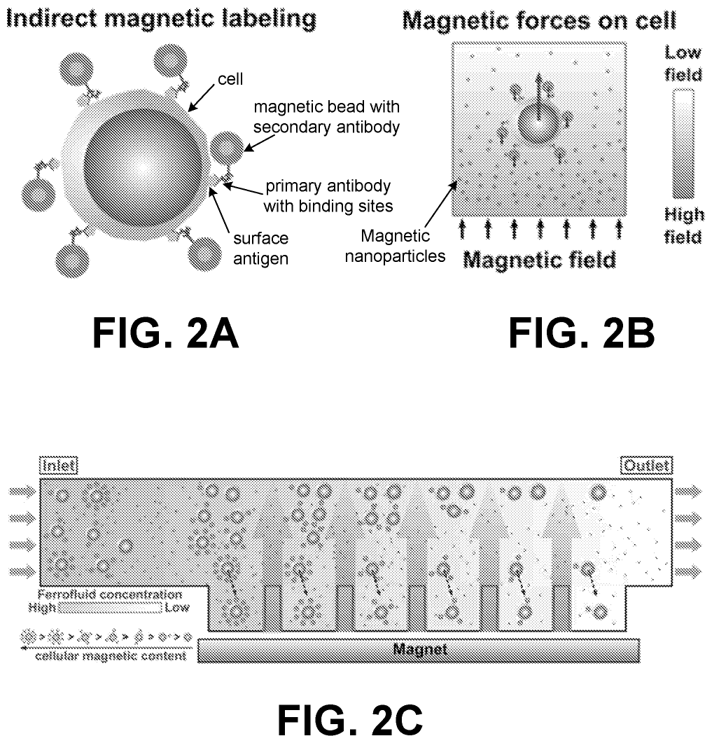

In FIG. 1A, an example qFCS device 100 is shown configured with six separation stages 102a-102f (separately “separation stage 102,” collectively “separation stages 102”). The biological sample can be introduced at an inlet (A) 104 to flow through the series of stages 102 for separation into individual collection chambers 106a-106f (separately “collection chamber 106,” collectively “collection chambers 106”) for each respective stage 102a-102f. One or more magnets 108 can be positioned adjacent to the collection chambers 106 to attract the individual cell-bead complexes having a cellular magnetic content greater than the ferrofluid concentration. Additionally, the device 100 includes incubation chambers 110a-110f (separately “incubation chamber 110,” collectively “incubation chambers 110”) fluidly connected to each of the collection chambers 106a-106f. Individual outlets 112a-112f (separately “outlet 112,” collectively “outlets 112”) are provided for each of the collection chambers 106 and respective incubation chambers 110. The device 100 includes a buffer fluid delivery system 124 to introduce a buffer solution after an initial separation of magnetically labeled cells at the first collection chamber 106a in the first separation stage 102a. The buffer fluid delivery system 124 can have an inlet (B) 114 configured to receive the buffer fluid and one or more microchannels 116 to deliver the solution to the individual stages 102a-102f. The buffer fluid delivery system 124 can include one or more flow resistance microchannels 118a-118e (separately “flow resistance microchannel 118,” collectively “flow resistance microchannels 118” to regulate the flow of the buffer fluid to the individual stages 102 of the device. The number of flow resistance microchannels 118 is one less than the number of stages 102 since the first separation stage 102a is not diluted. In each of the stages 102b-102f, after the first stage 102a, the ferrofluid concentration of the biological sample is diluted using mixers 120a-120e within the stage. The device 100 can also include a waste outlet 122.

For example, as shown in FIG. 1A, the there are six stages 102a-102f and six corresponding collection chambers 106a-106f, six incubation chambers 110a-110f, and six outlets 112a-112f. The first stage 102a receives the initial mixed ferrofluid biological sample comprising the individual cell-bead complexes magnetically labeled to have a cellular magnetic content proportional to an antigen-binding capacity of the individual cells. In this first stage 102a, the mixed ferrofluid biological sample has the highest ferrofluid concentration. The cell-bead complexes having a cellular magnetic content greater than the ferrofluid concentration are collected in the first collection chamber 106a. As shown in this example, the mixed ferrofluid biological sample continues to flow as input to the second stage 102b. The second stage 102b also receives input of a buffer fluid from the buffer fluid delivery section 124. The flow resistance microchannels 118 of the buffer fluid delivery section 124 are configured to regulate the flow rate and flow direction of the buffer fluid. The flow resistance microchannels 118 are configured such that there is not back flow of the mixed ferrofluid biological sample into the buffer fluid delivery section. The mixed ferrofluid biological sample received from the first stage 102a and the buffer fluid received from the flow resistance microchannels 118a are mixed in the mixer 120a of the second stage 102b to dilute the mixed ferrofluid biological sample and reduce the ferrofluid concentration. The cell-bead complexes having a cellular magnetic content greater than the ferrofluid concentration of the second stage 102b are collected in the second collection chamber 106b. The number of individual collection chambers of the plurality of collection chambers is equal to the number of collection stages (n) and the number of flow resistance microchannels 118 of the one or more flow resistance microchannels of the buffer fluid delivery systems is one less than the number of collection stages (n−1). Thus, in the embodiment illustrated in FIG. 1A, there are 6 stages 102 with 6 collection chambers 106, and 5 flow resistance microchannels 118 and 5 mixers 120. The additional stages 102 are configured in a similar manner as the second stage and adapted for separating target cells based on the cellular magnetic content compared to the reduced ferrofluid concentration within each subsequent stage, such that the target cells are separated based on their level of cellular magnetic content which is a function of their antigen binding capacity. One or more magnets 108 can be positioned adjacent to the collection chamber 106 for each stage 102, arranged in a cell collection section 126, to attract the individual cell-bead complexes having a cellular magnetic content greater than the reduced ferrofluid concentration.

FIG. 1B illustrates the features of the flow resistance microchannels 118 of the buffer fluid delivery system. Each of the flow resistance microchannels of the buffer fluid delivery system has a resistance width (w_{FR}), a resistance length (l_{FR}), and a resistance path shape configured to receive the buffer fluid at a first end of said flow resistance microchannel and deliver the buffer fluid at a predetermined rate. In an example, each of the one or more flow resistance microchannels 118 delivers the buffer fluid at the same predetermined rate. In some examples, each of the flow resistance microchannels 118 in the microfluidic device 100 can have the same resistance width (w_{FR}), resistance length (l_{FR-res}), and resistance path shape. In some examples, each of the one or more flow resistance microchannels 118 is configured to deliver the buffer fluid at a different predetermined rate, and the flow resistance microchannels 118 in the microfluidic device 100 can have different resistance widths (w_{FR}), resistance lengths (l_{FR-res}), and resistance path shapes. The resistance path shape of the individual flow resistance microchannels can have a curved alternating pattern (such as a “zig zag” pattern) configured to increase the flow resistance, and thus prevent the back flow. The resistance path shape can be used to control the flow direction. Although the resistance path shape can have the same design, the flow rate can vary. For example, the flow resistance microchannels can be configured to increase the flow rate for each subsequent collection stage.

In an example, the individual flow resistance microchannels 118 can have a plurality of section lengths (l_{FR-sect}) arranged in parallel and connected by curved segments that form a 180° turn at alternating ends and form a continuous length of the flow resistance microchannel 118. For example, as shown in the example of FIG. 1B, each of the flow resistance microchannels 118 can have a section length (L_{FR-sect}) of the plurality of section lengths ranges from about 500 μm to about 3000 μm having the resistance width (w_{FR}) of about 50 μm to about 200 μm and spaced at a distance (d_{FR}) of about 50 μm to about 200 μm. For example, the flow resistance microchannels can have a section length (L_{FR-sect}) of the plurality of section lengths of about 1500 μm having the resistance width (w_{FR}) of about 100 μm and spaced at a distance (d_{FR}) of about 100 μm. Each of the flow resistance microchannels has a width (w_{FR}) ranging from about 50 μm to about 200 μm and a resistance length (L_{FR-res}) ranging from about 50 mm to about 300 mm. For example, the resistance length (L_{FR-res}) can be 145 mm. For a device, since the first stage does not require dilution, the number of individual collection chambers of the plurality of collection chambers is equal to the number of collection stages (n) and the number of flow resistance microchannels (n_{FR}) of the one or more flow resistance microchannels of the buffer fluid delivery systems is one less than the number of collection stages (n−1). Each of the flow resistance microchannels can be configured to provide the buffer fluid at a predetermined flow rate for the corresponding individual collection stage. For example, the flow rate can increase for each subsequent collection stage.

FIG. 1C illustrates the features of the mixers 120 in an example microfluidic device 100. Since the first stage 102a does not require dilution, the number of individual mixers (nₘᵢₓₑᵣₛ) in the device is one less than the number of collection stages (n−1). The individual mixer 120 corresponding to the one or more subsequent collection stages 102 comprises a mixing microchannel having a mixer width (wₘᵢₓ), a mixer length (Lₘᵢₓ), and a mixer path shape configured to mix the buffer fluid with the mixed ferrofluid biological sample from the previous collection stage to reduce the ferrofluid concentration of the mixed ferrofluid biological sample for the individual collection stage 102. The mixer length (Lₘᵢₓ) for each individual mixer corresponding to each of subsequent collection stages 102 is configured for the individual collection stage. For example, the mixer length for each individual mixer 120 can be different than the one or more subsequent collection stages. As shown in the example of FIG. 1C, the mixer length (Lₘᵢₓ) can be between about 20 mm to about 120 mm. For example, the mixer in the first subsequent collection stage 102b of the one or more subsequent stages 102 in the series of collections stages has the mixer length of about 20 mm to about 80 mm and the mixer length of each of the remaining subsequent stages of the one or more subsequent stages increases in length by about 2.5 mm to about 10 mm. As shown in the example of FIG. 1C, the mixer 120a the mixer length (Lₘ₁) can be 40 mm; the mixer 120b the mixer length (Lₘ₂) can be 45 mm; the mixer 120c the mixer length (Lₘ₃) can be 50 mm; the mixer 120d the mixer length (Lₘ₄) can be 55 mm; and the mixer 120e the mixer length (Lₘ₅) can be 60 mm. Additionally, the mixer width (wₘᵢₓ) for each individual mixer corresponding to the one or more subsequent collection stages is configured for the individual collection stage 102. In an example, the mixer width (wₘᵢₓ) can be between about 100 μm to about 400 μm. For example, the mixer width (wₘᵢₓ) can be about 200 μm. Further, the mixer path shape for each individual mixer 120 corresponding to the one or more subsequent collection stages 102 is configured for the individual collection stage. The mixer path shape has an alternating pattern of mixer sections at an angle (α) and configured to mix the buffer fluid with the mixed ferrofluid biological sample. In an example, the mixer sections can have a section length (l_{mix-sect}) and be positioned at an angle (α) of about 10° to about 40° relative to each other in the alternating pattern to form a continuous length. For example, the length (l_{mix-sect}) of mixer sections can be about 800 μm to about 2400 μm. In the example shown in FIG. 1C, the section lengths (l_{mix-sect}) are 1200 μm and the mixer width (wₘᵢₓ) is about 200 μm.

Further, the individual mixer 120 further can include a plurality of internal protrusions 128 configured to mix the buffer fluid with the mixed ferrofluid biological sample from the previous collection stage to dilute the ferrofluid concentration of the mixed ferrofluid biological sample for the individual collection stage 102. In an example, the plurality of internal protrusions 128 are arranged the flow of the mixed ferrofluid biological sample at an angle (β) of about 30° to about 90° with respect to a sidewall of the mixing microchannel. For example, the plurality of internal protrusions 128 are arranged the flow of the mixed ferrofluid biological sample at an angle (β) of about 45° with respect to a sidewall of the mixing microchannel. The plurality of internal protrusions can be arranged against the flow of the mixed ferrofluid biological sample. The length of the individual protrusions (lₘᵢₓ₋ₚᵣₒ) can be about 50 μm to about 200 μm. In an example, the length of the individual protrusions (lₘᵢₓ₋ₚᵣₒ) can be about 120 μm.

As shown in FIG. 1D, the individual collection chambers 106 can vary by the individual collection stage 102. The individual collection chambers 106 of the plurality of collection stages 102 can be arranged in a cell collection section 126 such that the one or more magnets 108 can be positioned adjacent to the cell collection section 126. The individual collection chambers 106 of the plurality of collection stages 102 arranged in series can vary in volume according to the individual collection stage 102. For example, as shown in FIG. 1D, the first collection chamber 106a of the first collection stage 102a can have a width (w_{c1}) of about 0.5 mm to about 1 mm and effective separation region (d_{c1}) of about 0.5 mm to about 1 mm. The collection chamber dimensions can increase for each subsequent collection stage. For example, the second stage 102b can have a second collection chamber 106b with a width (w_{c2}) of about 1 mm to about 2 mm and effective separation region (d_{c2}) of about 0.5 mm to about 1.5 mm; the third stage can have a third collection chamber 106c with a width (w_{c3}) of about 2 mm to about 4 mm and effective separation region (d_{c3}) of about 0.75 mm to about 2 mm; the fourth stage can have a fourth collection chamber 106d with a width (w_{c4}) of about 4 mm to about 6 mm and effective separation region (d_{c4}) of about 1 mm to about 3 mm; the fifth stage can have a fifth collection chamber 106e with a width (w_{c5}) of about 6 mm to about 10 mm and effective separation region (d_{c5}) of about 2 mm to about 4 mm; and the sixth stage can have a sixth collection chamber 106f with a width (w_{c6}) of about 10 mm to about 15 mm and effective separation region (d_{c5}) of about 4 mm to about 6 mm. As shown in the example of FIG. 1D, the first collection chamber 106a can have a width (w_{c1}) of about 1.0 mm and effective separation region (d_{c1}) of about 0.75 mm; the second collection chamber 106b can have a width (w_{c2}) of about 1.5 mm and effective separation region (d_{c2}) of about 1.5 mm; the third collection chamber 106c can have a width (w_{c3}) of about 2.8 mm and effective separation region (d_{c3}) of about 1.5 mm; the fourth collection chamber 106d can have a width (w_{c4}) of about 5.2 mm and effective separation region (d_{c4}) of about 2.0 mm; the fifth collection chamber 106e can have a width (w_{c5}) of about 7.7 mm and effective separation region (d_{c5}) of about 3.0 mm; and the sixth collection chamber 106f can have a width (w_{c6}) of about 12.8 mm and effective separation region (d_{c6}) of about 5.0 mm. The number of collection stages and chambers can range from 2 to 30, however, in some examples, it may be possible have a greater number of collection stages. For example, the number of collection stages and chambers can range from 2 to 100, configured such that there is a decreasing cellular magnetic content of cell-bead complexes collected in each of the subsequent stages. In an example, for a number of chambers, any one of the cell collection chambers collects cell-bead complexes having lower cellular magnetic content than a previous collection chambers in the previous stage.

The incubation chambers of FIG. 1A are shown in greater detail in FIG. 1E. The microfluidic device 100 can include a plurality of incubation chambers 110 arranged in an incubation section 130 adjacent to the cell collection section 126. The number of incubation chambers can correspond to the number of collection stages and the individual collection chamber 106 and individual incubation chamber 110 for each collection stage 102 are in fluid communication. For example, each of the incubation chambers 110a-110e can have a width (wᵢ) ranging from about 0.8 mm to about 2.0 mm and a depth (dᵢ) ranging from about 2.0 mm to about 8.0 mm. As shown in the example of FIG. 1E, each incubation chamber 110 can be about the same size having a width (wᵢ) of about 1.2 mm and a depth (dᵢ) of about 4.0 mm. In other examples, individual incubation chambers 110 can vary in size. The one or more magnetic sources 108 adjacent to the cell collection section 130 can be moveable such that the cells captured within the individual collection chambers 106 of the cell collection section 126 can be delivered to the individual incubation chambers 110 of the incubation section 130 by translating the one or more magnetic sources 108 from the position adjacent to the cell collection section to a position adjacent to the incubation section 130.

In some examples, a kit or system can be provided to execute the method of profiling and isolating target cells in a biological sample using the quantitative ferrohydrodynamic cell separation device described herein. In an example, a system can comprise a plurality of magnetic microbeads, a biocompatible ferrofluid, and the microfluidic device described herein. The plurality of magnetic microbeads can be adapted to specifically bind to the primary antibodies to form cell-bead complexes, thereby producing a magnetically labeled biological sample comprising a plurality of cell-bead complexes, wherein the cellular magnetic content of the individual cell-bead complex is proportional to an antigen-binding capacity of the individual target cell. The system can also include a biocompatible ferrofluid comprising a plurality of magnetic nanoparticles and a biocompatible surfactant. The biocompatible ferrofluid adapted to be combined with the magnetically labeled biological sample to make a mixed ferrofluid biological sample.

The features of the embodiments described herein are representative and, in alternative embodiments, certain features and elements can be added or omitted. It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

### VARIOUS ASPECTS AND EMBODIMENTS OF THE PRESENT DISCLOSURE

The following list of exemplary aspects supports and is supported by the disclosure provided herein.

Aspect 1: A method for profiling and isolating target cells in a biological sample,
comprising:
providing a magnetically labeled biological sample comprising a plurality of cell-bead complexes, individual ones of the cell-bead complexes comprising a target cell bound to one or more antibody-conjugated magnetic beads, and wherein the cellular magnetic content of the individual cell-bead complex is proportional to a volumetric antigen-binding capacity of the individual target cell;
combining the magnetically labeled biological sample with a colloidally stable ferrofluid to produce a mixed ferrofluid biological sample;
flowing the mixed ferrofluid biological sample through a microfluidic device comprising a plurality of collection stages arranged in series and fluidly connected;
collecting in a first collection chamber of a first collection stage of the plurality of collection stages, a first portion of cell-bead complexes having the cellular magnetic content greater than the ferrofluid concentration of the mixed ferrofluid biological sample;
diluting the ferrofluid concentration of the mixed ferrofluid biological sample with a buffer solution for a subsequent collection stage; and
collecting, in a subsequent collection chamber of the subsequent collection stage, another portion of cell-bead complexes having the cellular magnetic content greater than the ferrofluid concentration of the mixed ferrofluid biological sample in the subsequent collection stage.

Aspect 2: The method of aspect 1, further comprising adding subsequent diluting and collecting steps to collect cell-bead complexes having lower cellular magnetic content than the cell-bead complexes collected in a previous collection chamber.

Aspect 3: The method of aspect 2, wherein the number of total collection stages and collection chambers range from 2 to 100.

Aspect 4: The method of aspect 2, wherein the number of total collection stages and collection chambers range from 2 to 300.

Aspect 5: The method of aspect 2, wherein the number of total collection stages and collection chambers range from 2 to 10.

Aspect 6: The method of aspect 1, wherein providing the magnetically labeled biological sample comprises combining the biological sample with a plurality of antibodies and a plurality of magnetic beads, wherein the antibodies are specific for cell surface antigens of the target cells and specifically bind the target cells and the plurality of magnetic beads specifically bind the antibodies, to form cell-bead complexes.

Aspect 7: The method of aspect 1, wherein providing the magnetically labeled biological sample comprises:
combining the biological sample with a plurality of primary antibodies adapted to specifically bind a plurality of specific cell surface antigens of the target cells to form antibody-functionalized target cells; and
combining the biological sample comprising the antibody-functionalized target cells with a plurality of secondary antibodies conjugated to a plurality of magnetic beads and adapted to specifically bind to the primary antibodies to form cell-bead complexes, thereby producing the magnetically labeled biological sample comprising the plurality of cell-bead complexes.

Aspect 8: The method of aspect 1, wherein diluting the ferrofluid concentration comprises:
receiving, into a mixer of the subsequent collection stage, the mixed ferrofluid biological sample from a previous collection stage, and
receiving a buffer fluid into a mixer of the subsequent collection stage.

Aspect 9: The method of aspect 8, wherein the mixer of the subsequent collection stage comprises a mixing microchannel of a microfluidic device.

Aspect 10: The method of aspect 9, wherein the mixing microchannel of the mixer has a mixer width, a mixer length, and a mixer path shape configured to mix the buffer fluid with the mixed ferrofluid biological sample from the previous collection stage to dilute the ferrofluid concentration of the mixed ferrofluid biological sample for the individual collection stage.

Aspect 11: The method of aspect 10, wherein the mixer length for each individual mixer corresponding to the one or more subsequent collection stages is configured for the individual collection stage.

Aspect 12: The method of aspect 10, wherein the mixer path shape has an alternating pattern of mixer sections at an angle and configured to mix the buffer fluid with the mixed ferrofluid biological sample.

Aspect 13: The method of aspect 10, wherein the individual mixer further comprises a plurality of internal protrusions configured to mix the buffer fluid with the mixed ferrofluid biological sample from the previous collection stage to dilute the ferrofluid concentration of the mixed ferrofluid biological sample for the individual collection stage.

Aspect 14: The method of aspect 1, wherein collecting the first portion of cell-bead complexes comprises using a magnet to separate a portion of cell-bead complexes having the cellular magnetic content greater than the ferrofluid concentration of the mixed ferrofluid biological sample in that cell collection stage or chamber.

Aspect 15: A microfluidic device, comprising:
a sample inlet configured to receive a mixed ferrofluid biological sample comprising a ferrofluid combined with a magnetically-labeled biological sample comprising a plurality of cell-bead complexes comprising individual target cells conjugated to one or more magnetic beads, individual cell-bead complexes having a cellular magnetic content proportional to a volumetric antigen-binding capacity of the individual target cell;
a buffer fluid delivery section comprising a solution inlet and one or more flow resistance microchannels fluidly connected to the solution inlet, the solution inlet configured to receive a buffer fluid and the one or more flow resistance microchannels configured to deliver the buffer fluid at a specified flow rate with a specific flow direction;
a plurality of collection stages arranged in series, each of the plurality of collection stages comprising a collection chamber collectively arranged in a cell collection section of the device, the plurality of collection stages fluidly connected such that a first collection stage is fluidly connected to the sample inlet and one or more subsequent collection stages are individually fluidly connected to a previous collection stage and the buffer fluid delivery section via a mixer configured to combine the buffer fluid with the mixed ferrofluid biological sample from the previous collection stage at a flow rate sufficient to dilute the ferrofluid concentration of the mixed ferrofluid biological sample for the individual collection stage; and
one or more magnetic sources adjacent to the cell collection section and configured to produce a substantially non-uniform magnetic field such that, for each individual collection stage, one or more cell-bead complexes having cellular magnetic content greater than the ferrofluid concentration within the individual collection stage are captured within the individual collection chamber of the individual collection stage.

Aspect 16: The device of aspect 15, wherein each of the plurality of collection stages further comprises an incubation chamber in fluid connection with the collection chamber of the individual stage of the plurality of collection stages.

Aspect 17: The device of aspect 16, wherein the number of incubation chambers (n) is equal to the number of collection chambers (n) and the number of collection stages (n).

Aspect 18: The device of aspect 15, wherein the number of individual collection chambers of the plurality of collection chambers is equal to the number of collection stages (n) and the number of flow resistance microchannels of the one or more flow resistance microchannels of the buffer fluid delivery systems is one less than the number of collection stages (n−1).

Aspect 19: The device of aspect 15, wherein the each of the one or more flow resistance microchannels of the buffer fluid delivery section has a resistance width, a resistance length, and a resistance path shape configured to receive the buffer fluid at a first end of said flow resistance microchannel and deliver the buffer fluid at a predetermined rate.

Aspect 20: The device of aspect 19, wherein individual ones of the one or more flow resistance microchannels has a resistance width, a resistance length, and a resistance path shape configured to deliver the buffer fluid a predetermined rate for the individual flow resistance microchannel.

Aspect 21: The device of aspect 19, wherein the resistance path shape of the individual flow resistance microchannels has a curved alternating pattern configured to control the flow direction of the buffer fluid.

Aspect 22: The device of aspect 19, wherein the individual flow resistance microchannels each comprise a plurality of section lengths arranged in parallel and connected by curved segments that form a 180° turn at alternating ends and form a continuous length of the flow resistance microchannel.

Aspect 23: The device of aspect 22, wherein each of the one or more flow resistance microchannels has a section length of the plurality of section lengths ranges from about 500 μm to about 3000 μm having the resistance width of about 50 μm to about 200 μm and spaced at a distance of about 50 μm to about 200 μm.

Aspect 24: The device of aspect 22, wherein each of the one or more flow resistance microchannels has a section length of the plurality of section lengths of about 1500 μm having the resistance width of about 100 μm and spaced at a distance of about 100 μm.

Aspect 25: The device of aspect 19, wherein each of the one or more flow resistance microchannels has a resistance width ranging from about 50 μm to about 200 μm.

Aspect 26: The device of aspect 19, wherein each of the one or more flow resistance microchannels has a resistance length ranging from about 50 mm to about 300 mm in total length.

Aspect 27: The device of aspect 15, wherein the number of individual collection chambers of the plurality of collection chambers is equal to the number of collection stages (n) and the number of flow resistance microchannels of the one or more flow resistance microchannels of the buffer fluid delivery systems and the number of individual mixers corresponding to the one or more subsequent collection stages is one less than the number of collection stages (n−1).

Aspect 28: The device of aspect 15, wherein the individual mixer corresponding to the one or more subsequent collection stages comprises a mixing microchannel having a mixer width, a mixer length, and a mixer path shape configured to mix the buffer fluid with the mixed ferrofluid biological sample from the previous collection stage to dilute the ferrofluid concentration of the mixed ferrofluid biological sample for the individual collection stage.

Aspect 29: The device of aspect 28, wherein the mixer length for each individual mixer corresponding to the one or more subsequent collection stages is configured for the individual collection stage.

Aspect 30: The device of aspect 29, wherein the mixer length is between about 20 mm to about 120 mm.

Aspect 31: The device of aspect 29, wherein the mixer in the first subsequent collection stage of the one or more subsequent stages in the series of collections stages has the mixer length of about 20 mm to about 80 mm and the mixer length of each of the remaining subsequent stages of the one or more subsequent stages increases in length by about 2.5 mm to about 10 mm.

Aspect 32: The device of aspect 28, wherein the mixer width for each individual mixer corresponding to the one or more subsequent collection stages is configured for the individual collection stage.

Aspect 33: The device of aspect 32, wherein the mixer width is between about 50 μm to about 400 μm.

Aspect 34: The device of aspect 32, wherein the mixer width is about 200 μm.

Aspect 35: The device of aspect 28, wherein the mixer path shape for each individual mixer corresponding to the one or more subsequent collection stages is configured for the individual collection stage.

Aspect 36: The device of aspect 28, wherein the mixer path shape has an alternating pattern of mixer sections at an angle and configured to mix the buffer fluid with the mixed ferrofluid biological sample.

Aspect 37: The device of aspect 28, wherein the mixer sections are positioned at an angle of about 10° to about 40° relative to each other in the alternating pattern to form a continuous length.

Aspect 38: The device of aspect 37, wherein the mixer sections are about 800 μm to about 2400 μm.

Aspect 39: The device of aspect 37, wherein the mixer sections are about 1200 μm.

Aspect 40: The device of aspect 28, wherein the individual mixer further comprises a plurality of internal protrusions configured to mix the buffer fluid with the mixed ferrofluid biological sample from the previous collection stage to dilute the ferrofluid concentration of the mixed ferrofluid biological sample for the individual collection stage.

Aspect 41: The device of aspect 40, wherein the plurality of internal protrusions are arranged at an angle of about 30° to about 90° with respect to a sidewall of the mixing microchannel.

Aspect 42: The device of aspect 40, wherein the plurality of internal protrusions are arranged at an angle of about 45° with respect to a sidewall of the mixing microchannel.

Aspect 43: The device of any of aspects 40-42, wherein the plurality of internal protrusions are arranged against the flow of the mixed ferrofluid biological sample.

Aspect 44: The device of aspect 15, wherein the individual collection chambers of the plurality of collection stages arranged in series vary in volume according to the individual collection stage.

Aspect 45: The device of aspect 15, wherein the first collection chamber of the first collection stages has a width of about 0.5 mm to about 1 mm and effective separation region of about 0.5 mm to about 1 mm.

Aspect 46: The device of aspect 15, further comprising a plurality of incubation chambers arranged in an incubation section adjacent to the cell collection section, wherein the number of incubation chambers corresponds to the number of collection stages and the individual collection chamber and individual incubation chamber for each collection stage are in fluid communication.

Aspect 47: The device of aspect 46, wherein the one or more magnetic sources adjacent to the cell collection section is moveable and the cells captured within the individual collection chambers of the cell collection section are delivered to the individual incubation chambers of the incubation section by translating the one or more magnetic sources from the position adjacent to the cell collection section to a position adjacent to the incubation section.

Aspect 48: A system comprising:
a plurality of magnetic microbeads adapted for adapted to specifically bind to the primary antibodies to form cell-bead complexes, thereby producing a magnetically labeled biological sample comprising a plurality of cell-bead complexes, wherein the cellular magnetic content of the individual cell-bead complex is proportional to a volumetric antigen-binding capacity of the individual target cell;
a biocompatible ferrofluid comprising a plurality of magnetic nanoparticles and a biocompatible surfactant, the biocompatible ferrofluid adapted to be combined with the magnetically labeled biological sample to make a mixed ferrofluid biological sample; and
the microfluidic device of aspect 15.

The features of the method of aspect 1 can be implemented with any of the devices of aspects 15-47 and/or 48 above.

The features of the embodiments described herein are representative and, in alternative embodiments, certain features and elements can be added or omitted. It is to be understood that, unless otherwise indicated, the present disclosure is not limited to particular materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

Additional details regarding the devices, kits, and methods, of the present disclosure are provided in the Examples below. The specific examples below are to be construed as merely illustrative, and not limitative of the remainder of the disclosure in any way whatsoever. Without further elaboration, it is believed that one skilled in the art can, based on the description herein, utilize the present disclosure to its fullest extent.

### EXAMPLES

Now having described the embodiments of the present disclosure, in general, the following Examples describe some additional embodiments of the present disclosure. While embodiments of the present disclosure are described in connection with the following examples and the corresponding text and figures, there is no intent to limit embodiments of the present disclosure to this description. On the contrary, the intent is to cover all alternatives, modifications, and equivalents included within the spirit and scope of embodiments of the present disclosure.

### Example 1

### Simultaneous and Multimodal Antigen Profiling and Isolation of Rare Cells Via Quantitative Ferrohydrodynamic Cell Separation

Simultaneous cell profiling and isolation based on cellular antigen binding capacity plays an important in understanding and treating diseases. However, fluorescence-activated cell sorting (FACS) and magnetic-activated cell sorting (MACS) are not able to meet this need, due to their requirement of a large quantity of target cells and the limitation stemmed from bimodal separation. The quantitative ferrohydrodynamic cell separation (qFCS) device and microfluidic method disclosed herein can achieve multimodal rare cell sorting and simultaneous antigen profiling at a ˜30,000 cell min⁻¹ throughput with a 96.49% recovery rate and a 98.72% purity of recovered cells. The qFCS device profiles and sorts cells via cellular magnetic content of the magnetically labeled cells, which correlates to cellular antigen-binding capacity. By integrating cellular magnetophoresis and diamagnetophoresis in biocompatible ferrofluids, it is demonstrated that the resulting qFCS device can accurately profile and isolate rare cells even when present at ˜1:50,000 target to background cells frequency. The qFCS device can accurately profile and isolate T lymphocytes based on a low-expression CD154 antigen and allow on-device analysis of cells after processing. This method could address the need for simultaneous and multimodal rare cell isolation and profiling in disease diagnostics, prognostics, and treatment.

Profiling of surface antigen expression on rare cells and their isolation for subsequent functional, protein, and genetic analyses in a biological sample have significant implications in disease diagnostics, prognostics, and treatment. For example, in human immune-mediated diseases, rare immune cells collected from the patients were separated and analyzed according to their antigens to evaluate the immune function, disease state, and therapeutic effects. In human cancers, rare circulating tumor cells in the blood circulation of the patients were sorted and characterized based on their antigens to understand metastasis and inform therapeutic options. Surface antigen molecules on the rare cells are responsible for a wide range of cellular functions, and their expressions are often heterogeneous and can evolve dynamically over the course of the cell cycle, making simultaneous antigen-based profiling and cell isolation a critical but challenging task. This task is further compounded by the rarity of the target cells, which can occur when they exist at very low frequencies in a complex matrix or when a limited amount of samples is available. These challenges made it difficult for the application of conventional methods to accomplish antigen profiling and cell isolation at the same time. Even though fluorescence-activated cell sorting (FACS) has been well established for antigen profiling, it has limited success in rare cell applications, and cells profiled in the FACS are not always suitable for subsequent analyses. An alternative magnetic-activated cell sorting (MACS) can isolate rare cells from a sample for downstream analysis via magnetic labeling of surface antigens, however, it lacks the ability to perform multimodal isolation based on the quantitative levels of antigen expressions, due to the fact that it operates primarily via a bimodal separation mechanism. Because of the limitations facing the conventional methods, new approaches are urgently needed to profile surface antigens from limited amounts of biological cells and isolate the cells based on their antigen expressions in a multimodal manner.

The microfluidic method can perform simultaneous and multimodal rare cell profiling and isolation based on a unique cellular property—cellular magnetic content, which is shown to correlate to magnetically labeled cell's antigen-binding capacity. This method relies on a microfluidic device architecture that achieves precise control over the concentration of a magnetic medium (ferrofluids) along a microchannel, resulting in concurrent characterization and isolation of magnetically labeled rare cells according to their magnetic contents and antigen-binding capacities with single-cell resolution. This new method, referred to as the quantitative ferrohydrodynamic cell separation (qFCS) method herein, can achieve antigen profiling and cell isolation via ferrohydrodynamic forces acting on cellular magnetic contents in a quantitative and multimodal manner. The qFCS method allows the sorting of rare cells into multiple cell-collection chambers in a prototype qFCS device that integrates cellular “diamagnetophoresis” and “magnetophoresis” in biocompatible ferrofluids in a continuous-flow microfluidic device, leading to an overall 96.49% recovery of rare cells with a high cell purity of 98.72% across multiple cell lines. The qFCS has a very high level of sensitivity and is able to quantitatively profile rare cells' antigen-binding capacities accurately even when they are present at ˜1:50,000 target to background cells frequency and when the cellular antigen expressions are low. The profiled cells are isolated simultaneously into multiple cell-collection chambers of the qFCS device according to the levels of their antigen bindings, resulting in a multimodal isolation method that can differentiate target cells with subtle cellular magnetic content differences. qFCS offers high-performance antigen profiling and cell isolation that is not available in existing magnetism-based microfluidic methods.

In the next sections, the theoretical background of the qFCS, the design and calibration of the qFCS for specific cell applications, the evaluation of the qFCS in recovering rare cells and profiling rare cells' antigen binding capacities, and the application of the qFCS in T lymphocytes profiling and isolation via a low-expression CD154 surface antigen are discussed.

### Results and Discussion

Theory of Quantitative Ferrohydrodynamic Cell Separation (qFCS)

The goal of the quantitative ferrohydrodynamic cell separation (qFCS) method is to simultaneously provide quantitative information about the antigen-binding capacity within the rare cells and isolate rare cells based on their antigen-binding capacity in a multimodal manner. This goal is achieved through a qFCS device that can perform cell isolation according to cellular magnetic content, a dimensionless variable defined as the volume fraction of magnetic materials in a magnetically labeled cell. In this section, cellular magnetic content is shown to correlate to the cell's antigen-binding capacity. First, the relationship between antigen binding capacity and cellular magnetic content, then derive the governing equations for qFCS to guide the design and calibration of its devices is discussed.

### Linking Cellular Magnetic Content of a Cell-Bead Complex to its Surface Antigen-Binding Capacity

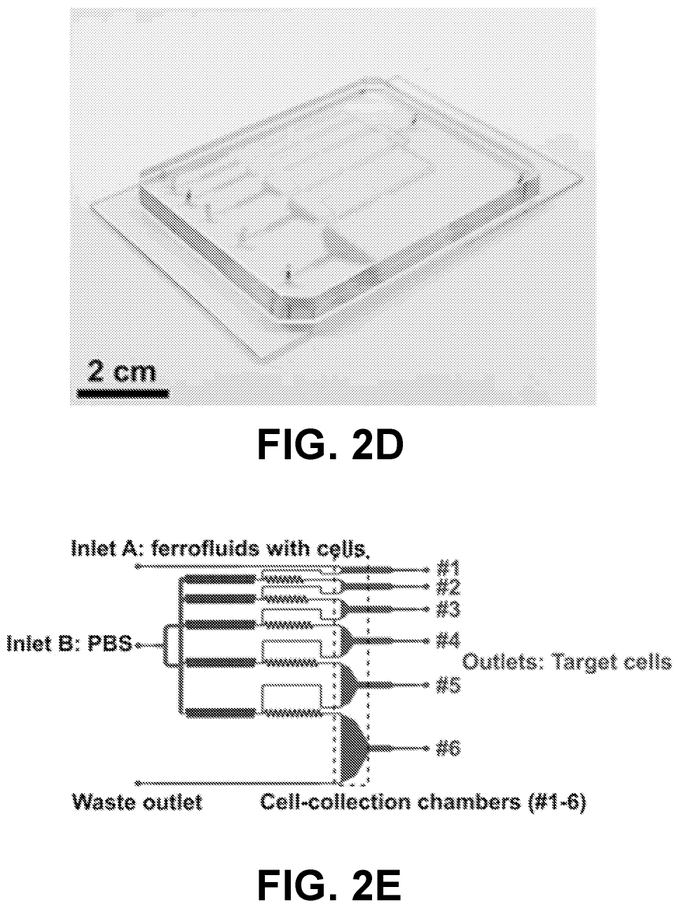

The predominant approaches in magnetic cell labeling include direct and indirect labels. Direct labeling uses primary antibodies conjugated to magnetic beads, in order to selectively bind to cells that express the corresponding antigen molecules. On the other hand, indirect labeling, a two-step process, first uses a primary antibody against a specific cell surface antigen, then uses a secondary antibody conjugated to a magnetic bead to bind to the primary antibody through its secondary binding sites. Equations are derived to relate the cellular magnetic content ϕ_{cell-beads} (a dimensionless variable, defined as the volume fraction of magnetic materials in a magnetically labeled cell) from its magnetic bead labeling to its surface antigen-binding capacity. First, the more commonly used indirect magnetic labeling process is considered. This relationship derived for indirect labeling also holds true for the case of direct labeling. The indirect magnetic labeling process is illustrated in FIG. 2A, where a primary antibody with secondary binding sites is first bound to a specific antigen on a cell's surface. Magnetic beads with secondary antibodies then bind to the secondary binding sites on the primary antibody, which forms a magnetic cell-beads complex. The total number of magnetic beads bound to a single cell's surface through indirect labeling is,

$${n}_{magnetic - beads} = α \times β \times γ \qquad ( 1.1 )$$

where α is the cell surface antigen-binding capacity, which is a quantitative measure representing the number of the primary antibodies bound to the cell. α depends on three parameters, including the total number of binding sites of both specific and non-specific antigens on the cell surface, the fraction of antigens (specific and non-specific) bound by the primary antibodies, and the valence of the primary antibody (i.e., the number of antigen-binding sites occupied by one primary antibody). β is the antibody amplification due to the secondary antibody binding to multiple sites on the primary antibody. β is also a quantitative measure that corresponds to the number of secondary antibodies per primary antibody. It depends on three parameters, including the number of binding sites on the primary antibody recognized by the secondary antibody, the fraction of binding sites on the primary antibody that are bound by the secondary antibody, and the valence of secondary antibody binding (i.e., the number of secondary binding sites occupied by one secondary antibody). Finally, γ represents the number of magnetic beads conjugated to each secondary antibody.

Equation (1.1) shows that the total number of magnetic beads bound to a single cell's surface through indirect magnetic labeling (FIG. 2A) is determined by three parameters: α (antigen-binding capacity−the number of the primary antibodies bound to the cell), β (antibody amplification−the number of secondary antibodies per primary antibody), and γ (the number of magnetic beads conjugated to each secondary antibody). For cells used in this study, both β and γ are assumed constant for the secondary antibody and magnetic beads when they are made from the same batch. As a result, the total number of magnetic beads n_{magnetic-beads} bound to a single cell's surface becomes proportional to the remaining variable, cell surface antigen-binding capacity α, which corresponds to the number of the primary antibodies bound to each cell.

$${n}_{magnetic - beads} = k α \qquad ( 1.2 )$$

Where k=β×γ is assumed to be a constant for the same batch of secondary antibody modified magnetic beads. For direct magnetic labeling, antibody amplification is not present, which leads to β=1. As a result, in both direct and indirect labeling processes, n_{magnetic-beads} appears to have a linear relationship with α when α is relatively small. However, as α increases, the available area on a cell's surface becomes limited for magnetic bead binding, n_{magnetic-beads} could saturate due to steric hinderance between neighboring magnetic beads.

The relationship between the cellular magnetic content ϕ_{cell-beads} and the total number of magnetic beads n_{magnetic-beads} bound to a single cell's surface can be established, thus the cell surface antigen-binding capacity α. The cellular magnetic content ϕ_{cell-beads} of a cell-beads complex is defined as,

$${ϕ}_{cell - beads} = \frac{{V}_{magentic - content}}{{V}_{cell - beads}} \qquad ( 1.3 )$$

where V_{magnetic-content} is the volume of magnetic materials of the cell-beads complex, and V_{cell-beads} is the total volume of the cell-beads complex including the cell and magnetic beads, and has the following expression,

$${V}_{cell - beads} = \frac{π {D}_{cell}^{3}}{6} + {n}_{magnetic - beads} \times \frac{π {D}_{magnetic - bead}^{3}}{6} \qquad ( 1.4 )$$

where the spherical diameter of the cell is D_{cell}, and the diameter of a single magnetic bead is D_{magnetic-bead}. Substituting Equation (1.4) into Equation (1.3), the following expression relates the cellular magnetic content ϕ_{cell-beads} to the total number of magnetic beads n_{magnetic-beads} bound to a single cell's surface,

$${ϕ}_{cell - beads} = \frac{{n}_{magnetic - beads} \times \frac{π {D}_{magnetic - bead}^{3}}{6} \times {ϕ}_{magnetic - bead}}{\frac{π {D}_{cell}^{3}}{6} + {n}_{magnetic - beads} \times \frac{π {D}_{magnetic - bead}^{3}}{6}} = \frac{{n}_{magnetic - beads} \times {D}_{magnetic - bead}^{3} \times {ϕ}_{magnetic - bead}}{{D}_{cell}^{3} + {n}_{magnetic - beads} \times {D}_{magnetic - bead}^{3}} \qquad ( 1.5 )$$

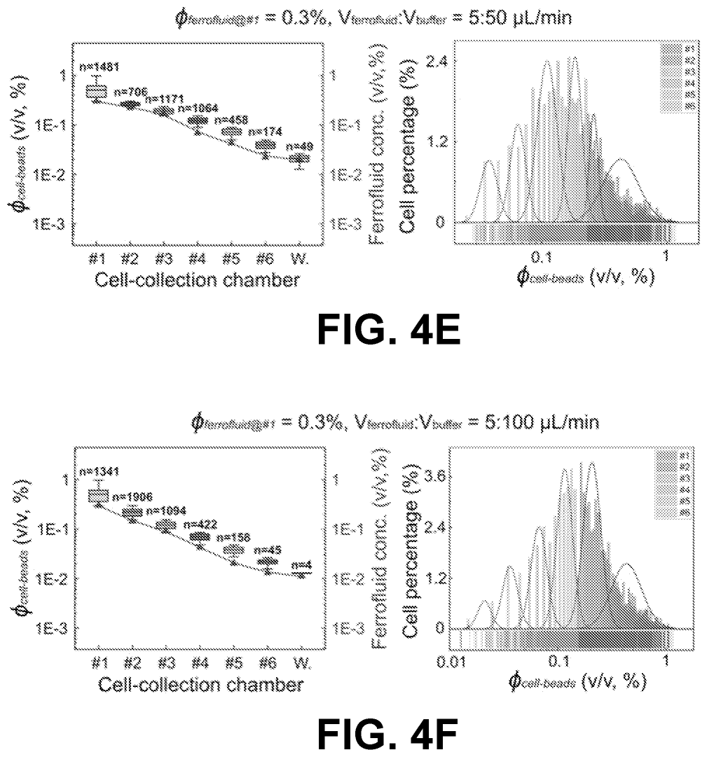

The relationship between the cellular magnetic content ϕ_{cell-beads} and the number of magnetic beads n_{magnetic-beads} on the cell surface in Equation (1.5) can be approximated as a linear relationship when the cellular diameters are constant (FIG. 9). However, for realistic cellular applications, cell diameters are heterogeneous thus this effect needs to be taken into account. For this purpose, Equations (1.2) and (1.5) are combined and simplified assuming D_{cell}³<<n_{magnetic-beads}×D_{magnetic-bead}³ (the diameter of magnetic beads D_{magnetic-bead} in this study is ˜10 times smaller than that of a cell D_{cell}), which leads to the following relationship between the cellular magnetic content ϕ_{cell-beads} and the cell's surface antigen-binding capacity α,

$${ϕ}_{cell - beads} = ( {kD}_{magnetic - bead}^{3} {ϕ}_{magnetic - bead} ) \frac{α}{{D}_{cell}^{3}} \qquad ( 1.6 )$$

Equation (1.6) shows that the cellular magnetic content ϕ_{cell-beads} is proportional to a “cell volumetric antigen binding capacity” α/D_{cell}³ when other parameters k, D_{magnetic-bead}³ and ϕ_{magnetic-bead} are constant. Equation (1.6) can be further transformed by introducing a “cell surface density of antigen binding capacity” α_{S}=α(πD_{cell}²), which leads to,

$${ϕ}_{cell - beads} = ( π {kD}_{magnetic - bead}^{3} {ϕ}_{magnetic - bead} ) \frac{{α}_{S}}{{D}_{cell}} \qquad ( 1.7 )$$

Equation (1.7) shows that the cellular magnetic content ϕ_{cell-beads} is proportional to the ratio of surface density of antigen binding capacity to cellular diameter α_{S}/D_{cell}.

Equations (1.6) and (1.7) relate an experimentally measurable entity-cellular magnetic content ϕ_{cell-beads} to cells' intrinsic properties including their diameters and antigen binding capacities. The relationships between cellular magnetic content ϕ_{cell-beads} and the cell's surface antigen-binding capacity α, or the cell's surface density of antigen binding capacity α_{S} depend on the cellular diameter. As a result, once the cellular magnetic content ϕ_{cell-beads} and cellular diameter D_{cell} are determined, they can be used to calculate the antigen-binding capacity or its density. In the next section, the governing equations of the quantitative ferrohydrodynamic cell separation (qFCS) which enables us to experimentally measure the cellular magnetic content ϕ_{cell-beads} is introduced.

Governing Equations of qFCS

Given that in this study, cellular magnetic content ϕ_{cell-beads} is related to the cell's surface antigen-binding capacity α, and the cell's surface density of antigen binding capacity α_{S}, a microfluidic technology was developed that can experimentally quantify ϕ_{cell-beads} among a cell population while simultaneously isolate cells based on their ϕ_{cell-beads}. This goal was achieved by integrating cellular “diamagnetophoresis” and “magnetophoresis” in biocompatible ferrofluids in a continuous-flow microfluidic device. This method is termed “quantitative ferrohydrodynamic cell separation (qFCS)” because it can isolate cells based on the quantitative levels of individual cell's antigen-binding capacity α. In comparison, traditional MACS only performs binary cell separation in which labeled cells are separated from unlabeled ones.

The working principle of qFCS is summarized in FIGS. 2B-2C. Within a cell population, cells of interest are first rendered magnetic by either direct or indirect magnetic labeling. The cellular magnetic content ϕ_{cell-beads} of a cell-beads complex after labeling becomes related to its antigen-binding capacity α. The cell population then continuously flow through a qFCS device which has multiple stages of ferrofluids with spatially stable and variable magnetic concentrations over the course of experiments. Within the device, qFCS generates a magnetic force on the cell-beads complex, whose magnitude is dictated by the delicate balance between the cell-beads complex's magnetization from the labeling of magnetic beads and cell-beads complex's surrounding magnetic medium-ferrofluids. When cell-beads complex's magnetization \vec{M}_{cell-beads} exceeds its surrounding ferrofluid's magnetization \vec{M}_{ferrofluid}, the net magnetic force on the cell-beads complex traps it in one of the stages of the device. On the other hand, when cell-beads complex's magnetization \vec{M}_{cell-beads} is equal to or less than its surrounding ferrofluid's magnetization \vec{M}_{ferrofluid}, the net magnetic force on the cell-beads complex drives it to the next stage of the device. This way, as the cell population flows through the qFCS device, they can be isolated into one of the chambers with a ferrofluid concentration that matches their cellular magnetic contents, as well as their antigen-binding capacity (FIG. 2C).

The magnetic forces on the cell-bead complex in qFCS are introduced as follows. Under an external magnetic field, ferrofluids have a magnetization of \vec{M}_{ferrofluid}, while cell-beads complex possesses a magnetization of \vec{M}_{cell-beads}, due to its labeling of magnetic beads. The interaction of the cell-bead complex with the external magnetic field depends on the balance of both “magnetophoresis” and “diamagnetophoresis”. FIG. 2B shows that magnetophoretic force results from the conjugated magnetic beads on the cell and directs the cell towards the maximum of a non-uniform magnetic field, while diamagnetophoretic force results from ferrofluids' magnetic nanoparticle-induced pressure imbalance on the cell's surface and directs the cell towards the minima of the magnetic field. The overall magnetic force on the cell-bead complex in the ferrofluid under an external magnetic field can be found in previous reports, and is also derived in details in Example 2. Here, the overall magnetic force acting on the cell-beads complex, which is the sum of the two competing forces: diamagnetophoretic and magnetophoretic forces, is defined as:

$${\vec{F}}_{m} = {\vec{F}}_{diamagnetophoretic} + {\vec{F}}_{magnetophoretic} = - {μ}_{0} {V}_{cell - beads} \{ ( {\vec{M}}_{ferrofluid} - {\vec{M}}_{cell - beads} ) \cdot ∇ \} \vec{H} \qquad ( 1.8 )$$

Equation (1.8) is derived in detail steps in Example 2. This magnetic force expression does not consider magnetic bead-to-bead interaction and its effect on the force experienced by the cell-beads complex. The bead-to-bead interaction is estimated and its effect on the magnetic force (shown in Example 2) and found it to be negligible in the experimental conditions. From Equation (1.8), it is known that the direction and magnitude of the overall magnetic force \vec{F}ₘ acting on a cell-beads complex in qFCS depends delicately on the product of the cell-beads complex's volume and the magnetization contrast between the cell-beads complex and the ferrofluid, i.e., the term V_{cell-beads}(\vec{M}_{ferrofluid}−\vec{M}_{cell-beads}) in Equation (1.8). it is noted that similar to the case where a cell-beads complex's magnetization \vec{M}_{cell-beads} is the product of its magnetic content ϕ_{cell-beads} and the bulk magnetization of magnetic materials in the magnetic bead \vec{M}_{bulk_cell-beads}, a ferrofluid's magnetization \vec{M}_{ferrofluid} is also the product of its magnetic content ϕ_{ferrofluid} (often referred to as ferrofluid concentration, which is the volume fraction of magnetic materials in the ferrofluid) and the bulk magnetization of magnetic materials in the ferrofluid \vec{M}_{bulk_ferrofluid},

$${\vec{M}}_{ferrofluid} = {ϕ}_{ferrofluid} \times {\vec{M}}_{bulk \_ ferrofluid} \qquad ( 1.9 )$$

Now the case in which a cell-beads complex flows through one of the stages of the ferrofluids in the qFCS (FIG. 2C) is considered. When the condition of \vec{M}_{cell-beads}≤\vec{M}_{ferrofluid} is met, i.e., ϕ_{cell-beads}≤ϕ_{ferrofluid}, assuming the ferrofluid and the magnetic beads are made of the same magnetic material, the diamagnetophoretic force overcomes the magnetophoretic force and drives the cell-beads complex to the next stage against a hydrodynamic viscous drag. On the other hand, when the condition of \vec{M}_{cell-beads}>\vec{M}_{ferrofluid} is met, i.e., ϕ_{cell-beads}>ϕ_{ferrofluid}, the magnetophoretic force outweighs the diamagnetophoretic force and traps the cell-beads complex in that stage. This way, each stage of the qFCS with a variable ferrofluid concentration ϕ_{ferrofluid} can trap cell-beads complexes with matching cellular magnetic content. Because cellular magnetic content ϕ_{cell-beads} is shown to correlate to the cell's surface antigen-binding capacity α, and the cell's surface density of antigen binding capacity α_{S}, qFCS can be used to isolate cells based on their binding levels of a specific antigen, while also measuring the distribution of that antigen's binding capacity among the cell population.

The above-mentioned qFCS principle can be applied to the design and fabrication of a prototype device, which includes a microfluidic device and a permanent magnet (FIG. 2C). The microfluidic device, shown in FIGS. 2D-2E, has six stages of spatially stable and concentration variable ferrofluids that can be generated and maintained over the course of the experiments (FIG. 2F, top panel). Each stage of qFCS has a corresponding cell-collection chamber (dashed boxes in FIG. 2E) that is used to collect cell-beads complexes with a matching cellular magnetic content to the ferrofluid concentration in that stage. This prototype device could isolate human white blood cells (WBCs) into the cell-collection chambers based on their cellular magnetic contents ϕ_{cell-beads} and their antigen-binding capacity of CD45 (FIG. 2F, bottom panel). In the following section, the design considerations and calibration processes of the prototype qFCS device for specific cell separations are discussed.

Design and Calibration of qFCS
Design of qFCS

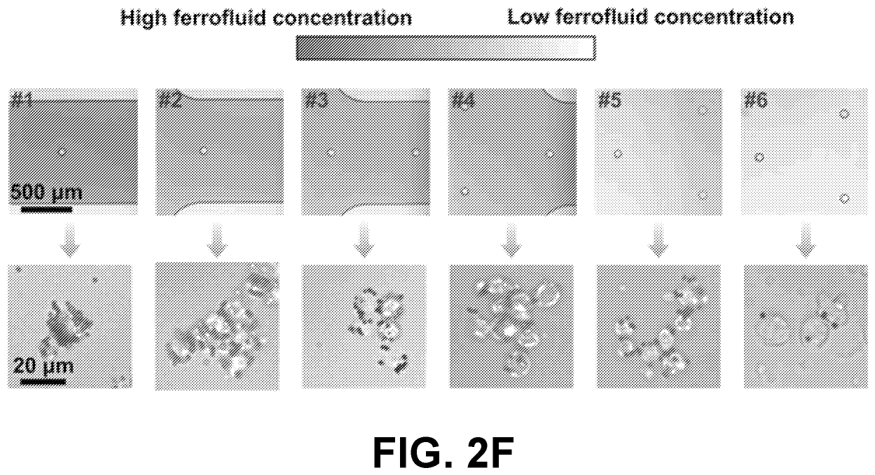

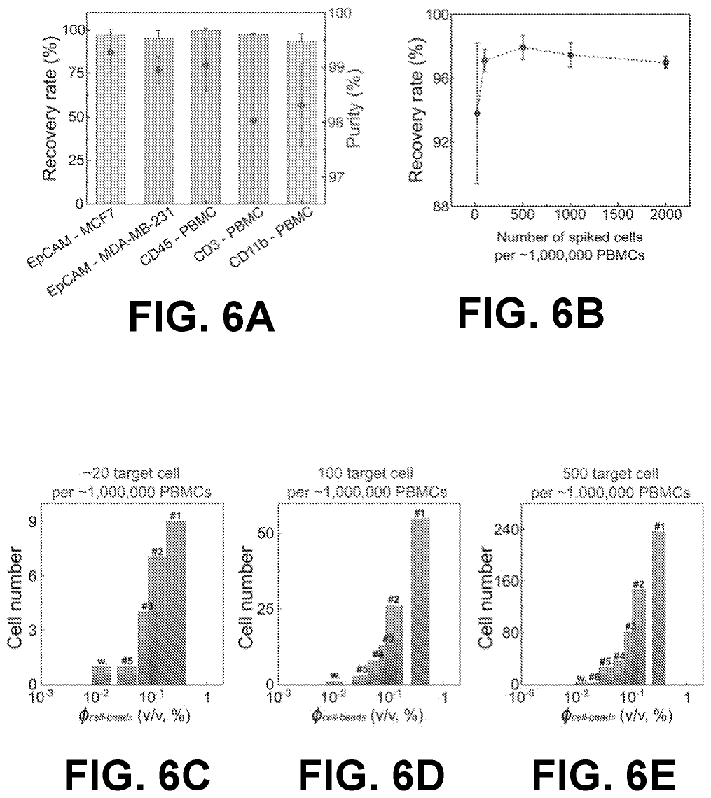

From the discussions in the previous section, the following outcomes are desired in order to apply the qFCS method for cell separations: (1) generation and maintenance of multiple spatially-stable ferrofluid stages with variable concentrations; (2) trapping of the cell-beads complex in a stage that satisfies the condition of ϕ_{cell-beads}>ϕ_{ferrofluid}. These considerations were addressed through a prototype qFCS device illustrated in FIGS. 2D-2E. In this device design, a ferrofluid flow with cells (Inlet A, FIG. 2E) is continuously mixed with a buffer flow (Inlet B, FIG. 2E) and diluted in its concentration as it flows through the six stages (#1-6, FIG. 2E) of the device. In this process, six cell-collection chambers (dashed box #1-6, FIG. 2E) with spatially-stable and decreasing ferrofluid concentrations are generated and sustained over time to allow for cell isolations in these chambers. A permanent magnet 108 (FIG. 3A) is positioned underneath the microfluidic device 100 and close to the collection chambers 106, so that sufficient magnetic forces (FIG. 13) can be produced to either trap the cell-bead complex in one of the cell-collection chambers or drive it to the next stage of the device, based on the contrast between the cellular magnetic content and the ferrofluid concentration in that stage. Separated cells in each cell-collection chamber can be characterized for their cellular magnetic contents, or collected via the outlets (Outlets, FIG. 2E) for further analysis. In designing this prototype device, the number of the stages and cell-collection chambers was chosen to be six in order to balance the complexity of the device and the ability to separate cells in a multimodal manner. The rationale to balance device complexity and multimodal cell separation can be explained as follows: as the number of stages and cell-collection chambers in a qFCS device increases, the complexity of the overall microfluidic channels, especially the number of the microchannels used for ferrofluid dilution (serpentine-shaped channels in FIG. 3B) increases, which leads to a reduced maximum cell flow rate and cell-processing throughput of the device; on the other hand, as the stages and cell-collection chambers decreases, the modes (cell-collection chambers) of the magnetic content-based cell isolation decreases. The current qFCS device has six stages and cell-collection chambers so that it can process a reasonable amount of cell samples at a ˜5 μL min⁻¹ flow rate and a ˜30,000 cell min⁻¹ throughput, while still providing six modes (cell-collection chambers) that can completely separate cells with a minimum difference in their cellular magnetic contents.

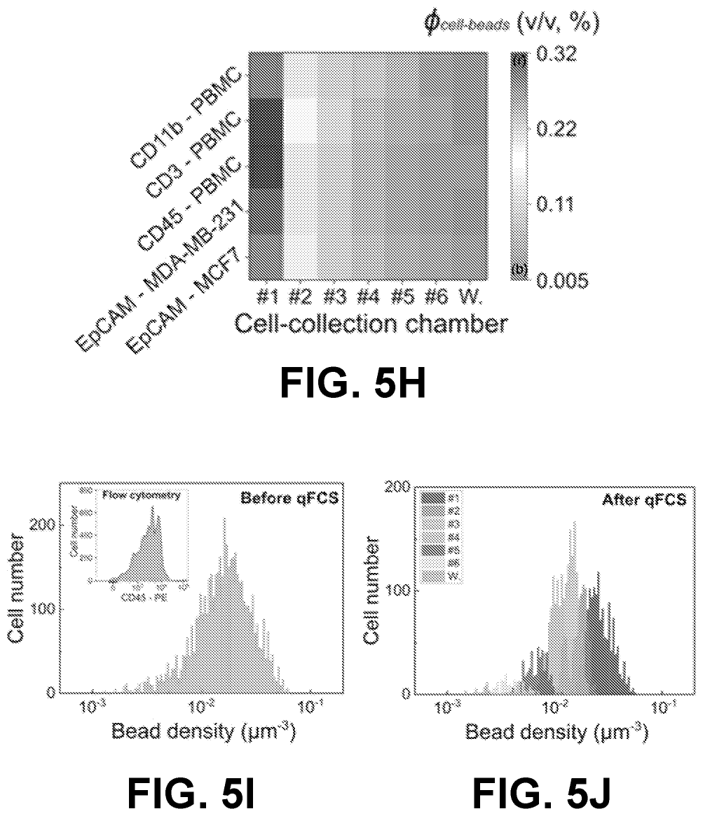

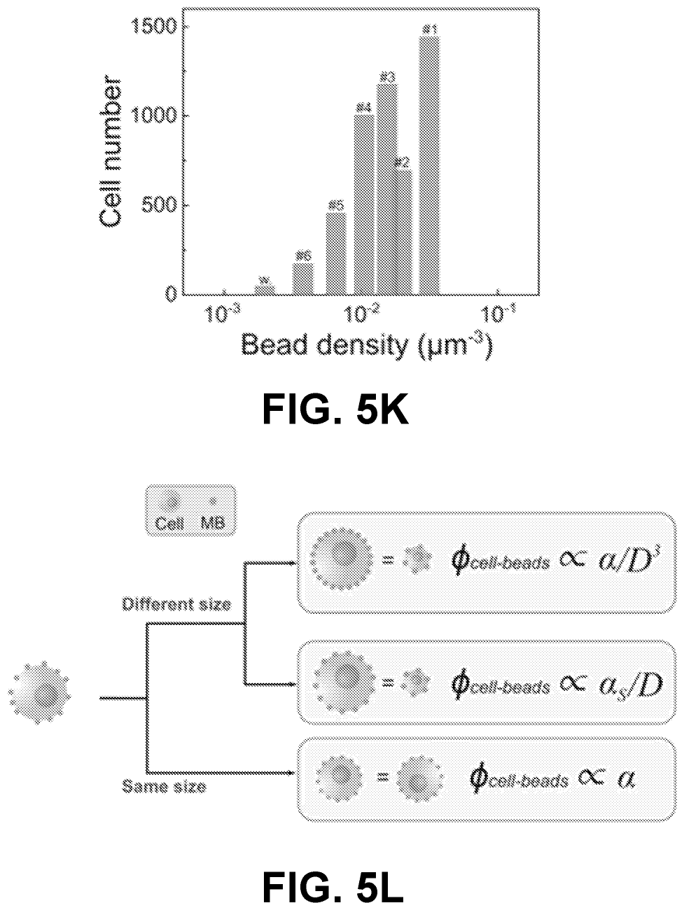

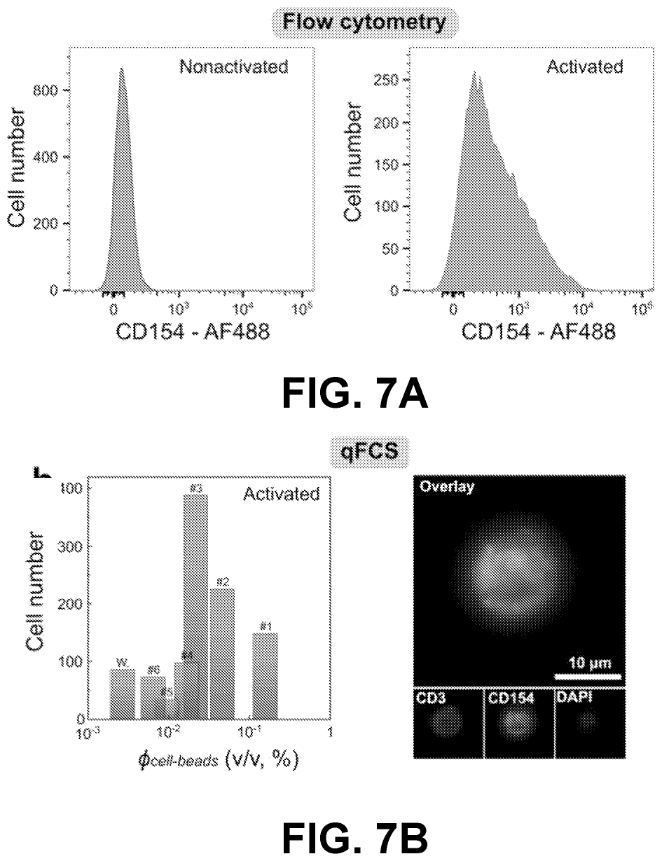

The qFCS device was calibrated to evaluate its ability to isolate and profile cells based on cellular magnetic content. The device was first examined for its ability to generate and maintain six stages of spatially stable and concentration-variable ferrofluids over time. Simulated profiles in FIGS. 3B-3C show that spatially stable ferrofluid concentrations in the effective cell flow region of the cell-collection chambers can be established in ˜1 minute and maintained with a continuous flow of ferrofluids (Inlet A, FIG. 2E) and buffer (Inlet B, FIG. 2E). The effective cell flow region of cell-collection chambers is defined as the region where the cells can travel to. In order to experimentally measure the ferrofluid concentrations in the qFCS cell-collection chambers, a linear relationship is first established between ferrofluids' light absorbance and its concentration (volume fraction of magnetic materials) in FIG. 3D. The theory of this linear relationship is derived in Example 2 and shown in FIG. 11. Using this linear relationship, together with the fact that ferrofluids' magnetization is proportional to its concentration (FIG. 3E), the ferrofluid concentration in the qFCS cell-collection chambers is obtained based on its light absorbance through imaging. This enabled us to investigate the ferrofluid concentration profiles in these chambers at variable flow rates and flow ratios (ferrofluid: buffer). FIG. 3F shows the relationship between the ferrofluid concentrations in the cell-collection chambers at a constant ferrofluid flow rate, but with variable flow ratios (ferrofluid:buffer). Both simulation and experimental data in FIG. 3F confirm that monotonically decreasing ferrofluid concentrations can be established in the qFCS device across stages and cell-collection chambers #1-6. Lowering flow ratios between the ferrofluid and the buffer accelerates the dilution of ferrofluids (FIG. 3F), while keeping the flow ratio between ferrofluid and buffer constant results in the same decreasing trend of dilution (FIG. 12). From these results, it is confirmed that: (1) a total of six spatially-stable ferrofluid concentrations can be established in ˜1 minute in the qFCS device and sustained over time to allow for subsequent cell profiling and isolation; (2) the maximum of the ferrofluid concentrations in the qFCS device is determined by the concentration of the starting ferrofluid flow (FIG. 14), while the decreasing trend of the ferrofluid concentrations across six stages and cell-collection chambers in the qFCS device is determined by the flow ratio between the ferrofluid and the buffer. These findings allow us to design patterns of ferrofluid concentration in the qFCS device according to specific cell separation needs.

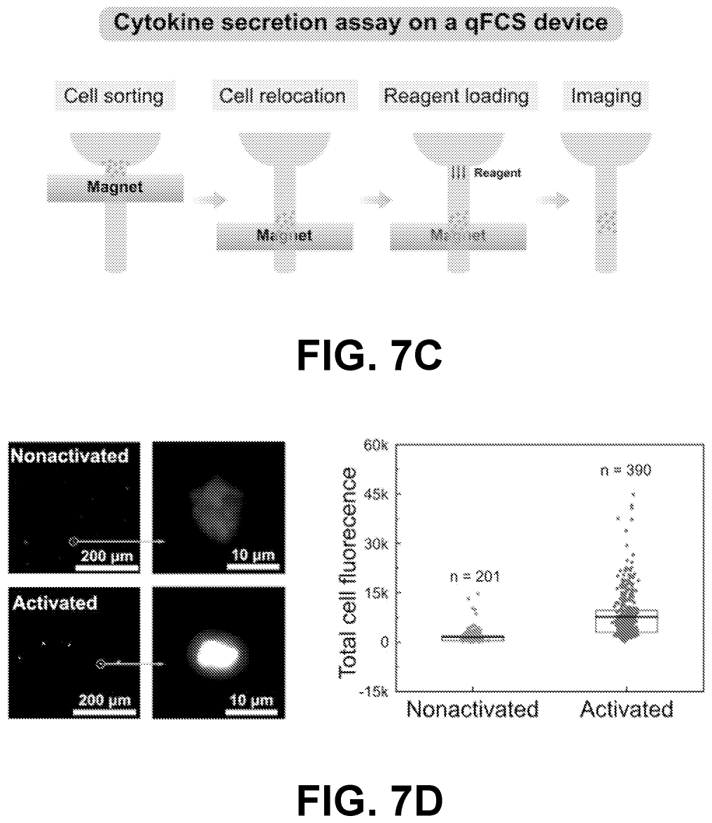

The qFCS device was also examined through simulation and experiments for its ability to trap cell-beads complexes in a cell-collection chamber that satisfies the condition of ϕ_{cell-beads}>ϕ_{ferrofluid}. A total flow rate was chosen for the qFCS device that was sufficiently slow so that cells passing through the device were predominately distinguished based on the contrast of their cellular magnetic contents and the ferrofluid concentration (FIG. 15). Simulated cell trajectories in FIG. 3G show that the stages and cell-collection chambers in the qFCS device can successfully differentiate cell-beads complexes based on the contrast of their magnetic content ϕ_{cell-beads} and the concentration of surrounding ferrofluids ϕ_{ferrofluid}. For example, in the case of ϕ_{cell-beads}≤ϕ_{ferrofluid} shown in the left panel of FIG. 3G, diamagnetophoretic force on the cell-beads complex equals or outweighs the magnetophoretic force and drives it to the next stage of the device. In the case of ϕ_{cell-beads}>ϕ_{ferrofluid} in the right panel of FIG. 3G, magnetophoretic force exceeds diamagnetophoretic force on the cell-beads complex and traps it in the current stage. Experimental images of the cell trajectories in FIG. 3H reveal that the magnetic force generated by the permanent magnet (FIG. 13) in the qFCS device resulted in a clear differentiation of two groups of cells based on their magnetic contents (ϕ_{cell-beads}≤ϕ_{ferrofluid} or ϕ_{cell-beads}>ϕ_{ferrofluid}) in one of the stages (stage #1). In summary, through both simulation and experiments, a qFCS device was designed that can generate and sustain spatially stable and variable ferrofluid concentrations across its six stages and cell-collection chambers to enable multimodal magnetic content-based cell profiling and isolation. This device is calibrated in the next section to optimize its operating parameters for specific cell applications.

Calibration of qFCS

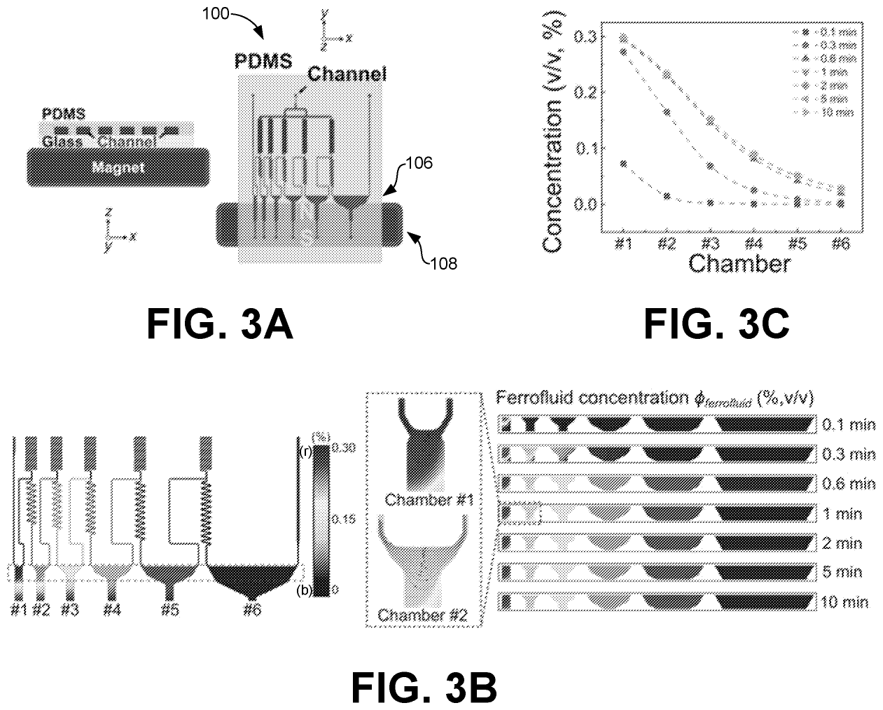

The qFCS device can generate and sustain six stages of decreasing ferrofluid concentrations, ϕ_{ferrofluid}, and profile and isolate cells based on cellular magnetic contents. However, for specific cell types, the operating parameters of this device, including its starting ferrofluid concentration and flow ratios between the ferrofluid and the buffer, should be carefully optimized by taking into account the physical and magnetic properties of the cells. The cells used in this study, including cancer cells and peripheral blood mononuclear cells (PBMCs), are estimated to have a physical diameter of 5-30 μm, with each cell being indirectly labeled with 1-50 magnetic beads. The magnetic beads used in this study have a 1.05 μm diameter and an 11.5% volume fraction of magnetic materials. Using these physical and magnetic properties, the distribution of cellular magnetic contents among the cell population was estimated to be 0.25±0.51% (v/v, mean±s.d., n=2,550) in FIG. 4A. The estimated cellular magnetic content instructed us to choose the starting ferrofluid concentration to be ˜0.3% (v/v) so that the majority of the cell-beads complexes can be isolated and profiled in the six cell-collection chambers of the qFCS device.

Prior to the cell experiments, simulations were used to investigate the range of cellular magnetic contents in the qFCS's cell-collection chambers. FIG. 4B shows the data in which a total of 2,550 cell-beads complexes, with their physical and magnetic properties sampled from FIG. 4A, were simulated using different flow ratios (ferrofluids:buffer). Firstly, it was learned that spatially stable and variable concentrations of ferrofluids were generated and sustained in both simulations. In both cases, the maximum ferrofluid concentration was decided by the starting ferrofluid concentration ϕ_{ferrofluid@#1}, which was 0.3% (v/v). The decreasing trend of ferrofluid concentrations across six stages was decided by the flow ratio between the ferrofluid and the buffer. Having a larger flow ratio between the ferrofluid and buffer led to a faster dilution of ferrofluids, therefore a smaller minimum ferrofluid concentration ϕ_{ferrofluid@#6} at the last stage (sixth stage) of the device. Secondly, cell-beads complexes were successfully isolated into one of the cell-collection chambers with matching cellular magnetic content and ferrofluid concentration. For example, n^{th} cell-collection chamber with a ferrofluid concentration of ϕ_{ferrofluid@#n} can isolate cell-beads complexes with a cellular magnetic content ϕ_{cell-beads} that falls into the range of ϕ_{ferrofluid@#n-1}≥ϕ_{cell-beads}>ϕ_{ferrofluid@#n}. The ranges of cellular magnetic contents in each cell-collection chamber when the sample passed through the device are summarized in Table 1, which shows that each chamber isolated a specific and non-overlapping range of cellular magnetic contents. it is noted that the ranges of cellular magnetic contents between neighboring chambers are not uniform, mainly because of the nonlinearity in the decreasing trend of the ferrofluid concentrations in the current device. It is also noted that cell-collection chamber #1 has a much wider range of cellular magnetic content comparing to other chambers, because it captures any cell-bead complex that satisfies the condition ϕ_{cell-beads}>ϕ_{ferrofluid@#1}. Thirdly, the flow ratio between the ferrofluid and the buffer determined the decreasing trend of ferrofluid concentrations across six stages. With a larger flow ratio (FIG. 4B, left panel, V_{ferrofluid}:V_{buffer}=5:50 μL min⁻¹), the decreasing trend of ferrofluid concentrations is slower, which leads to a narrower range of cellular magnetic contents that can be isolated and profiled. On the other hand, a smaller flow ratio (FIG. 4B, right panel, V_{ferrofluid}:V_{buffer}=5:100 μL min⁻¹) results in a faster-decreasing trend of ferrofluid concentrations, which implies a broader range of cellular magnetic contents that can be isolated and profiled (Table 1).

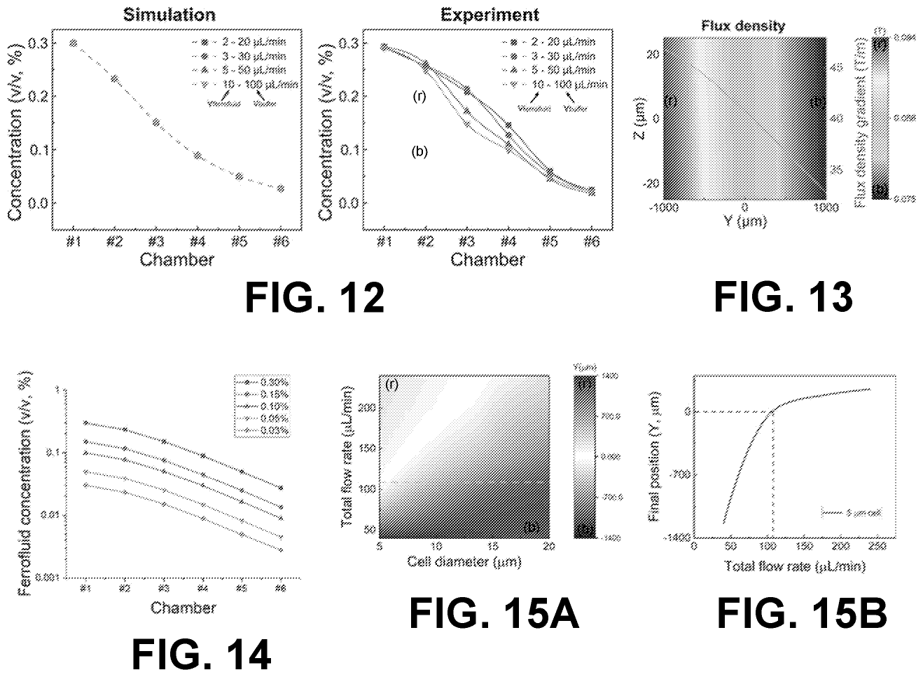

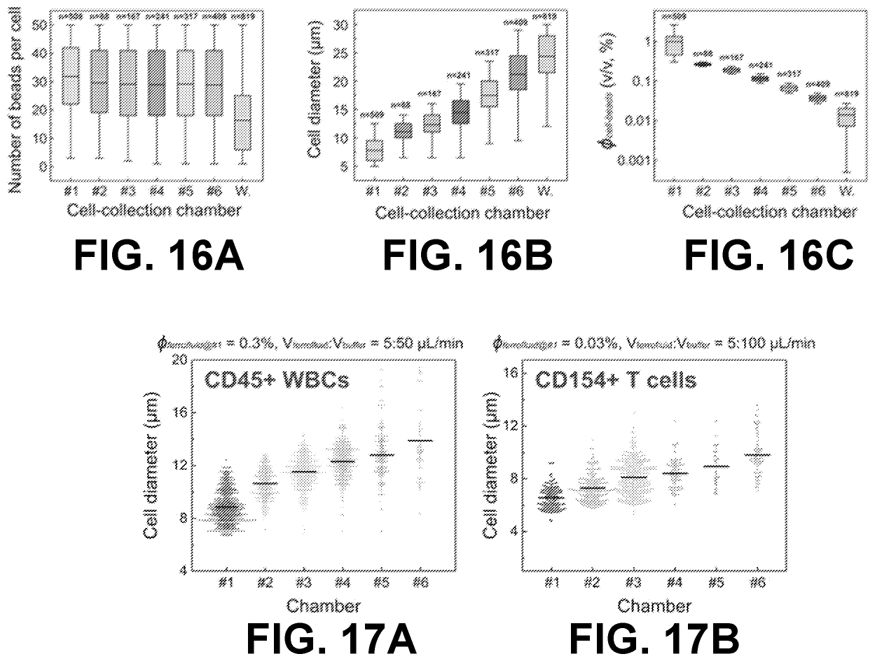

These simulation findings were compared with cell experiments in which ˜5,000 white blood cells (WBCs) with measured 6-23 μm diameters, indirectly labeled with anti-CD45 modified magnetic beads, were profiled and isolated by the qFCS devices in FIGS. 4C-4F. Firstly, experimental images in FIGS. 4C-4D from the WBCs profiling and isolation experiments show that neighboring cell-collection chambers in the qFCS device can differentiate cell-beads complexes based on their cellular magnetic contents ϕ_{cell-beads}. In each cell-collection chamber, qFCS captures a cell subpopulation that has variable cellular diameters and variable number of magnetic beads. Mean diameters of cells increase from chamber #1 to #6 (FIG. 17). Within each chamber, the number of magnetic beads on cells increases as the cell diameter increases (FIG. 18). However the cells in each chamber has a predetermined range of cellular magnetic contents ϕ_{cell-beads} that is decided by the ferrofluid concentration in that stage, demonstrating qFCS's ability to differentiate cells based solely on ϕ_{cell-beads}. The experimental range of cellular magnetic contents in each chamber matched the simulation data in Table 1. Secondly, it is noted that the ferrofluid concentration profiles and the range of cellular magnetic contents that can be processed from these experiments in FIGS. 4E-4F are consistent with the simulation estimates. The comparison of simulation and experimental data are presented in Table 1. Thirdly, it is noted that the waste outlets in WBCs experiments in FIGS. 4E-4F contain one to two orders of magnitudes smaller number of cells compared to their simulation estimates in FIG. 4B. This can be attributed to the fact that the simulations in FIG. 4B overestimated the number of cells that have small cellular magnetic contents (large diameters with very few magnetic beads attached). Taking together, these findings validated the simulation data so that the simulation process can be used in the future to determine the operating parameters of the qFCS device, including the starting ferrofluid concentration and flow ratios between the ferrofluid and the buffer, for specific cell separation applications.

TABLE 1
Quantification of multimodal and non-overlapping cell profiling and
isolation based on cellular magnetic contents in the qFCS device.

| | | | Range of | | | | | | |
|---|---|---|---|---|---|---|---|---|---|
| | | | cellular | Range of cellular magnetic contents in the cell-collection | | | | | |
| | | | magnetic | chambers (v/v, %) | | | | | |
| Starting | | | contents | Cell | Cell | Cell | Cell | Cell | Cell |
| ferrofluid | | | that can be | collection | collection | collection | collection | collection | collection |
| concentration | Flow ratio | Sources of | profiled | chambers | chambers | chambers | chambers | chambers | chambers |
| (v/v, %) | (ferrofluid:buffer) | data | (v/v, %) | #1 | #2 | #3 | #4 | #5 | #6 |
| 0.3 | V_{ferrofluid}:V_{buffer} = | Simulation | 0.00049- | 0.30- | 0.23- | 0.15- | 0.09- | 0.05- | 0.03- |
| | 5:50 μL min⁻¹ | | 3.64 | 3.64 | 0.30 | 0.23 | 0.15 | 0.09 | 0.05 |
| | | Experiment | 0.013- | 0.30- | 0.23- | 0.15- | 0.09- | 0.05- | 0.03- |
| | | | 1.16 | 1.16 | 0.30 | 0.23 | 0.15 | 0.09 | 0.05 |
| | V_{ferrofluid}:V_{buffer} = | Simulation | 0.00049- | 0.30- | 0.15- | 0.09- | 0.05- | 0.03- | 0.01- |
| | 5:100 μL min⁻¹ | | 3.64 | 3.64 | 0.30 | 0.15 | 0.09 | 0.05 | 0.03 |
| | | Experiment | 0.012- | 0.30- | 0.15- | 0.09- | 0.05- | 0.03- | 0.02- |
| | | | 1.18 | 1.17 | 0.30 | 0.15 | 0.09 | 0.05 | 0.03 |
| 0.03 | V_{ferrofluid}:V_{buffer} = | Simulation | 0.00049- | 0.030- | 0.023- | 0.015- | 0.009- | 0.005- | 0.003- |
| | 5:50 μL min⁻¹ | | 3.64 | 3.640 | 0.030 | 0.023 | 0.015 | 0.009 | 0.005 |
| | V_{ferrofluid}:V_{buffer} = | Simulation | 0.00049- | 0.030- | 0.015- | 0.009- | 0.005- | 0.003- | 0.001- |
| | 5:100 μL min⁻¹ | | 3.64 | 3.640 | 0.030 | 0.015 | 0.009 | 0.005 | 0.003 |

Evaluating qFCS for Simultaneous Cell Profiling and Isolation
Cell Profiling by qFCS

Using the prototype qFCS device and its optimized operating parameters, the device was validated with spiked cancer cells and peripheral blood mononuclear cells (PBMCs). These experiments were conducted to evaluate the performance of qFCS in both profiling antigen bindings and isolating rare cells based on their antigen bindings among a cell population. Firstly, the ability of qFCS in quantifying antigen-binding capacity in cultured cancer cells and peripheral blood mononuclear cells (PBMCs) was evaluated. The qFCS device profiles and separates cells based on the cellular magnetic content ϕ_{cell-beads}, which correlates to cells' antigen binding capacities and their cellular diameter as discussed in Equations (1.6) and (1.7). From the discussion, it is known that cellular magnetic content ϕ_{cell-beads} is proportional to a “cell volumetric antigen binding capacity”

$$α / {D}_{cell}^{3} ,$$

as well as to the ratio of antigen binding capacity density to cellular diameter α_{S}/D_{cell}. It also follows that ϕ_{cell-beads} is proportional to α when cellular diameters are constant. As a result, the experimental determinations of ϕ_{cell-beads} and/or D_{cell} can be used to profile the cells' antigen-binding capacity.

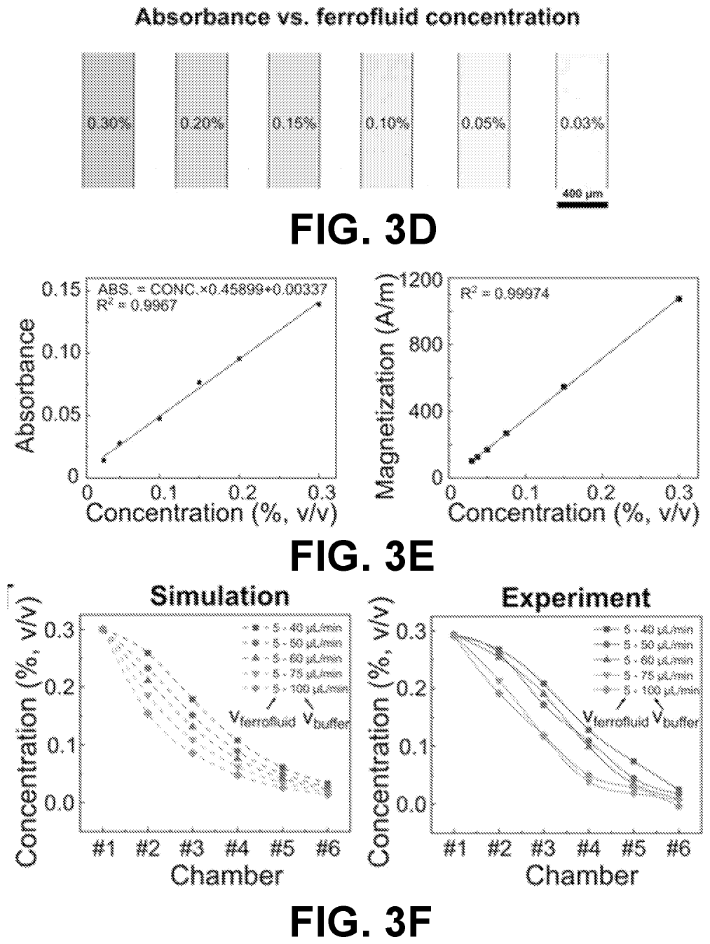

The experiments in this section optimized the operating parameters of the qFCS device, including a starting ferrofluid concentration ϕ_{ferrofluid} of 0.15% (v/v), a ferrofluid flow rate of 5 μL min⁻¹, and a buffer flow rate of 50 μL min⁻¹. The parameters were chosen after evaluating the cells' physical features and magnetic labeling. Five separate cell experiments were conducted to evaluate the profiling performance of the qFCS. The qFCS device can profile cells even with a low number of target cells. Each qFCS cell experiment started with ˜1,000 cells from a single culture (MCF7 breast cancer, MDA-MB-231 breast cancer, or PMBCs). The cells were indirectly labeled with magnetic beads (diameter: 1.05 μm; magnetic content: 11.5% (v/v)) that use antibodies targeting specific antigens on cell surface (anti-EpCAM for MCF7 breast cancer cells or MDA-MB-231 breast cancer cells, anti-CD45, anti-CD11b and anti-CD3 for PMBCs). Labeled cells were then spiked into ˜1,000,000 unlabeled PBMCs with a final volume of 200 UL and processed by a qFCS device. Cells in each cell-collection chamber of the device were imaged and analyzed for their cellular magnetic contents ϕ_{cell-beads} (FIGS. 5A-5E). It is noted that the qFCS devices profiled the “volumetric antigen binding capacities

$$α / {D}_{cell}^{3} ”$$

of all five types of cells, through their cellular magnetic contents ϕ_{cell-beads} at a low target to background cells frequency of 1:1,000. qFCS profiling depended sensitively on the experimental conditions including the starting ferrofluid concentration ϕ_{ferrofluid@#1} and the flow ratio (ferrofluid:buffer). FIG. 5F compares the difference of CD11b and CD3 profiling of PBMC between a starting ferrofluid concentration ϕ_{ferrofluid@#1} 0.3% (v/v) and 0.15% (v/v) presented FIGS. 5D-5E. Shifting the starting ferrofluid concentration in a qFCS device could lead to a shift in ϕ_{ccell-beads} profiles. FIG. 5G shows that decreasing the flow ratio (ferrofluid:buffer) leaded to a slightly larger range of ϕ_{cell-beads} being profiled. Taken together, these data show that the qFCS devices are flexible in profiling ϕ_{cell-beads} with variable combinations of ferrofluid concentrations and flow ratios (ferrofluid:buffer) to suit specific cell types and properties. It is observed that the current qFCS device provides excellent multimodal cell isolation in differentiating cell-beads complexes with subtle cellular magnetic contents ϕ_{cell-beads}. FIG. 5H summarizes the mean cellular magnetic contents ϕ_{cell-beads} in each cell-collection chamber of the device from the five cell experiments described above. Each cell-collection chamber of the qFCS device can profile cells with consistent cellular magnetic contents ϕ_{cell-beads} across different cell types (0.28-0.34 in chamber #1, 0.13-0.15 in chamber #2, 0.09-0.10 in chamber #3, 0.05-0.07 in chamber #4, 0.03-0.05 in chamber #5, 0.02-0.03 in chamber #6, and 0.005-0.01 at the waste outlet). The ranges of cellular magnetic contents ϕ_{cell-beads} in each cell-collection chamber is summarized in Table 1, which shows that the simulation and experimental data obtained from the qFCS calibration in FIG. 4 are consistent with each other.

Next, the qFCS ability in profiling density of antigen binding capacity α_{S} for cells is evaluated and compared it to flow cytometry. It is known that cellular magnetic contents ϕ_{cell-beads} is proportional to α_{S}/D_{cell} from Equation (1.7). As a result, once the cellular magnetic content ϕ_{cell-beads} and cellular diameter D_{cell} are experimentally determined, they can be used to calculate α_{S}. Because k in Equation (1.2) was unknown in this experiment, the cells were profiled based on the density of n_{magnetic-beads} which is proportional to α_{S}. For experiments, a flow cytometry measurement was first conducted for ˜1,000,000 PMBCs that were fluorescently labeled with an antibody targeting anti-CD45. After flow cytometry analyses, fluorescent intensities of ˜10,000 cells from this experiment are summarized and plotted (FIG. 5I, inset). It is noted that the flow cytometry requires a relatively large number of target cells for antigen profiling. In contrast to flow cytometry, the qFCS device provided accurate profiling of antigen binding capacity densities even with only ˜1,000 target cells. These ˜1,000 PMBCs in the qFCS experiment were indirectly labeled with magnetic beads (diameter: 1.05 μm; magnetic content: 11.5% (v/v)) that use the same antibody targeting the same antigen as in the flow cytometry experiments (anti-CD45). Before qFCS processing, these cells were first imaged and analyzed for both cellular magnetic contents ϕ_{cell-beads} and cellular diameters D_{cell} and showed a similar antigen binding capacity density profile to the flow cytometry (FIG. 5I). Labeled cells were spiked into ˜1,000,000 unlabeled PBMCs with a final volume of 200 μL, then processed by a qFCS device. Cells in each cell-collection chamber of the device were analyzed again for their antigen binding capacity densities. FIG. 5J shows that after qFCS processing, qFCS returned a similar profile of overall cellular antigen binding capacity density to the one in FIG. 5I. FIG. 5J also shows that the cells separated into different cell-collection chambers possessed distinct bead densities which are proportional to antigen binding capacity densities, confirming qFCS' ability to profile and separate cells based on antigen binding (FIG. 5K). In summary, through the experimental determination of cellular magnetic content ϕ_{cell-beads} in qFCS, together with the determination of cellular diameter D_{cell} from imaging analysis, cells can be profiled according to their antigen binding capacity in three scenarios (FIG. 5L): (1) cell profiling based on a “cell volumetric antigen binding capacity”

$$α / {D}_{c e l l}^{3} ,$$

(2) cell profiling based on the ratio of antigen binding capacity density to cellular diameter α_{S}/D_{cell}; (3) cell profiling based on antigen binding capacity α alone when cellular diameters are constant.
Cell Isolation by qFCS

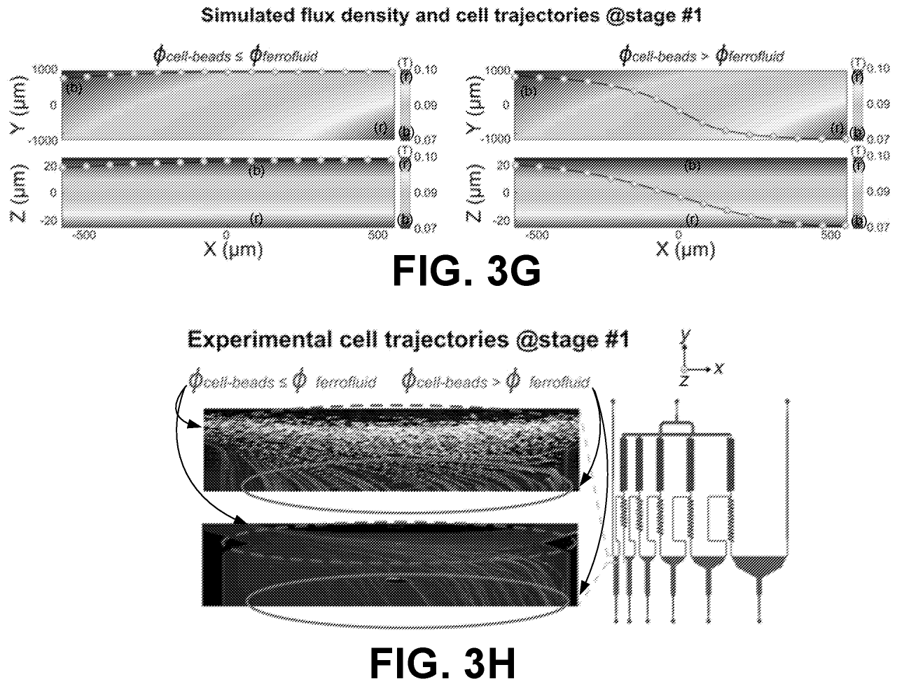

Next, the qFCS device was evaluated in its ability to isolate rare cells based on their antigen bindings among a cell population. The performance of qFCS in the cancer cell and PBMCs isolation was assessed, including the cell recovery rate and purity at extremely low target cell frequencies. For a total of five cell and antigen types, qFCS showed close-to-complete recovery rates across all five experiments (96.96±3.59%, 94.95±4.87%, 99.90±1.01%, 97.45±0.76%, and 93.18±4.63% for MCF7 targeting EpCAM, MDA-MB-231 targeting EpCAM, PBMCs targeting CD45, PBMCs targeting CD3, and PBMCs targeting CD11b, mean±s.d., n=3 for each experiment) (FIG. 6A). Purities of recovered cells are 99.27±0.35%, 98.95±0.24%, 99.03±0.48%, 98.03±1.24%, and 98.31±0.76% for MCF7 targeting EpCAM, MDA-MB-231 targeting EpCAM, PBMCs targeting CD45, PBMCs targeting CD3, and PBMCs targeting CD11b, respectively (all values are mean±s.d., n=3). The mean recovery rate across all experiments is 96.49%, and the mean purity of recovered cells across all experiments is 98.72%. Further the qFCS device was challenged with low-frequency cell spiking to evaluate its ability to recover rare cells, in which a controlled number (20, 100, 500, 1000, and 2000) of PBMCs indirectly labeled with magnetic beads targeting CD3 were spiked into ˜1,000,000 unlabeled PBMCs (lowest target to background cells frequency: 1:50,000) and processed by qFCS devices. Close-to-complete recovery rates of 93.78±4.39%, 97.11±0.68%, 97.92±0.74%, 97.44±0.76%, and 96.98±0.37% were achieved for 20, 100, 500, 1,000, and 2,000 spiked cells, respectively (all values are mean±s.d., n=3). The profiling ability of qFCS was also evaluated at these extremely low target cell frequencies, as shown in FIGS. 6C-6E. Even at the lowest target to background cells frequency of 1:50,000, where ˜20 PBMCs indirectly labeled with magnetic beads targeting CD3 were spiked into ˜1,000,000 unlabeled PBMCs, qFCS still returned accurate cellular magnetic content profiles like the ones in higher target cell frequencies.

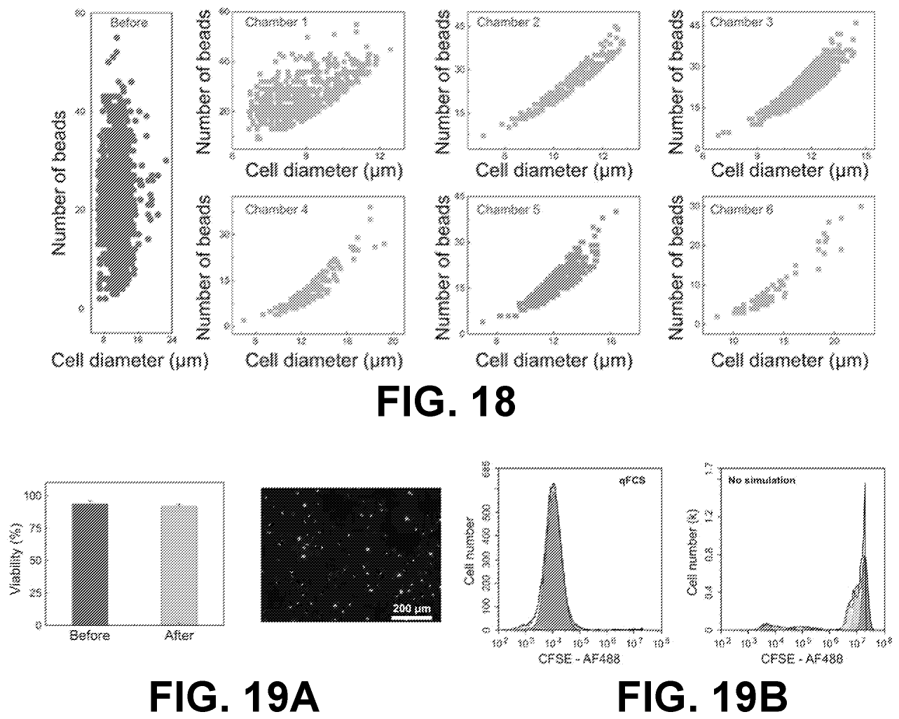

The biocompatibility of the qFCS method was evaluated by first measuring the viabilities of cells expressing CD3 before and after the qFCS processing, whose values were determined to be 93.7±2.2% (mean±s.d., n=3) and 91.8±1.6% (mean±s.d., n=3), respectively (FIG. 19), showing a negligible impact on cell viability from the qFCS processing. The long-term proliferation of isolated cells expressing CD3 from a qFCS device was also measured. After a 30-day expansion, flow cytometry data show that isolated cells have lower carboxyfluorescein succinimidyl ester (CFSE) intensity due to the cell proliferation compared to a control group, confirming that isolated cells retain their proliferation function. Taking together, these experimental data show that the qFCS method can simultaneously profile antigen binding capacities and isolate rare cells based on their antigen binding capacities in a multimodal and biocompatible manner.

### Simultaneous Profiling and Isolating Rare Cells Based on a Low-Expression Antigen

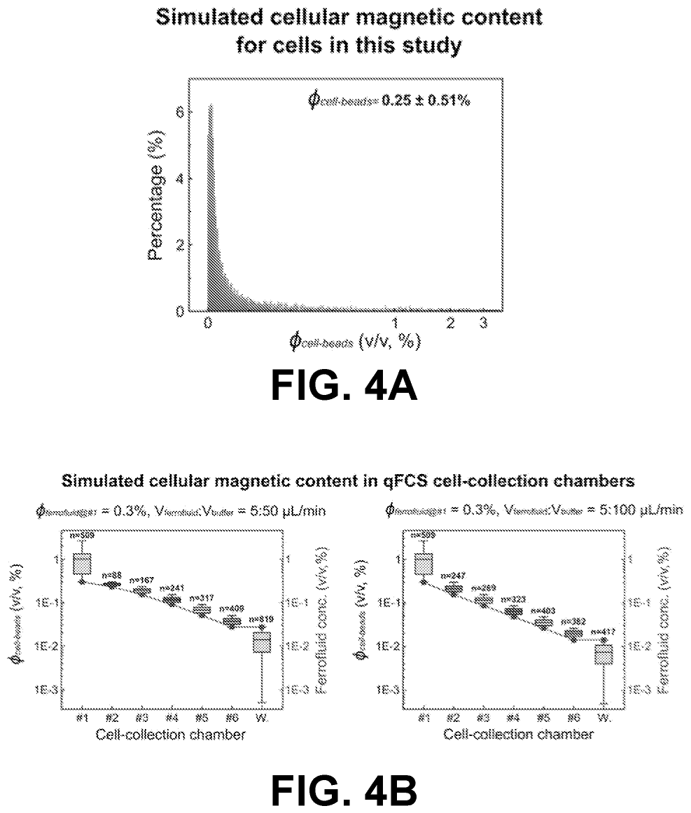

The qFCS device was further evaluated for its ability to simultaneously profile and isolate T lymphocytes based on the binding of a low-expression surface antigen molecule—CD154. CD154, also known as CD40 ligand, is a member of the tumor necrosis factor (TNF) family and a type II transmembrane protein predominantly expressed on activated CD4 T lymphocytes. Because of its potent effects in both humoral and cell-mediated immunity, dysregulation of CD154 expression has been found in autoimmune diseases. Quantification of the CD154 expression and isolation of cells according to their CD154 levels for downstream analyses become important in diagnosing and understanding autoimmune diseases. However, lower surface expression of CD154 is a well-known challenge that makes it difficult to accurately profile CD154 expression and isolate cells that express CD154. The qFCS devices were applied to profile and isolate T lymphocytes that express CD154 among PBMCs at a low target cell frequency. The expression of CD154 on activated T lymphocytes with flow cytometry was first measured. FIG. 7A shows that the majority of ˜10,000 activated T lymphocytes have lower expression levels of CD154. As a result, the qFCS operating parameter was optimized by choosing a low starting ferrofluid concentration of 0.03% (v/v), which allowed T lymphocytes with low-expression CD154 to be profiled and isolated. T lymphocytes used in this experiment were first activated and treated with CD40 antibody with a commercial kit to prevent the loss of transiently upregulated CD154. These activated T lymphocytes were indirectly labeled with biotinylated anti-CD154 magnetic beads (diameter: 1.05 μm; magnetic content: 11.5% (v/v)). ˜1,000 labeled T lymphocytes were spiked into ˜1,000,000 unlabeled PBMCs with a final volume of 200 μL and then processed using a qFCS device. FIG. 7B shows that the qFCS device not only returned a CD154 binding profile at the single-cell resolution that resembled flow cytometry, but also recovered CD154+ T lymphocytes with a recovery rate of 91.84% and a purity of 99.17%. Recovered CD154+ T lymphocytes from the qFCS device were confirmed for their identity via immunofluorescence (CD3+/CD154+/DAPI+) in FIG. 7B. Also studied was the impact on the T lymphocytes from the qFCS processing through a cytokine secretion assay that was performed entirely within the qFCS device (FIG. 7C). In this assay, isolated CD154+ cells within the cell-collection chambers of the qFCS device were relocated and held by the permanent magnet to allow for their on-device cytokine secretion assay. FIG. 7D shows that the isolated CD154+ cells have increased secretion of IL-2 compared to the nonactivated cells, confirming that qFCS can isolate T lymphocytes with a low-expression CD154 on their surface while maintaining their important cellular functions.

### Discussion

Multimodal sorting of rare cells based on the levels of a specific surface antigen while at the same time quantifying the binding capacity of that antigen is essential in understanding and treating diseases. Unfortunately, conventional methods, including FACS and MACS, did not meet this need as they either need a large number of target cells or their output is bimodal. Recognizing the need, A new microfluidic method was developed, termed the quantitative ferrohydrodynamic cell separation (qFCS), that achieved multimodal rare cell sorting and simultaneous antigen profiling via cellular magnetic content of magnetically labeled cells, which correlates to the cell's antigen-binding capacity. This correlation was exploited in a prototype qFCS device that offers characterization and isolation of magnetically labeled rare cells with single-cell resolution according to their antigen-binding capacity.

Even though magnetism-based cell separation methods have been demonstrated in the past, none of them used a combination of both cellular “diamagnetophoresis” and “magnetophoresis” in biocompatible ferrofluids for cell applications. The integration of these two magnetic manipulation mechanisms in one qFCS device enabled us to simultaneously measure single cell's intrinsic antigen binding capacity through magnetic labeling and manipulate the labeled cell into one of the cell-collection chambers according to its antigen binding capacity for further analysis. To understand the benefit of qFCS over other existing methods, a total 11 magnetism-based cell profiling and/or separation methods and compared their performance to the qFCS were surveyed. The qFCS method and its device include the following advantages over existing methods, including recently published magnetic ratcheting, magnetic ranking cytometry, cell tracking velocimetry, and magnetophoretic cytometer. Firstly, qFCS not only profiles cells' antigen-binding capacities but also sorts and recovers cells in a biocompatible manner for both on-device and downstream analyses, while other methods including magnetic ranking cytometry, cell tracking velocimetry, and magnetophoretic cytometry only provide antigen profiling capabilities. Secondly, qFCS offers better overall performance in the multimodal separation of cells with a mean 96.49% recovery of rare cells and a 98.72% purity of recovered cells compared to existing methods. Thirdly, qFCS has a high level of sensitivity and is able to profile and isolate rare cells accurately when they are present at down to 1:50,000 target to background cells frequency, while only one of the existing methods—magnetic ranking cytometry can offer competing level of sensitivity. Lastly, qFCS is versatile in that it can profile and isolate cells even when the antigen expressions are extremely low. qFCS allows users to adjust the starting ferrofluid concentration and the flow ratio so that the range of the antigen binding capacity profiling can be varied to suite specific cell types and properties.

Current qFCS device has its own limitations that need to be addressed in future development. Firstly, current qFCS device has a limited number of stages and cell-collection chambers, which makes its cell profiling coarse when compared to conventional methods such as FACS. Increasing the number of stages and cell-collection chambers for qFCS is not trivial as it involves a delicate balance of sample flow and device complexity. Secondly, current qFCS device is suitable for processing a limited number of cells due to its relatively slow flow rate. Increasing its flow rate and cell-processing throughput would require a re-design of the overall device architecture. Thirdly, when used for cell profiling, qFCS relies on information including both cellular magnetic contents and cellular diameters in order to quantify cells' antigen binding capacity. This requires additional imaging and analysis of cells after qFCS processing. Future generation of qFCS should consider developing on-device cell diameter measurement to automate the quantification of antigen binding capacity.

### Detailed Description of the Figures

Shown in FIGS. 2A-2F is an overview of the quantitative ferrohydrodynamic cell separation (qFCS) method and its prototype device. In FIG. 2A, an example schematic of indirect magnetic labeling in which a primary antibody binds against a specific cell surface antigen, a secondary antibody conjugated to a magnetic bead then binds to the primary antibody through secondary binding sites is shown. In this process, the cellular magnetic content of the cell-beads complex becomes proportional to the cell's antigen-binding capacity (the number of primary antibodies bound to the cell surface) under specific conditions.

In FIG. 2B, an example schematic of a cell-beads complex experiencing competing “magnetophoresis” and “diamagnetophoresis” in ferrofluids, which is a colloidal suspension of magnetic nanoparticles is shown. Magnetophoretic force on the cell-beads complex results from the conjugated magnetic beads and directs the cell-beads complex towards the maximum of a non-uniform magnetic field (black arrows). Diamagnetophoretic force on the cell-beads complex results from magnetic nanoparticle-induced pressure imbalance on the cell-beads complex's surface and directs it towards the minima of the magnetic field (central arrow extending from cell). These two magnetic forces are in opposite directions. Color bar indicates the gradient of the magnetic field.

In FIG. 2C, an example schematic of the qFCS device design is shown. Cell-beads complexes continuously flow through six stages of the ferrofluids in the qFCS. When the condition ϕ_{cell-beads}≤ϕ_{ferrofluid} is met, diamagnetophoretic force on the cell-bead complex equals or overcomes the magnetophoretic force and drives it to the next stage. When the condition ϕ_{cell-beads}>ϕ_{ferrofluid} is met, the magnetophoretic force outweighs the diamagnetophoretic force and traps the cell-beads complex in the current stage. Each stage of the qFCS with a ferrofluid concentration ϕ_{ferrofluid@#n} (n is n^{th} stage) can trap cell-beads complexes with their cellular magnetic contents falling in the range of ϕ_{ferrofluid@#n-1}≥ϕ_{cell-beads}>ϕ_{ferrofluid@#n}, which is proportional to the cell's surface antigen-binding capacity «, resulting in cell isolation based on the levels of antigen-binding capacity. At the same time, distributions of a specific antigen-binding capacity among the cell population can be profiled in qFCS by counting the cell-beads complexes in each stage. Blue arrows indicate the gradient of the magnetic field. Green coloring in the device indicates the gradient of the ferrofluid concentration.

FIG. 2D shows a photo of the microfluidic channels in an example qFCS device. In FIG. 2E, a top view of the qFCS microchannels is shown. Cells suspended in the ferrofluid are injected into inlet A, and PBS buffer from inlet B is applied to mix with the ferrofluid for dilution and generate spatially stable and variable concentrations in qFCS stages and cell-collection chambers #1-6.

As illustrated in FIG. 2F (Top panel), ferrofluid concentration decreases continuously from stages and cell-collection chambers #1-6 in the qFCS device. FIG. 2F (Bottom panel) shows experimental images of qFCS device in the isolation of white blood cells (WBCs) labeled with CD45 modified magnetic beads. As the ferrofluid concentration decreases from stage #1 to #6, the number of microbeads on WBCs and the corresponding cellular magnetic contents also decrease.

Shown in FIGS. 3A-3H is an example design of the quantitative ferrohydrodynamic cell separation (qFCS) method for cell isolation. In FIG. 3A, a schematic of the qFCS device shows the location of the permanent magnet and the microfluidic channels is shown. This configuration leads to a magnetic flux density and gradient sufficient for cell isolation. The permanent magnet (50.8 mm×6.35 mm×6.35 mm, L×W×H, N52 neodymium magnet) is placed relative to the microfluidic device, as shown here. Under such configuration, a magnetic flux density of up to 0.36 T in the x-y plane (z=0, top panel), and up to 0.28 T in the x-z plane (y=0, bottom panel) is generated (FIG. 13).

FIG. 3B illustrates an example simulation showing simulated ferrofluid concentrations (ϕ_{ferrofluid}) in the six cell-collection chambers at different time points. In this simulation, a 0.3% (v/v) ferrofluid is injected into inlet A at a flow rate of 5 μL min⁻¹, and a PBS buffer solution is injected into inlet B at a flow rate of 50 μL min⁻¹. ϕ_{ferrofluid} in each cell-collection chamber (#1-6, red dashed rectangles) are shown at 0.1 min, 0.3 min, 0.6 min, 1 min, 2 min, 5 min, and 10 min. Spatially stable ferrofluid concentration can be established in the effective cell flow region of cell-collection chambers in 1 min. Color bar shows the magnitude of the ferrofluid concentrations.

FIG. 3C illustrates an example simulation showing spatially stable and monotonically decreasing ϕ_{ferrofluid} profile can be established in the qFCS device after 1 min. Concentration is calculated by averaging the effective flow region in each chamber.

FIG. 3D shows example experimental results, where bright-field images of the ferrofluid in the cell-collection chambers of the qFCS device at variable concentrations from 0.03% to 0.3% are used to determine a linear relationship between the light absorbance of ferrofluids and ϕ_{ferrofluid}. The theory of this linear relationship is discussed in the Example 2. The light absorbance of the ferrofluid is calculated by log₁₀(i₀/i_{ferrofluid}), where iₒ is the mean of grayscale value of a bright-field image without ferrofluids, and i_{ferrofluid} is the mean of grayscale value of a bright-field image with ferrofluids. The bright-field images are taken near the ferrofluid inlet (inlet A) of the qFCS device.

FIG. 3E shows example experimental results, where the linear relationship between the experimentally measured magnetization of the ferrofluid and ϕ_{ferrofluid}. Linear fitting of the relationship (R²=0.9997, n=3) shows that ferrofluid magnetization is proportional to ϕ_{ferrofluid} as expected.

FIG. 3F illustrates example simulation (left panel) and experimental (right panel) results of ϕ_{ferrofluid} in the cell-collection chamber at variable flow ratios (ferrofluid:buffer). The ferrofluid flow rate (Inlet A, 0.3%, v/v ferrofluid) is 5 μL min⁻¹, while the buffer flow rate (inlet B, PBS buffer) is 40-100 μL min⁻¹.

Shown in FIG. 3G, an example simulation shows simulated cell trajectories in stage #1 of the qFCS device. As shown in FIG. 3G (left panel), in the case of ϕ_{cell-beads}≤ϕ_{ferrofluid}, in which the cellular magnetic content ϕ_{cell-beads} of a cell-beads complex (10 μm diameter, labeled with five magnetic beads (magnetic beads: 1.05 μm diameter, 11.5% (v/v) magnetic content)) is less than or equal to the ferrofluid concentration ϕ_{ferrofluid} in that stage (stage #1), the cell-beads complex is driven to the next stage of the device. As shown in FIG. 3G (right panel). in the case of ϕ_{cell-beads}>ϕ_{ferrofluid}, in which the cellular magnetic content ϕ_{cell-beads} of a cell-beads complex (10 μm diameter, labeled with 30 magnetic beads (magnetic beads: 1.05 μm diameter, 11.5% (v/v) magnetic content)) is larger than the ferrofluid concentration ϕ_{ferrofluid} in that stage (stage #1), the cell-beads complex is trapped at stage #1. A ferrofluid (0.3% v/v) flow rate of 5 μL min⁻¹ and buffer flow rate is 50 μL min⁻¹ in the simulation. Color bar shows the magnitude of the magnetic flux density ranging from about 0.07 (blue—b) to about 0.10 (red—r).

FIG. 3H shows experimental results, where Phase contrast (top) and Fluorescent (bottom) images of cell trajectories of human white blood cells (WBCs) labeled with magnetic beads targeting CD45 in the qFCS device (stage #1). Ferrofluid concentration is 0.3% (v/v), ferrofluid flow rate is 5 μL min⁻¹, and buffer flow rate is 50 μL min⁻¹. The dashed ellipse shows the cell-beads complexes with ϕ_{cell-beads}≤ϕ_{ferrofluid}; while the solid ellipse shows the cell-beads complexes with ϕ_{cell-beads}>ϕ_{ferrofluid}. Green box on the device schematic shows the location of the observation window (stage #1).

FIGS. 4A-4F illustrate an example calibration of the quantitative ferrohydrodynamic cell separation (qFCS) method for cell isolation. As shown in FIG. 3A as an example simulation, estimated distribution of cellular magnetic contents (ϕ_{cell-beads}) for the cells used in this study. ϕ_{cell-beads} is 0.25±0.51% (v/v, mean±s.d., n=2,550), for the cellular diameter and magnetic beads used in this study (cell diameter: 5-30 μm, number of magnetic beads per cell: 1-50, each magnetic bead has a diameter of 1.05 μm and a magnetic content of 11.5% (v/v)).

In FIG. 4B, shown are simulation results of the distribution of cellular magnetic contents. In FIG. 4B (Left panel), shown are an example distribution of ϕ_{cell-beads} in the six cell-collection chambers of the qFCS device under the condition: a ferrofluid flow rate of 5 μL min⁻¹ and a buffer flow rate of 50 μL min⁻¹. ϕ_{cell-beads} (%, v/v, mean±s.d.) are 1.01±0.74 (chamber #1, n=509), 0.26±0.02 (chamber #2, n=88), 0.19±0.02 (chamber #3, n=167), 0.12±0.02 (chamber #4, n=241), 0.07±0.01 (chamber #5, n=317), 0.04±0.01 (chamber #6, n=409), and 0.01±0.01 (waste outlet, labeled as “W”, n=819). In FIG. 4B (Right panel), shown are an example distribution of ϕ_{cell-beads} in the six cell-collection chambers of the qFCS device under the condition: a ferrofluid flow rate of 5 μL min⁻¹ and a buffer flow rate of 100 μL min⁻¹. ϕ_{cell-beads} (%, v/v, mean±s.d.) are 1.01±0.74 (chamber #1, n=509), 0.22±0.04 (chamber #2, n=247), 0.12±0.02 (chamber #3, n=269), 0.06±0.01 (chamber #4, n=323), 0.03±0.01 (chamber #5, n=403), 0.02±0.004 (chamber #6, n=382), and 0.01±0.004 (waste outlet, labeled as “W”, n=417). The starting ferrofluid concentration (ϕ_{ferrofluid@#1}) is 0.3% (v/v) in both simulations.

FIG. 4C shows example experimental results, where bright field images of anti-CD45 modified magnetic beads labeled white blood cells (WBCs) isolated in the cell-collection chambers of the qFCS device. Isolated WBCs in each cell-collection chamber are imaged to extract cell diameters and count the number of magnetic beads per cell to calculate ϕ_{cell-beads}.

FIG. 4D shows example experimental results of a distribution of cell diameters and ϕ_{cell-beads} in each cell-collection chamber. The number of magnetic beads on each cell is shown. FIG. 4E shows example experimental results of a distribution of ϕ_{cell-beads} cell-beads complexes in each cell-collection chamber of the qFCS device are summarized for WBCs isolation based on their CD45 binding capacity. In FIG. 4E (left panel), ϕ_{cell-beads} (%, v/v, mean±s.d.) of WBCs are measured to be 0.51±0.18 (chamber #1, n=1,481), 0.26±0.02 (chamber #2, n=706), 0.19±0.02 (chamber #3, n=1,171), 0.12±0.02 (chamber #4, n=1,064), 0.07±0.01 (chamber #5, n=458), 0.04±0.01 (chamber #6, n=174), and 0.02±0.00 (waste outlet, labeled as “W”, n=49). In FIG. 4E (right panel), the percentages of cells in each cell-collection chamber in the qFCS device after cell isolation. This experiment is conducted with a starting ˜5,000 WBCs at a concentration of 25,000 cells/mL that are indirectly labeled with anti-CD45 magnetic beads (magnetic beads: 1.05 μm diameter, 11.5% (v/v) magnetic volume fraction) and processed in the qFCS device with the following conditions: starting ferrofluid concentration ϕ_{ferrofluid@#1} 0.3% (v/v), ferrofluid flow rate 5 μL min⁻¹, buffer flow rate 50 μL min⁻¹.

FIG. 4F shows example experimental results of a similar study of WBCs isolation based on their CD45 binding capacity in the qFCS device as in FIG. 4D, except that the buffer flow rate is 100 μL min⁻¹. (Left panel) ϕ_{cell-beads} (%, v/v, mean±s.d.) are 0.52±0.15 (chamber #1, n=1,341), 0.22±0.04 (chamber #2, n=1,906), 0.12±0.02 (chamber #3, n=1,094), 0.07±0.01 (chamber #4, n=422), 0.04±0.01 (chamber #5, n=158), 0.02±0.00 (chamber #6, n=45), and 0.01±0.00 (waste outlet, labeled as “W”, n=4). (Right panel) The percentages of cells in each cell-collection chamber in the qFCS device after cell isolation.

FIGS. 5A-5L illustrates example experimental validation of the qFCS device for its capabilities of quantifying antigen-binding capacity. In FIGS. 5A-5E, the qFCS quantifies “volumetric antigen-binding capacity” in cultured cancer cells and peripheral blood mononuclear cells (PBMCs) through cellular magnetic contents ϕ_{cell-beads} are shown. Five separate experiments were conducted using qFCS. Each qFCS experiment started with ˜1,000 cells (MCF7 breast cancer, or MDA-MB-231 breast cancer, or PMBCs), which were labeled with magnetic beads (diameter: 1.05 μm; magnetic content: 11.5% (v/v)) through indirect labeling of respective antibodies (anti-EpCAM for MCF7 breast cancer cells or MDA-MB-231 breast cancer cells, anti-CD45, anti-CD3, and anti-CD11b for PMBCs). These labeled ˜1,000 cells were spiked into ˜1,000,000 unlabeled PBMCs with a final volume of 200 μL and then processed by the qFCS devices. qFCS device processing parameters included: a starting ferrofluid concentration ferrofluid of 0.15% (v/v), a ferrofluid flow rate of 5 μL min⁻¹, and a buffer flow rate of 50 μL min⁻¹. Isolated cells in the chambers of the qFCS device were counted and calculated for their cellular magnetic contents ϕ_{cell-beads}. In FIGS. 5A-5E, the numbers in the qFCS plots are the number of cell-collection chambers. FIG. 5A shows cellular magnetic content ϕ_{cell-beads} targeting EpCAM for MCF7 breast cancer cells. FIG. 5B shows ϕ_{cell-beads} targeting EpCAM for MDA-MB-231 breast cancer cells. FIG. 5C shows ϕ_{cell-beads} targeting CD45 for PMBCs. FIG. 5D shows ϕ_{cell-beads} targeting CD11b for PMBCs. FIG. 5E shows ϕ_{cell-beads} targeting CD3 for PMBCs.

FIG. 5F shows ϕ_{cell-beads} targeting CD11b and CD3 for PMBCs with a 0.3% (v/v) starting ferrofluid concentration. FIG. 5G shows Comparison of ϕ_{cell-beads} targeting CD45 for PMBCs with different flow ratios. FIG. 5H shows means of ϕ_{cell-beads} in each cell-collection chamber of the qFCS device. The means are calculated using experimental data from FIGS. 5A-5E. ϕ_{cell-beads} (%, v/v) are 0.28-0.34 (chamber #1), 0.13-0.15 (chamber #2), 0.09-0.10 (chamber #3), 0.05-0.07 (chamber #4), 0.03-0.05 (chamber #5), 0.02-0.03 (chamber #6), and 0.005-0.01 (waste outlet). FIG. 5A shows a comparison between flow cytometry and qFCS in profiling CD45 density in PBMCs. qFCS used magnetic beads density which was proportional to antigen binding capacity density. FIG. 5J shows qFCS profiled and isolated cells based on CD45 density into its six cell-collection chambers. FIG. 5K shows the mean magnetic bead densities in each cell-collection chambers. FIG. 5L shows three modes of antigen binding capacity based operation of qFCS, depending on cellular diameters.

In FIGS. 6A-6E, experimental validation of the qFCS device for its capabilities of isolating rare cells is shown. FIG. 6A illustrates recovery rates and purities of spiked cells. Recovery rate of 96.96±3.59%, 94.95±4.87%, 99.90±1.01%, 97.45±0.76%, and 93.18±4.63% were achieved for MCF7 targeting EpCAM, MDA-MB-231 targeting EpCAM, PBMCs targeting CD45, PBMCs targeting CD3, and PBMCs targeting CD11b, respectively (all values are mean±s.d., n=3). Purities of 99.27±0.35%, 98.95±0.24%, 99.03±0.48%, 98.03±1.24%, and 98.31±0.76% were achieved for MCF7 targeting EpCAM, MDA-MB-231 targeting EpCAM, PBMCs targeting CD45, PBMCs targeting CD3, and PBMCs targeting CD11b, respectively (all values are mean±s.d., n=3).

FIG. 6B illustrates the relationship between the cell recovery rate and the number of spiked cells. A series of cell spike-in experiments were conducted to quantity the recovery rate of the qFCS device in recovering low concentration cells. A certain number (20, 100, 500, 1000, and 2000) of PBMCs indirectly labeled with magnetic beads targeting CD3 were spiked into ˜1,000,000 unlabeled PBMCs and processed by qFCS devices. Recovery rates of 93.78±4.39%, 97.11±0.68%, 97.92±0.74%, 97.44±0.76%, and 96.98±0.37% were achieved for 20, 100, 500, 1,000, and 2,000 spiked cells, respectively (all values are mean±s.d., n=3).

FIGS. 6C-6E shows examples of quantifying antigen binding of CD3 among PBMCs with the qFCS devices at extremely low target cell frequencies: ˜20 human white blood cells (WBCs) labeled with CD3 modified magnetic beads (FIG. 1C), 100 human WBCs labeled with CD3 modified magnetic beads (FIG. 1D), and 500 human WBCs labeled with CD3 modified magnetic beads (FIG. 1E). These labeled cells were spiked into ˜1,000,000 unlabeled PBMCs with a final volume of 200 UL and then processed by the qFCS devices. qFCS device processing parameters included: a starting ferrofluid concentration ϕ_{ferrofluid} of 0.15% (v/v), a ferrofluid flow rate of 5 μL min⁻¹, and a buffer flow rate of 50 μL min⁻¹. Isolated cells in the chambers of the qFCS device were counted and calculated for their cellular magnetic contents ϕ_{cell-beads}.

Shown in FIGS. 7A-7D are examples of quantifying and isolating T lymphocytes based on the antigen binding of a low-expression CD154. In FIG. 7A, quantification of CD154 antigen expressions of nonactivated (left panel) and activated (right panel) ˜10,000 T lymphocytes using flow cytometry are shown. In FIG. 7B (left panel), quantification of CD154 expressions of activated ˜1,000 T lymphocytes in a qFCS device. ˜1,000 cells labeled with CD154 modified magnetic beads were spiked into ˜1,000,000 of PBMCs and suspended in a 200 μL ferrofluid. qFCS processing conditions included: a starting ferrofluid concentration ϕ_{ferrofluid} of 0.03% (v/v), a ferrofluid flow rate of 5 μL min⁻¹, and a buffer flow rate of 50 μL min⁻¹ is shown. In FIG. 7B (right panel), fluorescent image of an activated T lymphocyte. After qFCS processing, isolated T lymphocytes were immunofluorescently stained with anti-CD3 (AF647), anti-CD154 (AF488), and nucleic marker (DAPI) is shown.

FIG. 7C illustrates an example procedure of T lymphocytes cytokine secretion assay. After qFCS processing, isolated cells were relocated towards the collection outlet by moving the permanent magnet. Reagents were then loaded into the collection outlet while the cells were trapped by the magnet. Cells were incubated on the device and imaged.

In FIG. 7D, fluorescence images of nonactivated (top panel) and activated (bottom panel) T lymphocytes are shown. T lymphocytes were incubated with reagents designed to capture their secreted cytokine (IL2). Activated T lymphocytes were collected from the cell-collection chamber #3 of the qFCS device. Fluorescence intensities of T lymphocytes labeled with IL-2 capture reagent. The mean cell fluorescence intensities were 1,502±1,934 (mean±s.d., n=201) for the nonactivated cells and 7,623±6,722 (mean±s.d., n=390) for the activated cells.

### Materials and Methods

### Modeling and Simulation

Flow profiles and ferrofluid concentrations in the qFCS device were simulated and optimized using COMSOL Multiphysics Version 5.5 (COMSOL Inc., Stockholm, Sweden). Creeping flow and transport of diluted species modules were used in the COMSOL studies to simulate flow profile and distribution of ferrofluid concentration in the qFCS device. Ferrofluid properties, including the density of ferrofluid of 1,03-1,060 kg/cm³, the viscosity of ferrofluid of 0.99-1.68 mPa·s, and mean diameter of maghemite nanoparticle of 11.2 nm were used in these studies. Flow rates of the ferrofluid and the PBS buffer were 1-10 μL/min and 10-100 μL/min, respectively. Initial concentration of ferrofluid was 0.03-0.3% (v/v).

Magnetic fields, cell trajectories, and cell isolation process in the qFCS device were simulated in MATLAB (MathWorks, Natick, MA) using a previously published physical model. Briefly, this three-dimensional model simulates the transport of magnetizable cells in a ferrofluid inside a microfluidic channel coupled with permanent magnets. This model uses the combination of an analytical solution of magnetic field distribution and experimentally verified ferrofluid magnetization together to calculate magnetic forces on cells. The balance of magnetic force and hydrodynamic drag force on cells in low-Reynolds number flow condition are then used to simulate the cell trajectories. Parametric studies of device geometries/dimensions, magnetic field distributions, operating parameters including ferrofluid concentration and flow rates can be conducted in MATLAB using this model. Ferrofluid concentration values can be obtained from previous COMSOL simulations.

### Microfluidic Device Fabrication

The mold of the qFCS device was fabricated using SU-8 2025 photoresist (Kayaku Advance Materials, Westborough, MA) with a height of ˜50 μm. Microfluidic devices were fabricated using polydimethylsiloxane (PDMS) following standard soft lithography procedures. The fabricated microfluidic device was placed on a 3D-printed manifold to be integrated with one NdFeB permanent magnet (N52, K&J Magnetics, Pipersville, PA). The permanent magnet had a geometry of 50.8 mm×6.35 mm×6.35 mm (L×W×H) and a measured remnant magnetization of 1.48 T.

### Ferrofluids Synthesis and Characterization

The water-based biocompatible ferrofluid was synthesized by a chemical co-precipitation method following a developed protocol. Size and morphologies of the maghemite nanoparticles in the ferrofluid were characterized using a transmission electron microscope (TEM; FEI, Eindhoven, the Netherlands). The diameter of magnetic nanoparticles was measured to be 10.91±4.86 nm. Magnetic properties, including saturation magnetization (1,107 A m⁻¹) and volume fraction of magnetic contents (0.298%, v/v) of the as-synthesized ferrofluid, were obtained through fitting to the Langevin function with data measured using a vibrating sample magnetometer (VSM, MicroSense, Lowell, MA). The viscosity of the as-synthesized ferrofluid was measured to be 1.7 mPa·s using a compact rheometer (Anton Paar, Ashland, VA).

### Cell Culture

Cancer cell lines: human breast cancer cell lines, MCF-7 and MDA-MB-231 (ATCC, Manassas, VA) were cultured in the DMEM medium (Thermo Fisher Scientific, Waltham, MA) supplemented with 10% (v/v) fetal bovine serum (Thermo Fisher Scientific, Waltham, MA), 0.1 mM non-essential amino acids solution (NEAA, Thermo Fisher Scientific, Waltham, MA), and 1% (v/v) penicillin/streptomycin solution (Thermo Fisher Scientific, Waltham, MA). Cultured cells were harvested through incubation with 0.05% trypsin-EDTA (Thermo Fisher Scientific, Waltham, MA) at 37° C. for 3 to 5 minutes. The concentration of cells was measured with an automated cell counter (Countess™, Thermo Fisher Scientific, Waltham, MA).

Peripheral blood mononuclear cells (PBMCs): Human buffy coat blood was purchased from a commercial vendor (Zen-Bio, Research Triangle, NC) and diluted with an equal volume of non-complemented DMEM medium. To obtain PBMCs from the blood sample, 20 mL Ficoll-Paque™ PLUS (Cytiva, Marlborough, MA) was added to the bottom of a 50 ml conical tube, then 30 mL diluted blood was loaded into the tube. The tube was centrifuged at room temperature at 760 g for 20 minutes with the brakes off. PBMCs were harvested between the Ficoll and plasma layer and washed three times with PBS by centrifugation at 350 g for 8 minutes. The concentration of PBMCs was measured by the automated cell counter and adjusted to be 1×10⁶ cells mL⁻¹. PBMCs were cultured in 24-well plates (37° C., 5% CO₂) at a density of (1-10)×10⁶ cells mL⁻¹, using RPMI-1640 medium (Thermo Fisher Scientific, Waltham, MA) supplemented with 10% (v/v) fetal bovine serum, 0.1 mM non-essential amino acids solution and 1% (v/v) penicillin/streptomycin solution.

### Cell Labeling

Magnetic beads preparation: Streptavidin-coated magnetic beads (Dynabeads, Thermo Fisher Scientific, Waltham, MA) used in this study have a physical diameter of 1.05 μm. The volume fraction of magnetic material in the beads was determined to be 11.5%.31 The magnetic beads were first washed with 0.01% Tween 20 solution (Alfa Aesar, Haverhill, MA), followed by blocking with 0.1% bovine serum albumin (BSA, Thermo Fisher Scientific, Waltham, MA) in PBS solution. Biotinylated primary antibodies, including anti-EpCAM (Miltenyi Biotec, Bergisch Gladbach, Germany), anti-CD3 (Miltenyi Biotec, Bergisch Gladbach, Germany), anti-CD45 (eBioscience, San Diego, CA), anti-CD11b (eBioscience, San Diego, CA), and anti-CD154 (Biolegend, San Diego, CA) were first diluted to a concentration of 0.1 mg mL⁻¹. The beads were then pre-coated with the biotinylated primary antibodies at room temperature for 30 minutes and then washed twice with PBS before use.

Cell preparation: Harvested cells were mixed with biotinylated primary antibody-coated magnetic beads for 30 minutes at room temperature. The labeled cells with ≥1 beads were captured using a magnet system (DynaMag, Thermo Fisher Scientific, Waltham, MA) and washed with PBS. The number of labeled cells was confirmed with a Nageotte counting chamber (Hausser Scientific, Horsham, PA). In cell tracking experiments, labeled cells were stained with CellTracker Green (Thermo Fisher Scientific, Waltham, MA), and background cells (unlabeled PBMCs) were stained with CellTracker Orange (Thermo Fisher Scientific, Waltham, MA) to track their trajectories. Cells were mixed with the ferrofluid before use.

qFCS Experiment Procedure

The qFCS devices were first treated with air plasma for 3 minutes, followed by 70% (v/v) ethanol flushing for 10 minutes to render the channel surface hydrophilic. The microchannel of the qFCS devices was then primed to reduce non-specific binding using PBS supplemented with 0.5% (w/v) BSA and 2 mM EDTA (Thermo Fisher Scientific, Waltham, MA). The microchannel was flushed with PBS for 10 minutes to remove debris before sample loading. Cell-collect outlets of the qFCS devices were blocked with 3D printed pillars during isolation experiments. Sample fluids (ferrofluid and cells) and buffer fluids (PBS) were individually controlled with a syringe pump (Chemyx, Stafford, TX) at variable flow rates during the experiments. After qFCS processing, images of cells in the qFCS device cell-collection chambers were obtained using an inverted microscope equipped with a CCD camera (Carl Zeiss, Germany). Images of cells were analyzed by the ImageJ software to extract the cell's diameter. The effective diameter of the cells was calculated using their surface areas with the assumption that cells were spherical. The number of magnetic beads on each cell was counted and used to calculate cellular magnetic contents for individual cells.

### Cell Recovery Rate and Purity Calculations

Cells were counted from both the cell-collection chambers and the waste outlet after a qFCS cell isolation experiment. Cells with CellTracker green fluorescent signal were identified as the target cells, while cells with CellTracker fluorescent orange signal were identified as the background cells. The recovery rate of target cells in a qFCS experiment was calculated by n_{target-cell-chambers}/(_{n-target-cell-chambers}+n_{target-cell-waste}), where n_{target-cell-chambers} is the number of target cells in all six cell-collection chambers and n_{target-cell-waste} is the target cells in the waste outlet after a qFCS experiment. The purity of target cells in a qFCS experiment was calculated n_{target-cell-chambers}/(n_{target-cell-chambers}+n_{background-cell-chambers}), where n_{background-cell-chambers} is the number of background cells in all six cell-collection chambers.

### Flow Cytometry

The expression levels of antigens were profiled using a flow cytometer (Agilent Quanteon, Agilent, Santa Clara, CA). In a typical flow cytometry experiment, cells were first blocked with UltraCruz Blocking Reagent (Santa Cruz Biotechnology, Dallas, TX) at 4° C. for 20 minutes. Cells were then suspended in PBS solution supplemented with 2% BSA, 2 mM EDTA, and 2 mM NaN₃ (Sigma-Aldrich, St. Louis, MO). Antibodies with fluorophore were spiked into PBS solution with a volume ratio of 1:50 and incubated with the cells on ice for 30 minutes, then washed twice and resuspended in cold PBS prior to the flow cytometry. A control group with unlabeled cells was used to set the gate.

### T Lymphocytes Activation Assay

PBMCs were cultured in a 24-well plate at a density of 1×10⁷ cells mL⁻¹. To activate the T lymphocytes, 20 μL CytoStim reagent (Miltenyi Biotec, Bergisch Gladbach, Germany) and 10 μL CD40 (1 μg mL⁻¹, Miltenyi Biotec, Bergisch Gladbach, Germany) were added, mixed and incubated with 10⁷ PBMCs at 37° C. for 4 hours. Cells were mixed with cold isolation buffer (AutoMACS rinsing solution, Miltenyi Biotec, Bergisch Gladbach, Germany) supplemented with 5% BSA, centrifuged at 300 g for 10 minutes to remove the supernatant, and resuspended with 100 μL cold isolation buffer. Biotinylated anti-human CD154 (Miltenyi Biotec, Bergisch Gladbach, Germany) were conjugated with magnetic beads, and the biotinylated anti-CD154 coated magnetic beads were added into the cell suspension with a volume ratio of 1:30 and incubated for 30 minutes at room temperature. Labeled cells were harvested using the DynaMag and resuspended with an isolation buffer. The exact cell number was determined using a Nageotte counting chamber.

### On-Device Cytokine Secretion Assay

After processing with qFCS, anti-CD154 labeled cells were directed into the incubation chamber by moving the permanent magnet toward the cell-collection outlets and flushed with warm FBS-free cell culture medium. The device was placed in a cell incubator (37° C., 5% CO₂) for 20 minutes. IL-2 secretion assay was performed using a cell enrichment and detection kit (Miltenyi Biotec, Bergisch Gladbach, Germany). Briefly, the IL-2 catch reagent was infused into the device and incubated for 50 minutes to allow IL-2 secretion and capture. Cells were then washed with cold buffer (PBS supplemented with 0.5% BSA and 2 mM EDTA) to remove extra reagent. IL-2 detection antibody was infused into the cell-collection chamber and incubated with the cells for 10 minutes on ice. The chambers were washed with cold buffer and imaged. A control group was prepared with nonactivated cells.

### On-Device Immunofluorescence Staining

After processing with qFCS, the medium in the cell-collection chambers was replaced with PBS. The isolated cells were fixed with 4% (w/v) paraformaldehyde solution (PFA, Santa Cruz Biotechnology, Dallas, TX) for 10 minutes and subsequently permeabilized with 0.1% (v/v) Triton X-100 (Alfa Aesar, Haverhill, MA) for 10 minutes. UltraCruz blocking reagent was applied to the cells for 30 minutes at room temperature to reduce non-specific bindings. After blocking, cells were immunostained with primary antibodies, including anti-CD154-Alexa Fluor 488 (eBioscience, San Diego, CA) and anti-CD3-Alexa Fluor 647 (Santa Cruz Biotechnology, Dallas, TX). After overnight immunofluorescence staining, cells were washed and stained with DAPI (Electron Microscopy Sciences, Hatfield, PA) for imaging.

### Cell Viability and Proliferation Assay

Live/dead assay. Isolated cells in the cell-collection chambers were washed with Dulbecco's phosphate-buffered saline (D-PBS, Thermo Fisher Scientific, Waltham, MA) to remove the ferrofluid. Cells were then incubated in the chambers with D-PBS buffer containing 2 μM Calcein AM and 4 μM EthD-1 for 30 minutes at room temperature. After the incubation, cells were washed with D-PBS to remove extra reagents and imaged.

Proliferation assay. Isolated cells in the cell-collection chambers were collected and placed in a 24-well plate. 0.5 mL of PBS supplemented with 5 μM CellTrace CFSE staining solution (Thermo Fisher Scientific, Waltham, MA) was added to each well, and the cells were incubated at 37° C. for 20 minutes. 1 mL warm OpTmizer™ T cell Expansion SFM (Thermo Fisher Scientific, Waltham, MA), supplemented with 2 mM L-glutamine (Thermo Fisher Scientific, Waltham, MA) and 150 IU mL⁻¹ (Thermo Fisher Scientific, Waltham, MA) were then added to each well and incubated for additional 5 minutes. Cells were centrifuged (5 min, 300 g) and resuspended with OpTmizer™ T cell Expansion SFM. Cells were stimulated with 1 μg mL⁻¹ CD3 and 1 μg mL⁻¹ CD28 on Day 1 and re-stimulated every seven days. A control group was prepared using cells without CD3 and CD28 stimulation. On Day 30, cells were harvested and analyzed for CellTrace CFSE signals with the flow cytometer (Agilent Quanteon, Agilent, Santa Clara, CA).

### REFERENCES FOR EXAMPLE 1

1. Labib, M.; Wang, Z. J.; Ahmed, S. U.; Mohamadi, R. M.; Duong, B.; Green, B.; Sargent, E. H.; Kelley, S. O., Tracking the expression of therapeutic protein targets in rare cells by antibody-mediated nanoparticle labelling and magnetic sorting. Nat Biomed Eng 2021, 5 (1), 41-+.
2. Ozkumur, E.; Shah, A. M.; Ciciliano, J. C.; Emmink, B. L.; Miyamoto, D. T.; Brachtel, E.; Yu, M.; Chen, P. I.; Morgan, B.; Trautwein, J.; Kimura, A.; Sengupta, S.; Stott, S. L.; Karabacak, N. M.; Barber, T. A.; Walsh, J. R.; Smith, K.; Spuhler, P. S.; Sullivan, J. P.; Lee, R. J.; Ting, D. T.; Luo, X.; Shaw, A. T.; Bardia, A.; Sequist, L. V.; Louis, D. N.; Maheswaran, S.; Kapur, R.; Haber, D. A.; Toner, M., Inertial Focusing for Tumor Antigen-Dependent and -Independent Sorting of Rare Circulating Tumor Cells. Sci Transl Med 2013, 5 (179).
3. Chen, Y. C.; Li, P.; Huang, P. H.; Xie, Y. L.; Mai, J. D.; Wang, L.; Nguyen, N. T.; Huang, T. J., Rare cell isolation and analysis in microfluidics. Lab Chip 2014, 14 (4), 626-645.
4. Poudineh, M.; Aldridge, P.; Ahmed, S.; Green, B. J.; Kermanshah, L.; Nguyen, V.; Tu, C.; Mohamadi, R. M.; Nam, R. K.; Hansen, A.; Sridhar, S. S.; Finelli, A.; Fleshner, N. E.; Joshua, A. M.; Sargent, E. H.; Kelley, S. O., Tracking the dynamics of circulating tumour cell phenotypes using nanoparticle-mediated magnetic ranking. Nat Nanotechnol 2017, 12 (3), 274-+.
5. Singh, M.; Jackson, K. J. L.; Wang, J. J.; Schofield, P.; Field, M. A.; Koppstein, D.; Peters, T. J.; Burnett, D. L.; Rizzetto, S.; Nevoltris, D.; Masle-Farquhar, E.; Faulks, M. L.; Russell, A.; Gokal, D.; Hanioka, A.; Horikawa, K.; Colella, A. D.; Chataway, T. K.; Blackburn, J.; Mercer, T. R.; Langley, D. B.; Goodall, D. M.; Jefferis, R.; Komala, M. G.; Kelleher, A. D.; Suan, D.; Rischmueller, M.; Christ, D.; Brink, R.; Luciani, F.; Gordon, T. P.; Goodnow, C. C.; Reed, J. H., Lymphoma Driver Mutations in the Pathogenic Evolution of an Iconic Human Autoantibody. Cell 2020, 180 (5), 878-+.
6. McCutcheon, M.; Wehner, N.; Wensky, A.; Kushner, M.; Doan, S.; Hsiao, L.; Calabresi, P.; Ha, T.; Tran, T. V.; Tate, K. M.; Winkelhake, J.; Spack, E. G., A sensitive ELISPOT assay to detect low-frequency human T lymphocytes. J Immunol Methods 1997, 210 (2), 149-166.
7. Raddassi, K.; Kent, S. C.; Yang, J. B.; Bourcier, K.; Bradshaw, E. M.; Seyfert-Margolis, V.; Nepom, G. T.; Kwok, W. W.; Hafler, D. A., Increased Frequencies of Myelin Oligodendrocyte Glycoprotein/MHC Class II-Binding CD4 Cells in Patients with Multiple Sclerosis. J Immunol 2011, 187 (2), 1039-1046.
8. Poudineh, M.; Sargent, E. H.; Pantel, K.; Kelley, S. O., Profiling circulating tumour cells and other biomarkers of invasive cancers. Nat Biomed Eng 2018, 2 (2), 72-84.
9. Alix-Panabieres, C.; Pantel, K., Clinical prospects of liquid biopsies. Nat Biomed Eng 2017, 1 (4).
10. Massague, J.; Obenauf, A. C., Metastatic colonization by circulating tumour cells. Nature 2016, 529 (7586), 298-306.
11. Krebs, M. G.; Metcalf, R. L.; Carter, L.; Brady, G.; Blackhall, F. H.; Dive, C., Molecular analysis of circulating tumour cells-biology and biomarkers. Nat Rev Clin Oncol 2014, 11 (3), 129-44.
12. Heitzer, E.; Haque, I. S.; Roberts, C. E. S.; Speicher, M. R., Current and future perspectives of liquid biopsies in genomics-driven oncology. Nat Rev Genet 2019, 20 (2), 71-88.
13. Ma, N.; Jeffrey, S. S., Deciphering cancer clues from blood. Science 2020, 367 (6485), 1424-1425.
14. Givan, A. L., Principles of flow cytometry: An overview. Method Cell Biol 2001, 63, 19-50.
15. Miltenyi, S.; Muller, W.; Weichel, W.; Radbruch, A., High-Gradient Magnetic Cell-Separation with Macs. Cytometry 1990, 11 (2), 231-238.
16. Murray, C.; Miwa, H.; Dhar, M.; Park, D. E.; Pao, E.; Martinez, J.; Kaanumale, S.; Loghin, E.; Graf, J.; Raddassi, K.; Kwok, W. W.; Hafler, D.; Puleo, C.; Di Carlo, D., Unsupervised capture and profiling of rare immune cells using multi-directional magnetic ratcheting (vol 18, pg 2396, 2018). Lab Chip 2018, 18 (23), 3703-3703.
17. Labib, M.; Philpott, D. N.; Wang, Z. J.; Nemr, C.; Chen, J. B.; Sargent, E. H.; Kelley, S. O., Magnetic Ranking Cytometry: Profiling Rare Cells at the Single-Cell Level. Accounts Chem Res 2020, 53 (8), 1445-1457.
18. Civelekoglu, O.; Liu, R. X.; Usanmaz, C. F.; Chu, C. H.; Boya, M.; Ozkaya-Ahmadov, T.; Arifuzzman, A. K. M.; Wang, N. Q.; Sarioglu, A. F., Electronic measurement of cell antigen expression in whole blood. Lab Chip 2022, 22 (2), 296-312.
19. McCloskey, K. E.; Moore, L. R.; Hoyos, M.; Rodriguez, A.; Chalmers, J. J.; Zborowski, M., Magnetophoretic cell sorting is a function of antibody binding capacity. Biotechnol Progr 2003, 19 (3), 899-907.
20. Sutermaster, B. A.; Darling, E. M., Considerations for high-yield, high-throughput cell enrichment: fluorescence versus magnetic sorting. Sci Rep-Uk 2019, 9.
21. Schneider, T.; Karl, S.; Moore, L. R.; Chalmers, J. J.; Williams, P. S.; Zborowski, M., Sequential CD34 cell fractionation by magnetophoresis in a magnetic dipole flow sorter. Analyst 2010, 135 (1), 62-70.
22. Reisbeck, M.; Helou, M. J.; Richter, L.; Kappes, B.; Friedrich, O.; Hayden, O., Magnetic fingerprints of rolling cells for quantitative flow cytometry in whole blood. Sci Rep-Uk 2016, 6.
23. Yenilmez, B.; Knowlton, S.; Tasoglu, S., Self-Contained Handheld Magnetic Platform for Point of Care Cytometry in Biological Samples. Adv Mater Technol-Us 2016, 1 (9).
24. Liu, Y.; Zhao, W. J.; Cheng, R.; Puig, A.; Hodgson, J.; Egan, M.; Pope, C. N. C.; Nikolinakos, P. G.; Mao, L. D., Label-free inertial-ferrohydrodynamic cell separation with high throughput and resolution. Lab on a Chip 2021, 21 (14), 2738-2750.
25. Kose, A. R.; Koser, H., Ferrofluid mediated nanocytometry. Lab Chip 2012, 12 (1), 190-196.
26. Chen, Q.; Li, D.; Zielinski, J.; Kozubowski, L.; Lin, J. H.; Wang, M. H.; Xuan, X. C., Yeast cell fractionation by morphology in dilute ferrofluids. Biomicrofluidics 2017, 11 (6).
27. Gijs, M. A. M.; Lacharme, F.; Lehmann, U., Microfluidic Applications of Magnetic Particles for Biological Analysis and Catalysis. Chem Rev 2010, 110 (3), 1518-1563.
28. McCloskey, K. E.; Chalmers, J. J.; Zborowski, M., Magnetophoretic mobilities correlate to antibody binding capacities. Cytometry 2000, 40 (4), 307-315.
29. McCloskey, K. E.; Comella, K.; Chalmers, J. J.; Margel, S.; Zborowski, M., Mobility measurements of immunomagnetically labeled cells allow quantitation of secondary antibody binding amplification. Biotechnol Bioeng 2001, 75 (6), 642-655.
30. Rosensweig, R. E., Ferrohydrodynamics. Cambridge University Press: Cambridge, 1985.
31. Zhao, W.; Liu, Y.; Jenkins, B. D.; Cheng, R.; Harris, B. N.; Zhang, W.; Xie, J.; Murrow, J. R.; Hodgson, J.; Egan, M.; Bankey, A.; Nikolinakos, P. G.; Ali, H. Y.; Meichner, K.; Newman, L. A.; Davis, M. B.; Mao, L., Tumor antigen-independent and cell size variation-inclusive enrichment of viable circulating tumor cells. Lab Chip 2019, 19 (10), 1860-1876.
32. Liu, Y.; Zhao, W. J.; Cheng, R.; Harris, B. N.; Murrow, J. R.; Hodgson, J.; Egan, M.; Bankey, A.; Nikolinakos, P. G.; Laver, T.; Meichner, K.; Mao, L. D., Fundamentals of integrated ferrohydrodynamic cell separation in circulating tumor cell isolation. Lab Chip 2021, 21 (9), 1706-1723.
33. Liu, Y.; Zhao, W. J.; Cheng, R.; Hodgson, J.; Egan, M.; Pope, C. N. C.; Nikolinakos, P. G.; Mao, L. D., Simultaneous biochemical and functional phenotyping of single circulating tumor cells using ultrahigh throughput and recovery microfluidic devices. Lab Chip 2021, 21 (18), 3583-3597.
34. Zhao, W.; Cheng, R.; Miller, J. R.; Mao, L., Label-Free Microfluidic Manipulation of Particles and Cells in Magnetic Liquids. Adv Funct Mater 2016, 26 (22), 3916-3932.
35. Zhao, W. J.; Liu, Y.; Jenkins, B. D.; Cheng, R.; Harris, B. N.; Zhang, W. Z.; Xie, J.; Murrow, J. R.; Hodgson, J.; Egan, M.; Bankey, A.; Nikolinakos, P. G.; Ali, H. Y.; Meichner, K.; Newman, L. A.; Davis, M. B.; Mao, L. D., Tumor antigen-independent and cell size variation-inclusive enrichment of viable circulating tumor cells. Lab Chip 2019, 19 (10), 1860-1876.
36. VanKooten, C.; Banchereau, J., CD40-CD40 ligand: A multifunctional receptor-ligand pair. Adv Immunol 1996, 61, 1-77.
37. Liu, Y.; Zhao, W.; Cheng, R.; Harris, B. N.; Murrow, J. R.; Hodgson, J.; Egan, M.; Bankey, A.; Nikolinakos, P. G.; Laver, T.; Meichner, K.; Mao, L., Fundamentals of integrated ferrohydrodynamic cell separation in circulating tumor cell isolation. Lab Chip 2021.
38. Cheng, R.; Zhu, T.; Mao, L., Three-dimensional and analytical modeling of microfluidic particle transport in magnetic fluids. Microfluidics and Nanofluidics 2014, 16 (6), 1143-1154.
39. Zhu, T.; Lichlyter, D. J.; Haidekker, M. A.; Mao, L., Analytical model of microfluidic transport of non-magnetic particles in ferrofluids under the influence of a permanent magnet. Microfluidics and Nanofluidics 2011, 10 (6), 1233-1245.
40. Zhao, W. J.; Cheng, R.; Lim, S. H.; Miller, J. R.; Zhang, W. Z.; Tang, W.; Xie, J.; Mao, L. D., Biocompatible and label-free separation of cancer cells from cell culture lines from white blood cells in ferrofluids. Lab Chip 2017, 17 (13), 2243-2255.
41. Liu, Y.; Zhao, W.; Cheng, R.; Logun, M.; Zayas-Viera, M. D. M.; Karumbaiah, L.; Mao, L., Label-free ferrohydrodynamic separation of exosome-like nanoparticles. Lab Chip 2020, 20 (17), 3187-3201.

### Example 2

This Example provides data and information supplemental to EXAMPLE 1, above.

### Derivation of Equations to Relate Cellular Magnetic Content of a Cell-Bead Complex to its Surface Antigen-Binding Capacity

Magnetic cell labeling includes direct and indirect labels. For direct labeling, primary antibodies conjugated to magnetic beads bind to cells that express the corresponding antigen molecules. For indirect labeling (FIG. 2A), a primary antibody is first used against a specific cell surface antigen, a secondary antibody conjugated to a magnetic bead is then used to bind to the unconjugated primary antibody through secondary binding sites on the primary antibody.

For direct labeling, the total number of magnetic beads n_{magnetic-beads} bound to a single cell's surface can be expressed as,

$${n}_{magnetic - beads} = α \times γ \qquad ( 2.1 )$$

where α is the cell surface antigen-binding capacity, representing the process of primary antibody binding and γ represents the number of magnetic beads conjugated to each primary antibody. α is a quantitative measure of the number of the primary antibodies bound to the cell and depends on the following parameters: the total number of binding sites of both specific and non-specific antigens on the cell surface n_{α}, fraction of antigens (specific and non-specific) bound by primary antibodies θ_{α}, and the valence of primary antibody λ_{α} (i.e., the number of antigen-binding sites occupied by one primary antibody). Therefore,

$$α = {n}_{α} \times {θ}_{α} \times {λ}_{α} \qquad ( 2.2 )$$

For indirect labeling, the total number of magnetic beads n_{magnetic-beads} bound to a single cell's surface can be expressed as,

$${n}_{magnetic - beads} = α \times β \times γ \qquad ( 2.3 )$$

where α is the cell surface antigen-binding capacity defined as in the case of direct labeling. β is the antibody amplification due to the secondary antibody binding to multiple sites on the primary antibody. β, as a quantitative measure, corresponds to the number of secondary antibodies per primary antibody. It depends on the following parameters: the number of binding sites on the primary antibody recognized by the secondary antibody n_{β}, fraction of binding sites on the primary antibody that are bound by the secondary antibody θ_{β}, and the valence of secondary antibody binding λ_{β} (i.e., the number of secondary binding sites occupied by one secondary antibody). In this case, γ represents the number of magnetic beads conjugated to each secondary antibody. Therefore,

$$β = {n}_{β} \times {θ}_{β} \times {λ}_{β} \qquad ( 2.4 )$$

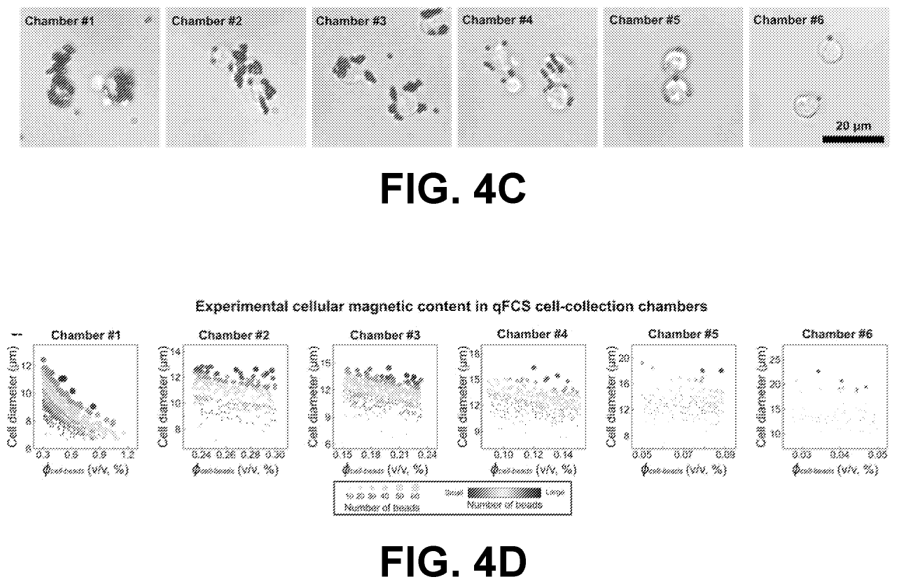

Equation (2.3), the total number of magnetic beads n_{magnetic-beads} bound to a single cell's surface through indirect labeling, would reduce to Equation (2.1), which is the case for direct labeling, when β=1, which means no amplification through secondary antibody. As a result, a general Equation (2.3) relates the total number of magnetic beads on a single cell's surface n_{magnetic-beads} to the cell surface antigen-binding capacity α.

$${n}_{magnetic - beads} = k α \qquad ( 2.5 )$$

Where k=β×γ. For commercial antibodies and magnetic beads that are made from the same batch, one may assume that both β and γ are constant, namely, the number of secondary antibody conjugated to each primary antibody is the same in the indirect labeling process, and the number of magnetic beads conjugated to each secondary antibody is also the same. However, the validity of these assumptions needs to be examined experimentally but is beyond the scope of this manuscript. The readers can refer to previous publications for studies on this subject. Assuming that k=β×γ is a constant in Equation (2.5), n_{magnetic-beads} is expected to have a linear relationship with α when α is relatively small. As α increases, the available area on a cell's surface becomes limited for magnetic bead binding, n_{magnetic-beads} could saturate due to steric hinderance between neighboring magnetic beads. The maximum number of magnetic beads that can be closely packed on the surface of a spherical cell with variable diameters is estimated in FIG. 8. For a majority of white blood cells with diameters ranging from 6-30 μm (lymphocytes: B and T cells, 6-8 μm in diameter; natural killer cells: 12-15 μm in diameter; granulocytes: 10-15 μm in diameter; and monocytes: 15-30 μm in diameter), the maximum number of magnetic beads with a diameter of 1.05 μm ranges from 120 to 3172. Given the fact that the majority of cells have approximately 1-50 magnetic beads on them, the cells used in this study didn't approach their maximum numbers in FIG. 8. Therefore, the total number of magnetic beads on a single cell's surface n_{magnetic-beads} can be assumed to have a linear relationship with cell surface antigen-binding capacity α, as in Equation (2.5).

The relationship between the cellular magnetic content ϕ_{cell-beads} (a dimensionless variable) and the total number of magnetic beads n_{magnetic-beads} bound to a single cell's surface can be established, thus the cell surface antigen-binding capacity α. The cellular magnetic content ϕ_{cell-beads} of a cell-beads complex is defined as,

$${ϕ}_{cell - beads} = \frac{{V}_{magnetic - content}}{{V}_{cell - beads}} \qquad ( 2.6 )$$

where V_{magnetic-content} is the volume of magnetic materials of the cell-beads complex, while V_{cell-beads} is the total volume of the cell-beads complex including the cell and magnetic beads, and has the following expression,

$${V}_{cell - beads} = \frac{π {D}_{cell}^{3}}{6} + {n}_{magnetic - beads} \times \frac{π {D}_{magnetic - bead}^{3}}{6} \qquad ( 2.7 )$$

where the spherical diameter of the cell is D_{cell}, and the diameter of a single magnetic bead is D_{magnetic-bead}. Substituting Equation (2.7) into Equation (2.6), the following expression to link the cellular magnetic content ϕ_{cell-beads} to the total number of magnetic beads n_{magnetic-beads} bound to a single cell's surface is determined,

$${ϕ}_{cell - beads} = \frac{{n}_{magnetic - beads} \times \frac{π {D}_{magnetic - bead}^{3}}{6} \times {ϕ}_{magnetic - bead}}{\frac{π {D}_{cell}^{3}}{6} + {n}_{magnetic - beads} \times \frac{π {D}_{magnetic - bead}^{3}}{6}} \qquad ( 2.8 )$$

FIG. 9 shows that for lymphocytes with a mean diameter of 7 μm that are conjugated with 1-50 magnetic beads (diameter: 1.05 μm; magnetic content: 11.5%, v/v), the relationship between the cellular magnetic content ϕ_{cell-beads} and the number of magnetic beads n_{magnetic-beads} on the cell surface can be approximated as a linear relationship (FIG. 9).

Substituting Equation (2.5) into Equation (2.8), the cellular magnetic content ϕ_{cell-beads} can be related to the number of magnetic beads n_{magnetic-beads},

$$( 2.9 )$$

$${ϕ}_{cell - beads} = \frac{{n}_{magnetic - beads} \times \frac{π {D}_{magnetic - bead}^{3}}{6} \times {ϕ}_{magnetic - bead}}{\frac{π {D}_{cell}^{3}}{6} + {n}_{magnetic - beads} \times \frac{π {D}_{magnetic - bead}^{3}}{6}} = \frac{{n}_{magnetic - beads} \times {D}_{magnetic - bead}^{3} \times {ϕ}_{magnetic - bead}}{{D}_{cell}^{3} + {n}_{magnetic - beads} \times {D}_{magnetic - bead}^{3}}$$

The relationship between the cellular magnetic content ϕ_{cell-beads} and the number of magnetic beads n_{magnetic-beads} on the cell surface in Equation (2.9) can be approximated as a linear relationship when the cellular diameters are constant. Following the same argument used in FIG. 9, for lymphocytes with a mean diameter of 7 μm that are conjugated with 1-50 magnetic beads (diameter: 1.05 μm; magnetic content: 11.5%, v/v), the relationship between the cellular magnetic content ϕ_{cell-beads} and kα can be also approximated as a linear relationship,

$${ϕ}_{cell - beads} ∝ k α \qquad ( 2.1 )$$

Where k=β×γ and is assumed to be a constant for commercial antibodies and magnetic beads that are made from the same batch, namely, the number of secondary antibody conjugated to each primary antibody is the same, and the number of magnetic beads conjugated to each secondary antibody is the same in the indirect labeling process. In that case, the equation can be simplified as,

$${ϕ}_{cell - beads} ∝ α \qquad ( 2.11 )$$

Equation (2.11) states that the cellular magnetic content ϕ_{cell-beads} is proportional to the cell's surface antigen-binding capacity α. It is noted that the following in deriving and using Equation (2.11).
a. Antigen binding capacity α is different from the total number of antigen binding sites on a cell's surface. Rather, α is a measure of the number of primary antibodies that bind to the cell's surface through both specific and non-specific bindings.
b. When the antigen binding capacity α is small, the cellular magnetic content is proportional to α. However, as the antigen-binding capacity α increases, the cellular magnetic content ϕ_{cell-beads} will saturate due to the maximum number of magnetic beads that can bind to a cell surface (steric hinderance effect). One needs to examine whether the linear relationship in Equation (2.11) holds true for a specific application, using parameters including the physical diameters of the cells, magnetic beads, and magnetic content of beads.
c. It is assumed that β and γ are a constant for commercial antibodies and magnetic beads that are made from the same batch. The number of secondary antibody conjugated to each primary antibody is the same in the indirect labeling process, and the number of magnetic beads conjugated to each secondary antibody is also the same.

However, for realistic cellular applications, cell diameters are heterogeneous thus need to take its effect into account. For this purpose, Equations (2.5) and (2.9) are combined and simplified assuming D_{cell}³<<n_{magnetic-beads}×D_{magnetic-bead}³ (the diameter of magnetic beads D_{magnetic-bead} in this study is ˜10 times smaller than that of a cell D_{cell}), which leads to the following relationship between the cellular magnetic content ϕ_{cell-beads} and the cell's surface antigen-binding capacity α,

$${ϕ}_{cell - beads} = ( {kD}_{magnetic - bead}^{3} {ϕ}_{magnetic - bead} ) \frac{α}{{D}_{cell}^{3}} \qquad ( 2.12 )$$

Equation (2.12) shows that the cellular magnetic content ϕ_{cell-beads} is proportional to a “cell volumetric antigen binding capacity”

$$α / {D}_{c e l l}^{3}$$

when other parameters k,

$${D}_{m a g n e n c - b e a d}^{3} ,$$

and ϕ_{magnetic-bead} are constant. Equation (2.12) can be further transformed by introducing a “cell surface density of antigen binding capacity”

$${α}_{S} = α / ( π {D}_{c e l l}^{2} ) ,$$

which leads to,

$${ϕ}_{c ell - beads} = ( πk {D}_{m a g net}^{3} , {ϕ}_{m agnet - bead} ) \frac{{α}_{S}}{{D}_{c e l l}} \qquad ( 2.13 )$$

Equation (2.13) shows that the cellular magnetic content ϕ_{cell-beads} is proportional to the ratio of surface density of antigen binding capacity to cellular diameter α_{S}/D_{cell}.

### Derivation of Magnetic Forces on the Cell-Beads Complex and the Effect of Beads Interaction on the Magnetic Force Calculation

### Derivation of Magnetic Forces on the Cell-Beads Complex

The magnetic forces on the cell-bead complex in qFCS are introduced as follows. Under an external magnetic field, ferrofluids have a magnetization of \vec{M}_{ferrofluid}, while cell-beads complex possesses a magnetization of \vec{M}_{cell-beads}, due to its labeling of magnetic beads. The interaction of the cell-bead complex with the external magnetic field depends on the balance of both “magnetophoresis” and “diamagnetophoresis”. FIG. 2B shows that magnetophoretic force results from the conjugated magnetic beads on the cell and directs the cell towards the maximum of a non-uniform magnetic field, while diamagnetophoretic force results from ferrofluids' magnetic nanoparticle-induced pressure imbalance on the cell's surface and directs the cell towards the minima of the magnetic field. The overall magnetic force on the cell-bead complex in the ferrofluid under an external magnetic field can be found in previous reports, and is also derived below. Considering the two competing magnetic forces acting on a cell-bead complex with a volume of V_{cell-beads} in the ferrofluid under an external magnetic field, the diamagnetophoretic body force on the cell-beads complex is generated from magnetic nanoparticle induced pressure imbalance on the surface of the cell-beads complex,

$${\vec{F}}_{diamagnetophoretic} = - {μ}_{0} {V}_{cell - beads} ( {\vec{M}}_{ferrofluid} \cdot ∇ ) \vec{H} \qquad ( 2.14 )$$

where μ₀=4π×10⁻⁷ H m⁻¹ is the permeability of free space, \vec{M}_{ferrofluid} is the magnetization of ferrofluids, and \vec{H} is magnetic field strength at the center of the cell-bead complex. The second magnetic force is the magnetophoretic force acting on the magnetic materials of the cell-beads complex with a volume of V_{magnetic-content} in the ferrofluid.

$${V}_{magnetic - content} = {V}_{cell - beads} \times {ϕ}_{cell - beads} \qquad ( 2.15 )$$

Where the volume fraction of magnetic materials in the cell-beads conjugate, or cellular magnetic content, is ϕ_{cell-beads}. The magnetophoretic force is then,

$${\vec{F}}_{magnetophoretic} = {μ}_{0} {V}_{magnet - content} \times ( {M}_{bulk \_ cell - beads} \cdot ∇ ) \vec{H} = {μ}_{0} {V}_{c ell - beads} \times {ϕ}_{cell - beads} \times ( {\vec{M}}_{bulk \_ cell - beads} \cdot ∇ ) \vec{H} = {μ}_{0} {V}_{c ell - beads} \times ( {\vec{M}}_{c ell - beads} \cdot ∇ ) \vec{H} \qquad ( 2.16 )$$

where the bulk magnetization of magnetic materials in the magnetic bead is \vec{M}_{bulk_cell-beads}. Cell-beads complex's magnetization \vec{M}_{cell-beads} is, in fact, the product of ϕ_{cell-beads} and \vec{M}_{bulk_cell-beads}. This relationship can be used to simplify Equation (2.16),

$${\vec{M}}_{c ell - beads} = {ϕ}_{c ell - beads} \times {\vec{M}}_{bulk \_ cell - beads} \qquad ( 2.17 )$$

With the above derivations, the overall magnetic force acting on the cell-beads complex is obtained, which is the sum of the two competing forces: diamagnetophoretic and magnetophoretic forces,

$${\vec{F}}_{m} = {\vec{F}}_{d iamagnetophoretic} + {\vec{F}}_{magnetophoeritc} = - {μ}_{0} {V}_{cell - beads} \{ ( {\vec{M}}_{ferrofluid} - {\vec{M}}_{c ell - beads} ) \cdot ∇ \} \vec{H} \qquad ( 2.18 )$$

From Equation (2.18), we know that the direction and magnitude of the overall magnetic force \vec{F}ₘ acting on a cell-beads complex in qFCS depends delicately on the product of the cell-beads complex's volume and the magnetization contrast between the cell-beads complex and the ferrofluid, i.e., the term V_{cell-beads}(\vec{M}_{ferrofluid}−\vec{M}_{cell-beads}) in Equation (2.18). It is noted that similarly to Equation (2.17), where a cell-beads complex's magnetization \vec{M}_{cell-beads} is the product of its magnetic content ϕ_{cell-beads} and the bulk magnetization of magnetic materials in the magnetic bead \vec{M}_{bulk_cell-beads}, a ferrofluid's magnetization \vec{M}_{ferrofluid} is also the product of its magnetic content ϕ_{ferrofluid} (often referred to as ferrofluid concentration, which is the volume fraction of magnetic materials in the ferrofluid) and the bulk magnetization of magnetic materials in the ferrofluid \vec{M}_{bulk_ferrofluid},

$${\vec{M}}_{ferrofluid} = {ϕ}_{ferrofluid} \times {\vec{M}}_{bulk \_ ferrofluid} \qquad ( 2.19 )$$

Now the case in which a cell-beads complex flows through one of the stages of the ferrofluids in the qFCS is considered. When the condition of \vec{M}_{cell-beads}≤\vec{M}_{ferrofluid} is met, i.e., ϕ_{cell-beads}≤ϕ_{ferrofluid} assuming the ferrofluid and the magnetic beads are made of the same magnetic material, the diamagnetophoretic force overcomes the magnetophoretic force and drives the cell-beads complex to the next stage against a hydrodynamic viscous drag. On the other hand, when the condition of \vec{M}_{cell-beads}>\vec{M}_{ferrofluid} is met, i.e., ϕ_{cell-beads}>ϕ_{ferrofluid}, the magnetophoretic force outweighs the diamagnetophoretic force and traps the cell-beads complex in that stage. This way, each stage of the qFCS with a variable ferrofluid concentration ϕ_{ferrofluid} can trap cell-beads complexes with matching cellular magnetic content.

### Effect of Beads Interaction on the Magnetic Force Calculation

It is noted that in this study the magnetic beads are attached to the surface of the cells, and in certain cases, the magnetic beads can be in close proximity to each other, which may give rise to the bead-to-bead interaction. While this bead-to-bead interaction is largely neglected in magnetic force calculation in most literatures, this bead-to-bead interaction is estimated and its effect on the overall magnetic force calculation expressed in Equation (2.18) when it is applied to individual magnetic beads. This estimate follows the method introduced by Mikkelsen et al.

Here, the simplest case is considered where two spherical magnetic beads are attached to the surface of the cell and are separated from each other by |\vec{r}₁−\vec{r}₂|, where \vec{r}₁ is the center location of bead #1 and \vec{r}₂ is the center location of bead #2. The presence of the magnetic bead #2 perturbs its local magnetic field, which in turn changes the local magnetic field around magnetic bead #1, as well as the magnetization of magnetic bead #1. This gives rise to an interaction between the two beads. Learning how this interaction affects the overall expression of the magnetic force experienced by magnetic bead #1 is of interest. From earlier Equation (2.16) it is known that the magnetic force experienced by the magnetic bead #1, without consideration of beads interaction, has the following expression,

$${\vec{F}}_{magnetophoretic \_ bead \_ 1} = {μ}_{0} {V}_{bead \_ 1} \times ( {\vec{M}}_{bead \_ 1} \cdot ∇ ) \vec{H} \qquad ( 2.2 )$$

where μ₀=4π×10⁻⁷ H m⁻¹ is the permeability of free space, V_{bead_1} is the volume of the magnetic bead #1, \vec{M}_{bead_1} is the magnetization of the magnetic bead #1, and \vec{H} is magnetic field strength at the center of bead #1.

After considering the effect of having magnetic bead #2 in close proximity of magnetic bead #1, which modifies the local magnetic field and the magnetization of bead #1, the modified magnetic force on bead #1 at \vec{r}₁ is,

$${\vec{F}}_{magnetophoretic \_ bead \_ 1 \_ correction} = {μ}_{0} {V}_{bead \_ 1} \times ( ( {\vec{M}}_{bead \_ 1} + Δ {\vec{M}}_{bead \_ 1} ) \cdot ∇ ) ( \vec{H} + Δ {\vec{H}}_{bead \_ 2} ) \qquad ( 2.21 )$$

Where Δ\vec{H}_{bead_2} is the change to the magnetic field due to the perturbation introduced by the bead #2, and Δ\vec{M}_{bead_1} is the change in magnetization of bead #1 caused by the magnetic field change. Comparing Equation (2.21) to Equation (2.20), it is noticed that there are a total of three additional terms in the magnetic force expression, which are:

$$( Δ {\vec{M}}_{bead \_ 1} ) \cdot ∇ \vec{H} \qquad ( i )$$

$$( {\vec{M}}_{bead \_ 1} \cdot ∇ ) Δ {\vec{H}}_{bead \_ 2} \qquad ( ii )$$

$$( Δ {\vec{M}}_{bead \_ 1} \cdot ∇ ) {\vec{H}}_{bead \_ 2} \qquad ( iii )$$

The following calculations show that:
(i) term (Δ\vec{M}_{bead_1})·∇\vec{H} is of order −3 in the separation between the centers of two beads |\vec{r}₁−\vec{r}₂|.
(ii) term (\vec{M}_{bead_1}·∇)Δ\vec{H}_{bead_2} is of order −4 in the separation between the centers of two beads |\vec{r}₁−\vec{r}₂|.
(iii) term (Δ\vec{M}_{bead_1}·∇)Δ\vec{H}_{bead_2} is of order −7 in the separation between the centers of two beads |\vec{r}₁−\vec{r}₂|.
   The expression of these terms can be obtained by first looking at Δ\vec{H}_{bead_2}, which is to leading order a dipole field and falls off as distance to the power of −3. Assuming the beads have a diameter of 2a, the following is the expression for Δ\vec{H}_{bead_2} of a dipole,

$$Δ {\vec{H} ( \vec{r} )}_{bead \_ 2} = \frac{χ}{χ + 3} \frac{{a}^{3}}{{\vert {\vec{r}}_{1} - {\vec{r}}_{2} \vert}^{3}} ( \frac{3 ( \vec{H} ( {\vec{r}}_{2} ) \cdot ( \vec{r} - {\vec{r}}_{2} ) ) ( \vec{r} - {\vec{r}}_{2} )}{{( \vec{r} - {\vec{r}}_{2} )}^{2}} - \vec{H} ( {\vec{r}}_{2} ) ) \qquad ( 2.22 )$$

where χ is the volumetric magnetic susceptibility of the beads. It is also assumed that the external magnetic field are sufficiently small so that the bead magnetization depends linearly on the external field.

$$\vec{M} = \frac{3 χ}{χ + 3} \vec{H} \qquad ( 2.23 )$$

As a result, Δ\vec{M}_{bead_1} can be estimated as,

$$Δ {\vec{M}}_{bead \_ 1} = 3 {( \frac{χ}{χ + 3} )}^{2} \frac{{a}^{3}}{{\vert {\vec{r}}_{1} - {\vec{r}}_{2} \vert}^{3}} \times ( \frac{3 ( \vec{H} ( {\vec{r}}_{2} ) \cdot ( {\vec{r}}_{1} - {\vec{r}}_{2} ) ) ( \vec{r} - {\vec{r}}_{2} )}{{( {\vec{r}}_{1} - {\vec{r}}_{2} )}^{2}} - \vec{H} ( {\vec{r}}_{2} ) ) \qquad ( 2.24 )$$

From Equations (2.22) and (2.24), the expression for (Δ\vec{M}_{bead_1})·∇\vec{H} can be obtained,

$$( Δ {\vec{M}}_{bead \_ 1} ) \cdot ∇ \vec{H} ( {\vec{r}}_{1} ) = 3 {( \frac{χ}{χ + 3} )}^{2} \frac{{a}^{3}}{{\vert {\vec{r}}_{1} - {\vec{r}}_{2} \vert}^{3}} \times ( \frac{3 ( \vec{H} ( {\vec{r}}_{2} ) \cdot ( {\vec{r}}_{1} - {\vec{r}}_{2} ) ) ( ( {\vec{r}}_{1} - {\vec{r}}_{2} ) \cdot ∇ ) \vec{H} ( {\vec{r}}_{1} )}{{( {\vec{r}}_{1} - {\vec{r}}_{2} )}^{2}} - ( \vec{H} ( {\vec{r}}_{2} ) \cdot ∇ ) \vec{H} ( {\vec{r}}_{1} ) ) \qquad ( 2.25 )$$

It is shown that (Δ\vec{M}_{bead_1})·∇\vec{H} is of order −3 in the separation between the centers of two beads |\vec{r}₁−\vec{r}₂|. Similarly, it is known that (\vec{M}_{bead_1}·∇)Δ\vec{H}_{bead_2} is of order −4 in the separation between the centers of two beads |\vec{r}₁−\vec{r}₂|, and (Δ\vec{M}_{bead_1}·∇)Δ\vec{H}_{bead_2} is of order −7 in the separation between the centers of two beads |\vec{r}₁−\vec{r}₂|. The rational is that Δ\vec{H}_{bead_2} and Δ\vec{M}_{bead_1} each contribute a dependence on the separation between the centers of two beads |\vec{r}₁−\vec{r}₂| to the power of −3, and the differentiation contributes to a power of −1.

In summary, the leading term (Δ\vec{M}_{bead_1})·∇\vec{H} in the correction of the magnetic force calculation is of order −3 in the separation between the centers of two beads |\vec{r}₁−\vec{r}₂|. The other two additional terms, (\vec{M}_{bead_1}·∇)Δ\vec{H}_{bead_2} and (Δ\vec{M}_{bead_1}·∇)Δ\vec{H}_{bead_2}, can be safely neglected due to the fact that they are of order −4 and −7. Even though only two magnetic beads are considered in this estimate, the influence from more beads can also be safely neglected, because they are of even higher order dependence in the separation between the centers of two beads |\vec{r}₁−\vec{r}₂|.

To quantify the correction to the magnetic force calculation in the study, the following calculation assumes the two beads are in contact with each other, and with the following experimental conditions that were relevant to the study: magnetic flux density B is 0.1 Tesla, gradient of magnetic flux density ∇B is 40 Tesla/m, diameter of the magnetic bead 2a is 1.05 μm, volume fraction of magnetic materials in the magnetic bead is 11.5% (v/v), bulk magnetization of magnetic materials in the bead is 370,000 A/m, magnetic susceptibility of the magnetic bead in weak magnetic field is 0.83 on average, separation of centers of two magnetic beads |\vec{r}₁−\vec{r}₂| is 1.05 μm.

$${\vec{F}}_{magnetophoretic \_ bead \_ 1} = {μ}_{0} {V}_{bead \_ 1} \times ( {\vec{M}}_{bead \_ 1} \cdot ∇ ) \vec{H} = 1.03 pN \qquad ( 2.26 )$$

$${\vec{F}}_{magnetophoretic \_ bead \_ 1 \_ correction} = {μ}_{0} {V}_{bead \_ 1} \times ( ( {\vec{M}}_{bead \_ 1} + Δ {\vec{M}}_{bead \_ 1} ) \cdot ∇ ) ( \vec{H} + Δ {\vec{H}}_{bead \_ 2 )} \approx {μ}_{0} {V}_{bead \_ 1} \times ( {\vec{M}}_{bead \_ 1} \cdot ∇ ) \vec{H} + {μ}_{0} {V}_{bead \_ 1} \times ( Δ {\vec{M}}_{bead \_ 1} \cdot ∇ ) \vec{H} = 1.03 pN + 0 \text{.07} pN = 1.10 pN \qquad ( 2.27 )$$

Through this calculation, the correction introduced by the presence of multiple beads to the magnetic force calculation on individual beads is estimated at ˜7%. As a result, the magnetic force expression in Equation (2.20) can be used to calculate the cell-beads complex force in the ferrofluid without considering the bead-to-bead interaction.

### Relationship Between Light Absorbance of Ferrofluids and its Concentration (Volume Fraction of Magnetic Materials)

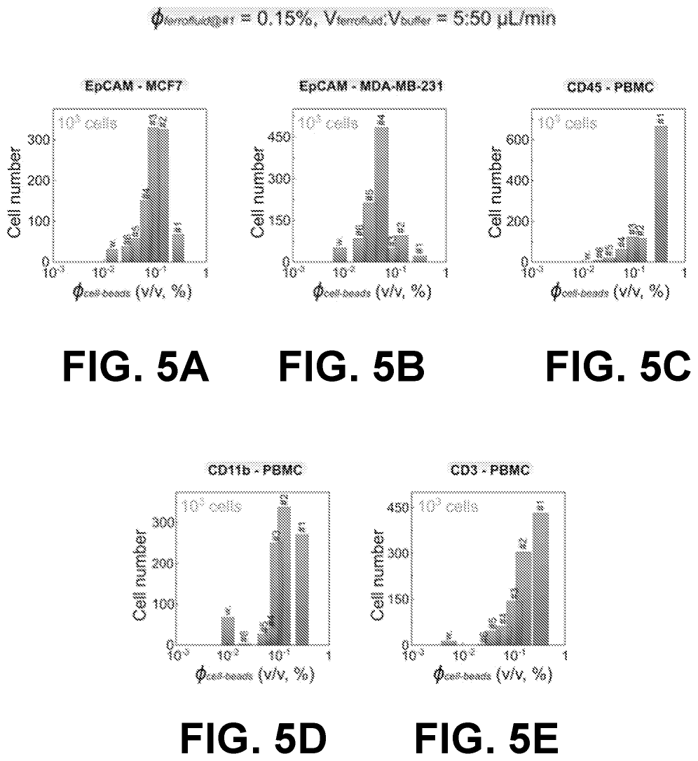

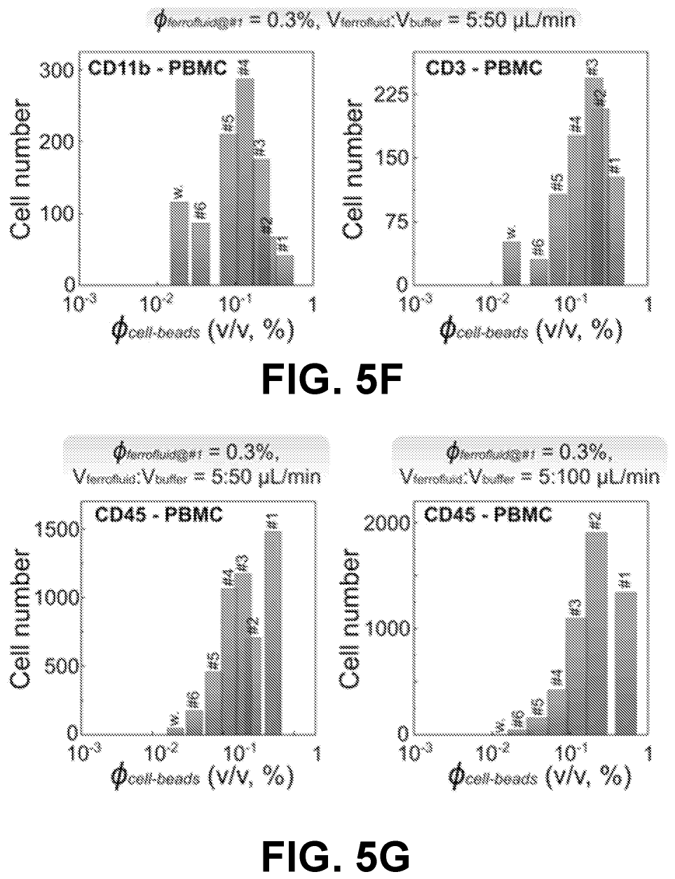

The relationship between the light absorbance of ferrofluids and its concentration can be derived following existing theory. First, the optical depth of a thin layer of colloidal nanoparticle solution is derived. It is assumed that the light absorbers (magnetic nanoparticles in ferrofluids) do not shadow each other in the thin layer in the direction of light. The optical depth is a measure of how much light absorption occurs when light travels through a light-absorbing medium such as the ferrofluid. FIG. 10A shows the thin layer of ferrofluid with magnetic nanoparticles. The total volume of the cylinder in FIG. 10A is L×A, and the number of the magnetic nanoparticles in the cylinder is n×L×A, n is the number density of the magnetic nanoparticles in the ferrofluid with a unit of m⁻³. It is also known that the cross-sectional area of one nanoparticle is σ=πr², where r is the radius of the nanoparticle. Therefore, the fractional area that is blocked by the nanoparticles in the direction of light is σₜₒₜₐₗ=n×L×A×σ, and the fraction of light that is blocked is τ=σₜₒₜₐₗ/A=nLσ. τ is defined as the optical depth, a dimensionless variable. The ferrofluid concentration (volume fraction) ϕ_{ferrofluid} can be converted to the number density of magnetic nanoparticles in the ferrofluid through n=3ϕ_{ferrofluid}/(4πr³).

Second, an optically thick layer of ferrofluids in which magnetic nanoparticles shadow each other in the direction of light is considered. FIG. 10B shows that this optically thick layer of ferrofluids can be divided into numerous optically thin layers. The change in light intensity dI after light travels through one thin layer is,

$$dI = - I \times n σ dL = - Id τ \qquad ( 2.28 )$$

$$\frac{dI}{I} = - d τ$$

Integrating Equation (2.28),

$${\int }_{{I}_{in}}^{{I}_{out}} = {\int }_{0}^{τ} d τ \qquad ( 2.29 )$$

$${[ ln I ]}_{{I}_{in}}^{{I}_{out}} = - {[ τ ]}_{0}^{τ}$$

Therefore,

$$ln \frac{{I}_{out}}{{I}_{in}} = - τ \qquad ( 2.3 )$$

$$\frac{{I}_{out}}{{I}_{in}} = {e}^{- τ}$$

The light absorbance of the ferrofluid is defined as,

$$Absorbance = {log}_{10} \frac{{I}_{in}}{{I}_{o u t}} \qquad ( 2.31 )$$

FIG. 11 shows the theoretical linear relationship between the ferrofluid absorbance and its concentration (volume fraction), which is consistent with the experimental data in FIG. 3D. The discrepancy in the absolute values of ferrofluid absorbance between FIG. 11 and FIG. 3D may be attributed to the use of a mean nanoparticle diameter in FIG. 11 while in fact the ferrofluid has nanoparticles with a log normal distribution of diameters.

Governing Equations for Cell Trajectory in qFCS

In this section, the governing equations used for cell trajectory simulation in qFCS are discussed. Magnetic fields, cell trajectories, and cell isolation process in the qFCS device were simulated in MATLAB (MathWorks, Natick, MA) using a three-dimensional analytical model. Briefly, this model simulates the transport of magnetizable cells in a ferrofluid inside a microfluidic channel coupled with permanent magnets. This model uses the combination of an analytical solution of magnetic field distribution and experimentally verified ferrofluid magnetization together to calculate magnetic forces on cells. The balance of magnetic force and hydrodynamic drag force on cells in low-Reynolds number flow condition are then used to simulate the cell trajectories.

The three-dimensional expression of the net magnetic force on a magnetizable body in a magnetizable fluid (ferrofluid) is given in the main text,

$${\vec{F}}_{m} = - {μ}_{0} V \{ ( {\vec{M}}_{ferrofluid} - {\vec{M}}_{cell - beads} ) \cdot ∇ \} \vec{H} \qquad ( 2.32 )$$

In three-dimensional space,

$${F}_{m , x} = - {μ}_{0} V [ ( {M}_{f , x} - {M}_{p , x} ) \frac{\partial {H}_{x}}{\partial x} + ( {M}_{f , y} - {M}_{p , y} ) \frac{\partial {H}_{x}}{\partial y} + ( {M}_{f , z} - {M}_{p , z} ) \frac{\partial {H}_{x}}{\partial z} ] \qquad ( 2.33 )$$

$${F}_{m , y} = - {μ}_{0} V [ ( {M}_{f , x} - {M}_{p , x} ) \frac{\partial {H}_{y}}{\partial x} + ( {M}_{f , y} - {M}_{p , y} ) \frac{\partial {H}_{y}}{\partial y} + ( {M}_{f , z} - {M}_{p , z} ) \frac{\partial {H}_{y}}{\partial z} ] \qquad ( 2.34 )$$

$${F}_{m , z} = - {μ}_{0} V [ ( {M}_{f , x} - {M}_{p , x} ) \frac{\partial {H}_{z}}{\partial x} + ( {M}_{{f}_{, y}} - {M}_{p , y} ) \frac{\partial {H}_{z}}{\partial y} + ( {M}_{f , z} - {M}_{p , z} ) \frac{\partial {H}_{z}}{\partial z} ] \qquad ( 2.35 )$$

where F_{m,x}, F_{m,y} and F_{m,y} are the x, y and z components of the magnetic force vector. M_{f,x}, M_{f,y} and M_{f,z} are the x, y and z components of the ferrofluid magnetization vector. M_{p,x}, M_{p,y} and M_{p,z} are the x, y and z components of the cell-beads complex magnetization vector. Hₓ, H_{y} and H_{z} are the x, y and z components of the magnetic field strength vector.

The magnetic force \vec{F}ₘ acting on the cell is balanced by the hydrodynamic viscous drag force \vec{F}_{d}, when there is a relative motion between the cell and the fluid flow. Its expression is,

$${\vec{F}}_{d} = - 3 π η {D}_{p} ( {\vec{v}}_{p} - {\vec{v}}_{f} ) λ \qquad ( 2.36 )$$

where η is the ferrofluid viscosity, Dₚ is the diameter of a spherical cell, \vec{v}ₚ and \vec{v}_{f} are the velocity vectors of the ferrofluid and the cell. λ includes the parallel (λ_{∥}) and perpendicular (λ_{⊥}) components of the hydrodynamic drag force coefficient of a moving cell after taking into account the influence from one nearby flat surface. Its appearance indicates increased fluid viscosity as the object moves closer to the solid surface.

$${λ}_{∥} = 1 - {[ 1 - \frac{9}{16} ( \frac{{D}_{p}}{{D}_{p} + 2 Δ} ) + \frac{1}{8} {( \frac{{D}_{p}}{{D}_{p} + 2 Δ} )}^{3} - \frac{45}{256} {( \frac{{D}_{p}}{{D}_{p} + 2 Δ} )}^{4} - \frac{1}{16} ( \frac{{D}_{p}}{{D}_{p} + 2 Δ} ) ]}^{- 1} \qquad ( 2.37 )$$

$${λ}_{⊥} = {[ 1 - \frac{9}{8} ( \frac{{D}_{p}}{{D}_{p} + 2 Δ} ) + \frac{1}{2} {( \frac{{D}_{p}}{{D}_{p} + 2 Δ} )}^{3} ]}^{- 1} \qquad ( 2.38 )$$

where Δ is the shortest distance between the solid surface and the surface of the object.

In three-dimensional space,

$${F}_{d , x} = - 3 π η {D}_{p} ( {v}_{p , x} - {v}_{f , x} ) {λ}_{∥} \qquad ( 2.39 )$$

$${F}_{d , y} = - 3 π η {D}_{p} ( {v}_{p , y} - {v}_{f , y} ) {λ}_{∥} \qquad ( 2.4 )$$

$${F}_{d , z} = - 3 π η {D}_{p} ( {v}_{p , z} - {v}_{f , z} ) {λ}_{⊥} \qquad ( 2.41 )$$

The balance of Eqs. (2.32) and (2.36) under laminar flow condition at low Reynold's number was used to predict the trajectories of magnetizable cells.

$${\vec{F}}_{m} + {\vec{F}}_{d} = 0 \qquad ( 2.42 )$$

which yields

$$[ \begin{matrix}{v}_{p , x} \\ {v}_{p , y} \\ {v}_{p , z}\end{matrix} ] = [ \begin{matrix}{v}_{f , x} \\ 0 \\ 0\end{matrix} ] - \frac{{μ}_{0} {D}_{p}^{2}}{18 η} ( \begin{matrix}\frac{1}{{λ}_{∥}} ( ( {M}_{f , x} - {M}_{p , x} ) \frac{\partial {H}_{x}}{\partial x} + ( {M}_{f , y} - \\ {M}_{p , y} ) \frac{\partial {H}_{x}}{\partial y} + ( {M}_{f , z} - {M}_{p , z} ) \frac{\partial {H}_{x}}{\partial z} ) \\ \frac{1}{{λ}_{∥}} ( ( {M}_{f , x} - {M}_{p , x} ) \frac{\partial {H}_{y}}{\partial x} + ( {M}_{f , y} - \\ {M}_{p , y} ) \frac{\partial {H}_{y}}{\partial y} + ( {M}_{f , z} - {M}_{p , z} ) \frac{\partial {H}_{y}}{\partial z} ) \\ \frac{1}{{λ}_{⊥}} ( ( {M}_{f , x} - {M}_{p , x} ) \frac{\partial {H}_{z}}{\partial x} + ( {M}_{f , y} - \\ {M}_{p , y} ) \frac{\partial {H}_{z}}{\partial y} + ( {M}_{f , z} - {M}_{p , z} ) \frac{\partial {H}_{z}}{\partial z} )\end{matrix} ) \qquad ( 2.43 )$$

where it is assumed the magnetizable body is spherical and

$$V = \frac{1}{6} π {D}_{p}^{3} .$$

v_{f,x} in Eq. (2.43) is the ferrofluid velocity profile of a fully developed laminar flow in a rectangular microchannel (see FIG. 1F for coordinates) of width w and height h.

$${v}_{f , x} = \frac{π Q}{2 w h} ( \frac{a}{b} ) \qquad ( 2.44 )$$

where Q is the sample flow rate and,

$$a = {\sum }_{n = 0}^{∞} \frac{{( - 1 )}^{n} cos [ \frac{( 2 n + 1 ) π z}{w} ]}{{( 2 n + 1 )}^{3}} [ 1 - \frac{cosh [ \frac{( 2 n + 1 ) π y}{w} ]}{cosh [ \frac{( 2 n + 1 ) π h}{2 w} ]} ] \qquad ( 2.45 )$$

$$b = {\sum }_{n - 0}^{∞} \frac{1}{{( 2 n + 1 )}^{4}} [ 1 - \frac{tanh [ \frac{( 2 n + 1 ) π h}{2 w} ]}{\frac{( 2 n + 1 ) π h}{2 w}} ] \qquad ( 2.46 )$$

Eq. (2.43) is a coupled ordinary differential equation (ode) system for the cell trajectory. An ode solver (ode45) in MATLAB was used to solve the system.
Simulation and Experimental Data on the Ferrofluid Concentration in qFCS Devices at Constant Flow Ratios (Ferrofluid: Buffer)

Shown in FIG. 12 are simulation (left panel) and experimental (right panel) results of the ferrofluid concentration in the chambers at variable inlet A flow rate (0.3%, v/v ferrofluid, 2-10 μL min-1) and inlet B flow rate (PBS buffer, 20-100 μL min-1). The ratio between sample flow rate and sheath flow rate is kept at a constant of 1:10. Simulated ferrofluid concentration profile is predicated to have a constant slope when the flow ratio between ferrofluid and buffer flows remains the same. Experimental data confirm the prediction but do have a slight deviation from the simulation, especially at stages 3-4 of the device.

FIG. 13 shows a magnetic flux density (surface plot) and gradient of flux density (line plot) in the cell-collection chamber #1 of the qFCS device.

FIG. 14 shows ferrofluid concentration profiles in the qFCS device at different starting ferrofluid concentrations (0.03%, 0.05%, 0.10%, 0.15%, 0.30%, v/v). The ferrofluid flow and buffer flow rate are 5 μL min⁻¹ and 50 μL min⁻¹, respectively.

FIGS. 15A and 15 illustrate simulation data on maximum flow rates for qFCS. Shown in FIG. 15A are the final positions of cells in cell-collection chamber #6 in qFCS with variable flow rates and cell diameters. The ferrofluid concentration is 0.0027% (v/v) and the magnetic content of cell is 0.005% (v/v) in this simulation. The green dashed line indicates the separation threshold (final position, Y<0). Shown in FIG. 15B, a maximum of 105 μL min⁻¹ is estimated in cell-chamber #6 with 0.0027% (v/v) ferrofluid for the capture of all cells (5 μm cell with 0.005% (v/v) cellular magnetic content).

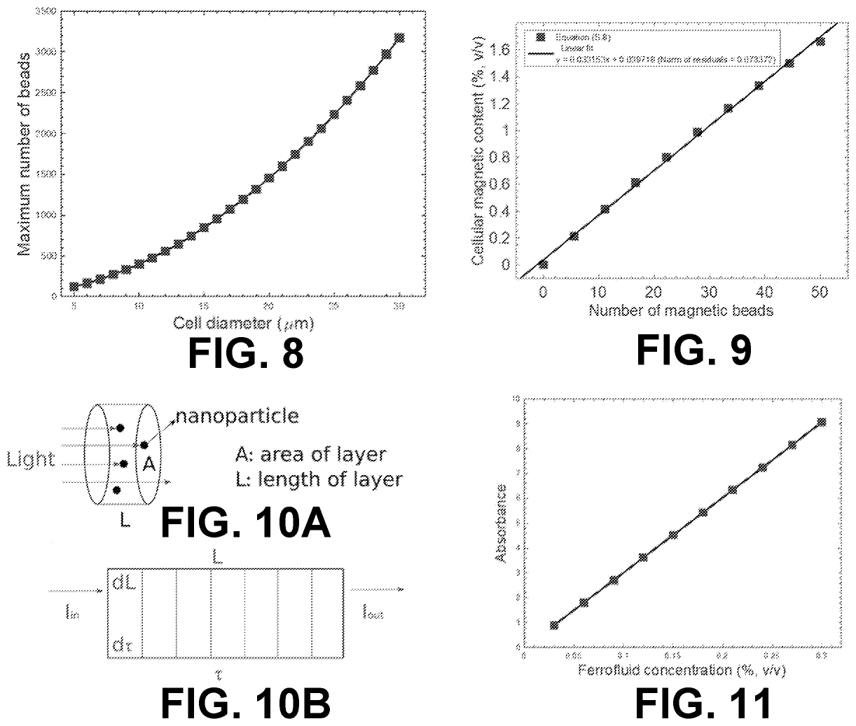

FIGS. 16A-16C illustrate simulation data of cell-beads complexes corresponding to the FIG. 4B (left panel). In FIG. 16A, a number of magnetic beads on the cells in each cell-collection chamber in the qFCS is shown. The mean numbers of magnetic beads on the cells are 32±12 (chamber #1, n=509), 30±13 (chamber #2, n=88), 29±14 (chamber #3, n=167), 29±14 (chamber #4, n=241), 29±14 (chamber #5, n=317), 29±14 (chamber #6, n=409), and 16±12 (waste outlet, n=819). All values are mean±s.d.

FIG. 16B shows the cell diameters in each cell-collection chamber in the qFCS. The mean diameters (μm) in each chamber are 7.82±2.00 (chamber #1, n=509), 11.01±2.05 (chamber #2, n=88), 12.25±2.41 (chamber #3, n=167), 14.42±2.94 (chamber #4, n=241), 17.43±3.59 (chamber #5, n=317), 21.20±4.45 (chamber #6, n=409), and 24.37±4.69 (waste outlet, n=819). All values are mean±s.d.

FIG. 16C shows the calculated cellular magnetic contents in each cell-collection chamber in the qFCS. The cellular magnetic contents (v/v, %) are 1.01±0.74 (chamber #1, n=509), 0.26±0.02 (chamber #2, n=88), 0.19±0.02 (chamber #3, n=167), 0.12±0.02 (chamber #4, n=241), 0.07±0.01 (chamber #5, n=317), 0.04±0.01 (chamber #6, n=409), and 0.01±0.01 (waste outlet, n=819). All values are mean±s.d. This sets of data is also presented in the main text in FIG. 3b (left panel).

FIG. 17 shows the diameter distribution of cells collected in qFCS chambers. (a) CD45+ WBCs (b) CD154+ T cells.

FIG. 18 shows the number of magnetic beads on CD45+ WBCs with respect to cell diameter. (FIG. 4D), before separation (before) and after separation (chamber #1-6).

FIG. 19 shows the cell viability and cell proliferation assay for evaluating qFCS biocompatibility. (a) Short-term viability of CD3 positive cells before and after the qFCS processing. The cell viability of CD3 positive cells before and after qFCS is determined to be 93.7±2.2% (mean±s.d., n=3) and 91.8±1.6% (mean±s.d., n=3), respectively. (b) Flow cytometry measurement of CFSE intensity of CD3 positive cells (left panel, cell-collection chamber #1) and unstimulated T cells after 30 day's proliferation. The CD3 positive cells were stimulated with anti-CD3 and anti-CD28.

### REFERENCES FOR EXAMPLE 2

1. Gijs, M. A. M.; Lacharme, F.; Lehmann, U., Microfluidic Applications of Magnetic Particles for Biological Analysis and Catalysis. Chemical Reviews 2010, 110, 1518-1563.
2. McCloskey, K. E.; Moore, L. R.; Hoyos, M.; Rodriguez, A.; Chalmers, J. J.; Zborowski, M., Magnetophoretic cell sorting is a function of antibody binding capacity. Biotechnology Progress 2003, 19, 899-907.
3. McCloskey, K. E.; Chalmers, J. J.; Zborowski, M., Magnetophoretic mobilities correlate to antibody binding capacities. Cytometry 2000, 40, 307-315.
4. McCloskey, K. E.; Comella, K.; Chalmers, J. J.; Margel, S.; Zborowski, M., Mobility measurements of immunomagnetically labeled cells allow quantitation of secondary antibody binding amplification. Biotechnology and Bioengineering 2001, 75, 642-655.
5. Daniels V G, W. P., Burkitt H G, Functional histology: A text and colour atlas. Churchill Livingstone 1979.
6. Rosensweig, R. E., Ferrohydrodynamics. Cambridge University Press:Cambridge, 1985.
7. Zhao, W.; Liu, Y.; Jenkins, B. D.; Cheng, R.; Harris, B. N.; Zhang, W.; Xie, J.; Murrow, J. R.; Hodgson, J.; Egan, M.; Bankey, A.; Nikolinakos, P. G.; Ali, H. Y.; Meichner, K.; Newman, L. A.; Davis, M. B.; Mao, L., Tumor antigen-independent and cell size variation-inclusive enrichment of viable circulating tumor cells. Lab on a Chip 2019, 19, 1860-1876.
8. Liu, Y.; Zhao, W. J.; Cheng, R.; Harris, B. N.; Murrow, J. R.; Hodgson, J.; Egan, M.; Bankey, A.; Nikolinakos, P. G.; Laver, T.; Meichner, K.; Mao, L. D., Fundamentals of integrated ferrohydrodynamic cell separation in circulating tumor cell isolation. Lab on a Chip 2021, 21, 1706-1723.
9. Liu, Y.; Zhao, W. J.; Cheng, R.; Hodgson, J.; Egan, M.; Pope, C. N. C.; Nikolinakos, P. G.; Mao, L. D., Simultaneous biochemical and functional phenotyping of single circulating tumor cells using ultrahigh throughput and recovery microfluidic devices. Lab on a Chip 2021, 21, 3583-3597.
10. Zhao, W.; Cheng, R.; Miller, J. R.; Mao, L., Label-Free Microfluidic Manipulation of Particles and Cells in Magnetic Liquids. Adv Funct Mater 2016, 26, 3916-3932.
11. Zhao, W. J.; Liu, Y.; Jenkins, B. D.; Cheng, R.; Harris, B. N.; Zhang, W. Z.; Xie, J.; Murrow, J. R.; Hodgson, J.; Egan, M.; Bankey, A.; Nikolinakos, P. G.; Ali, H. Y.; Meichner, K.; Newman, L. A.; Davis, M. B.; Mao, L. D., Tumor antigen-independent and cell size variation-inclusive enrichment of viable circulating tumor cells. Lab on a Chip 2019, 19, 1860-1876.
12. Murray, C.; Miwa, H.; Dhar, M.; Park, D. E.; Pao, E.; Martinez, J.; Kaanumale, S.; Loghin, E.; Graf, J.; Raddassi, K.; Kwok, W. W.; Hafler, D.; Puleo, C.; Di Carlo, D., Unsupervised capture and profiling of rare immune cells using multi-directional magnetic ratcheting (vol 18, pg 2396, 2018). Lab on a Chip 2018, 18, 3703-3703.
13. Labib, M.; Philpott, D. N.; Wang, Z. J.; Nemr, C.; Chen, J. B.; Sargent, E. H.; Kelley, S. O., Magnetic Ranking Cytometry: Profiling Rare Cells at the Single-Cell Level. Accounts of Chemical Research 2020, 53, 1445-1457.
14. Civelekoglu, O.; Liu, R. X.; Usanmaz, C. F.; Chu, C. H.; Boya, M.; Ozkaya-Ahmadov, T.; Arifuzzman, A. K. M.; Wang, N. Q.; Sarioglu, A. F., Electronic measurement of cell antigen expression in whole blood. Lab on a Chip 2022, 22, 296-312.
15. Mikkelsen, C.; Hansen, M. F.; Bruns, H., Theoretical comparison of magnetic and hydrodynamic interactions between magnetically tagged particles in microfluidic systems. Journal of Magnetism and Magnetic Materials 2005, 293, 578-583.
16. Grob, D. T.; Wise, N.; Oduwole, O.; Sheard, S., Magnetic susceptibility characterisation of superparamagnetic microspheres. Journal of Magnetism and Magnetic Materials 2018, 452, 134-140.
17. Mihos, C. http://burro.astr.cwru.edu/Academics/Astr221/StarPhys/opticaldepthprimer.html
18. Brenner, H., The Slow Motion of a Sphere through a Viscous Fluid Towards a Plane Surface. Chemical Engineering Science 1961, 16, 242-251.
19. Lin, B. H.; Yu, J.; Rice, S. A., Direct measurements of constrained Brownian motion of an isolated sphere between two walls. Physical Review E 2000, 62, 3909-3919.
20. Ichikawa, N.; Hosokawa, K.; Maeda, R., Interface motion of capillary-driven flow in rectangular microchannel. Journal of Colloid and Interface Science 2004, 280, 155-164.
21. Brody, J. P.; Yager, P.; Goldstein, R. E.; Austin, R. H., Biotechnology at low Reynolds numbers. Biophysical Journal 1996, 71, 3430-3441.
22. Sutermaster, B. A.; Darling, E. M., Considerations for high-yield, high-throughput cell enrichment: fluorescence versus magnetic sorting. Sci Rep 2019, 9, 227.
23. Poudineh, M.; Aldridge, P.; Ahmed, S.; Green, B. J.; Kermanshah, L.; Nguyen, V.; Tu, C.; Mohamadi, R. M.; Nam, R. K.; Hansen, A.; Sridhar, S. S.; Finelli, A.; Fleshner, N. E.; Joshua, A. M.; Sargent, E. H.; Kelley, S. O., Tracking the dynamics of circulating tumour cell phenotypes using nanoparticle-mediated magnetic ranking. Nature Nanotechnology 2017, 12, 274-+.
24. Schneider, T.; Karl, S.; Moore, L. R.; Chalmers, J. J.; Williams, P. S.; Zborowski, M., Sequential CD34 cell fractionation by magnetophoresis in a magnetic dipole flow sorter. Analyst 2010, 135, 62-70.
25. Reisbeck, M.; Helou, M. J.; Richter, L.; Kappes, B.; Friedrich, O.; Hayden, O., Magnetic fingerprints of rolling cells for quantitative flow cytometry in whole blood. Scientific Reports 2016, 6.
26. Yenilmez, B.; Knowlton, S.; Tasoglu, S., Self-Contained Handheld Magnetic Platform for Point of Care Cytometry in Biological Samples. Advanced Materials Technologies 2016, 1.
27. Liu, Y.; Zhao, W. J.; Cheng, R.; Puig, A.; Hodgson, J.; Egan, M.; Pope, C. N. C.; Nikolinakos, P. G.; Mao, L. D., Label-free inertial-ferrohydrodynamic cell separation with high throughput and resolution. Lab on a Chip 2021, 21, 2738-2750.
28. Kose, A. R.; Koser, H., Ferrofluid mediated nanocytometry. Lab on a Chip 2012, 12, 190-196.
29. Chen, Q.; Li, D.; Zielinski, J.; Kozubowski, L.; Lin, J. H.; Wang, M. H.; Xuan, X. C., Yeast cell fractionation by morphology in dilute ferrofluids. Biomicrofluidics 2017, 11.

It should be emphasized that the above-described embodiments of the present disclosure are merely possible examples of implementations, and are set forth only for a clear understanding of the principles of the disclosure. Many variations and modifications may be made to the above-described embodiments of the disclosure without departing substantially from the spirit and principles of the disclosure. All such modifications and variations are intended to be included herein within the scope of this disclosure.

1. A method for profiling and isolating target cells in a biological sample, comprising:
providing a magnetically labeled biological sample comprising a plurality of cell-bead complexes, individual ones of the cell-bead complexes comprising a target cell bound to one or more antibody-conjugated magnetic beads, and wherein the cellular magnetic content of the individual cell-bead complex is proportional to a volumetric antigen-binding capacity of the individual target cell;
combining the magnetically labeled biological sample with a colloidally stable ferrofluid to produce a mixed ferrofluid biological sample;
flowing the mixed ferrofluid biological sample through a microfluidic device comprising a plurality of collection stages arranged in series and fluidly connected;
collecting in a first collection chamber of a first collection stage of the plurality of collection stages, a first portion of cell-bead complexes having the cellular magnetic content greater than the ferrofluid concentration of the mixed ferrofluid biological sample;
diluting the ferrofluid concentration of the mixed ferrofluid biological sample with a buffer solution for a subsequent collection stage; and
collecting, in a subsequent collection chamber of the subsequent collection stage, another portion of cell-bead complexes having the cellular magnetic content greater than the ferrofluid concentration of the mixed ferrofluid biological sample in the subsequent collection stage.

2. The method of claim 1, further comprising adding subsequent diluting and collecting steps to collect cell-bead complexes having lower cellular magnetic content than the cell-bead complexes collected in a previous collection chamber.

3. The method of claim 2, wherein the number of total collection stages and collection chambers range from 2 to 100.

4-5. (canceled)

6. The method of claim 1, wherein providing the magnetically labeled biological sample comprises combining the biological sample with a plurality of antibodies and a plurality of magnetic beads, wherein the antibodies are specific for cell surface antigens of the target cells and specifically bind the target cells and the plurality of magnetic beads specifically bind the antibodies, to form cell-bead complexes.

7. The method of claim 1, wherein providing the magnetically labeled biological sample comprises:
combining the biological sample with a plurality of primary antibodies adapted to specifically bind a plurality of specific cell surface antigens of the target cells to form antibody-functionalized target cells; and
combining the biological sample comprising the antibody-functionalized target cells with a plurality of secondary antibodies conjugated to a plurality of magnetic beads and adapted to specifically bind to the primary antibodies to form cell-bead complexes, thereby producing the magnetically labeled biological sample comprising the plurality of cell-bead complexes.

8. The method of claim 1, wherein diluting the ferrofluid concentration comprises:
receiving, into a mixer of the subsequent collection stage, the mixed ferrofluid biological sample from a previous collection stage, and
receiving a buffer fluid into a mixer of the subsequent collection stage

9. The method of claim 8, wherein the mixer of the subsequent collection stage comprises a mixing microchannel of a microfluidic device.

10-13. (canceled)

14. The method of claim 1, wherein collecting the first portion of cell-bead complexes comprises using a magnet to separate a portion of cell-bead complexes having the cellular magnetic content greater than the ferrofluid concentration of the mixed ferrofluid biological sample in that cell collection stage or chamber.

15. A microfluidic device, comprising:
a sample inlet configured to receive a mixed ferrofluid biological sample comprising a ferrofluid combined with a magnetically-labeled biological sample comprising a plurality of cell-bead complexes comprising individual target cells conjugated to one or more magnetic beads, individual cell-bead complexes having a cellular magnetic content proportional to a volumetric antigen-binding capacity of the individual target cell;
a buffer fluid delivery section comprising a solution inlet and one or more flow resistance microchannels fluidly connected to the solution inlet, the solution inlet configured to receive a buffer fluid and the one or more flow resistance microchannels configured to deliver the buffer fluid at a specified flow rate with a specific flow direction;
a plurality of collection stages arranged in series, each of the plurality of collection stages comprising a collection chamber collectively arranged in a cell collection section of the device, the plurality of collection stages fluidly connected such that a first collection stage is fluidly connected to the sample inlet and one or more subsequent collection stages are individually fluidly connected to a previous collection stage and the buffer fluid delivery section via a mixer configured to combine the buffer fluid with the mixed ferrofluid biological sample from the previous collection stage at a flow rate sufficient to dilute the ferrofluid concentration of the mixed ferrofluid biological sample for the individual collection stage; and
one or more magnetic sources adjacent to the cell collection section and configured to produce a substantially non-uniform magnetic field such that, for each individual collection stage, one or more cell-bead complexes having cellular magnetic content greater than the ferrofluid concentration within the individual collection stage are captured within the individual collection chamber of the individual collection stage.

16. The device of claim 15, wherein each of the plurality of collection stages further comprises an incubation chamber in fluid connection with the collection chamber of the individual stage of the plurality of collection stages.

17. The device of claim 16, wherein the number of incubation chambers (n) is equal to the number of collection chambers (n) and the number of collection stages (n).

18. The device of claim 15, wherein the number of individual collection chambers of the plurality of collection chambers is equal to the number of collection stages (n) and the number of flow resistance microchannels of the one or more flow resistance microchannels of the buffer fluid delivery systems is one less than the number of collection stages (n−1).

19-26. (canceled)

27. The device of claim 15, wherein the number of individual collection chambers of the plurality of collection chambers is equal to the number of collection stages (n) and the number of flow resistance microchannels of the one or more flow resistance microchannels of the buffer fluid delivery systems and the number of individual mixers corresponding to the one or more subsequent collection stages is one less than the number of collection stages (n−1).

28. The device of claim 15, wherein the individual mixer corresponding to the one or more subsequent collection stages comprises a mixing microchannel having a mixer width, a mixer length, and a mixer path shape configured to mix the buffer fluid with the mixed ferrofluid biological sample from the previous collection stage to dilute the ferrofluid concentration of the mixed ferrofluid biological sample for the individual collection stage.

29. The device of claim 28, wherein the mixer length for each individual mixer corresponding to the one or more subsequent collection stages is configured for the individual collection stage.

30-43. (canceled)

44. The device of claim 15, wherein the individual collection chambers of the plurality of collection stages arranged in series vary in volume according to the individual collection stage.

45. The device of claim 15, wherein the first collection chamber of the first collection stages has a width of about 0.5 mm to about 1 mm and effective separation region of about 0.5 mm to about 1 mm.

46. The device of claim 15, further comprising a plurality of incubation chambers arranged in an incubation section adjacent to the cell collection section, wherein the number of incubation chambers corresponds to the number of collection stages and the individual collection chamber and individual incubation chamber for each collection stage are in fluid communication.

47. The device of claim 46, wherein the one or more magnetic sources adjacent to the cell collection section is moveable and the cells captured within the individual collection chambers of the cell collection section are delivered to the individual incubation chambers of the incubation section by translating the one or more magnetic sources from the position adjacent to the cell collection section to a position adjacent to the incubation section.

48. A system comprising:
a plurality of magnetic microbeads adapted for adapted to specifically bind to the primary antibodies to form cell-bead complexes, thereby producing a magnetically labeled biological sample comprising a plurality of cell-bead complexes, wherein the cellular magnetic content of the individual cell-bead complex is proportional to a volumetric antigen-binding capacity of the individual target cell;
a biocompatible ferrofluid comprising a plurality of magnetic nanoparticles and a biocompatible surfactant, the biocompatible ferrofluid adapted to be combined with the magnetically labeled biological sample to make a mixed ferrofluid biological sample; and
the microfluidic device of claim 15.
